(19) United States
(12) Patent Application Publication
(10) Pub. No.: US 2026/0222143 A1
(43) Pub. Date: Jul. 30, 2026

(54) METHOD, DEVICE AND COMPUTER STORAGE MEDIUM OF COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/149,181

(22) PCT Filed: Jan. 20, 2023
(86) PCT No.: PCT/CN2023/073410

§ 371 Date: Jul. 18, 2025

(51) Int. Cl. H04L 5/00

(52) U.S. Cl. CPC H04L 5/0048

(57) ABSTRACT

Embodiments of the present disclosure provide a solution on CSI. According to embodiments of the present disclosure, a terminal device receives, from a network device, at least one configuration for one channel state information (CSI) report, wherein the at least one configuration indicates a plurality of channel state information reference signal (CSI-RS) resources; the terminal device determines, based on the at least one configuration, at least one first amplitude coefficient, at least one second amplitude coefficient, at least one phase coefficient and at least one bitmap for non zero coefficient indication comprised in at least one codebook indicator and a first index corresponding to a strongest coefficient; the terminal device determines, priority for the at least one codebook indicator corresponding to the first index based on a first priority order and priority for the at least one codebook indicator corresponding to a second index based on a second priority order, wherein the first index is different from the second index; and the terminal device transmits at least one codebook indicator in the CSI report to the network device.

### TECHNICAL FIELD

Embodiments of the present disclosure generally relate to the field of telecommunication, and in particular, to methods, devices and computer storage media of communication for channel state information (CSI).

### BACKGROUND

Several technologies have been proposed to improve communication performances. For example, multi-input multi-output (MIMO) has been proposed. MIMO includes features that facilitate utilization of a large number of antenna elements at base station for both sub-6 GHz and over-6 GHz frequency bands. In this situation, a plurality of antennas at a transmitter and/or receiver can be used to achieve array and diversity gain instead of capacity gain. In wireless communications, channel state information (CSI) is the known channel properties of a communication link. This information describes how a signal propagates from the transmitter to the receiver and represents the combined effect of, for example, scattering, fading, and power decay with distance. The method is called Channel estimation. The CSI makes it possible to adapt transmissions to current channel conditions, which is crucial for achieving reliable communication with high data rates in multi-antenna systems. Therefore, CSI enhancement is worth studying.

### SUMMARY

In general, embodiments of the present disclosure provide methods, devices and computer storage media for CSI.

In a first aspect, there is provided a terminal device. The terminal device comprises a processor, configured to cause the terminal device to: receive, from a network device, at least one configuration for one channel state information (CSI) report, wherein the at least one configuration indicates a plurality of channel state information reference signal (CSI-RS) resources; determine, based on the at least one configuration, at least one first amplitude coefficient, at least one second amplitude coefficient, at least one phase coefficient and at least one bitmap for non zero coefficient indication comprised in at least one codebook indicator and a first index corresponding to a strongest coefficient; determine priority for the at least one codebook indicator corresponding to the first index based on a first priority order and priority for the at least one codebook indicator corresponding to a second index based on a second priority order, wherein the first index is different from the second index, and transmit at least one codebook indicator in the CSI report to the network device.

In a second aspect, there is provided a terminal device. The terminal device comprises a processor configured to cause the terminal device to: receive, from a network device, at least one configuration for one channel state information (CSI) report, wherein the at least one configuration indicates a plurality of channel state information reference signal (CSI-RS) resources and more than one codebook subset restriction, and each CSI-RS resource in the plurality of CSI-RS resources corresponds to at least one codebook subset restriction; determine, based on the at least one configuration, a first index corresponding to a strongest coefficient and at least one codebook indicator comprising: at least one first amplitude coefficient, at least one second amplitude coefficient corresponding to the first index and at least one second amplitude coefficient a second index, wherein a first average amplitude calculated based on the at least one first amplitude coefficient and the at least one second amplitude coefficient is restricted based on the codebook subset restriction corresponding to the first index, and a second average amplitude calculated based on the at least one first amplitude coefficient and the at least one second amplitude coefficient is restricted based on the codebook subset restriction corresponding to the second index and transmit, to the network device, at least one first amplitude coefficient, at least one second amplitude coefficient corresponding to the first index and at least one second amplitude coefficient a second index in the CSI report.

In a third aspect, there is provided a network device. The network device comprises a processor configured to cause the network device to: transmit, to a terminal device, at least one configuration for one channel state information (CSI) report, wherein the at least one configuration indicates a plurality of channel state information reference signal (CSI-RS) resources; and receive at least one codebook indicator in the CSI report from the terminal device, wherein the at least one codebook indicator comprises: at least one first amplitude coefficient, at least one second amplitude coefficient, at least one phase coefficient and at least one bitmap for non zero coefficient indication.

In a fourth aspect, there is provided a network device. The network device comprises a processor configured to cause the network device to: transmit, to a terminal device, at least one configuration for one channel state information (CSI) report, wherein the at least one configuration indicates a plurality of channel state information reference signal (CSI-RS) resources and more than one codebook subset restriction, and each CSI-RS resource in the plurality of CSI-RS resources corresponds to at least one codebook subset restriction; and receive, from the terminal device, at least one first amplitude coefficient, at least one second amplitude coefficient corresponding to a first index and at least one second amplitude coefficient a second index in the CSI report from the terminal device, wherein the first index is a first index corresponding to a first CSI-RS resource in the plurality of CSI-RS resources, and the second index is a second index corresponding to a second CSI-RS resource in the plurality of CSI-RS resources.

In a fifth aspect, there is provided a communication method. The method comprises: receiving, at a terminal device and from a network device, at least one configuration for one channel state information (CSI) report, wherein the at least one configuration indicates a plurality of channel state information reference signal (CSI-RS) resources; determining, based on the at least one configuration, at least one first amplitude coefficient, at least one second amplitude coefficient, at least one phase coefficient and at least one bitmap for non zero coefficient indication comprised in at least one codebook indicator and a first index corresponding to a strongest coefficient; determining priority for the at least one codebook indicator corresponding to the first index based on a first priority order and priority for the at least one codebook indicator corresponding to a second index based on a second priority order, wherein the first index is different from the second index, and transmitting at least one codebook indicator in the CSI report to the network device.

In a sixth aspect, there is provided a communication method. The method comprises: transmitting, at a network device and to a terminal device, at least one configuration for one channel state information (CSI) report, wherein the at least one configuration indicates a plurality of channel state information reference signal (CSI-RS) resources; and receiving, from the terminal device, at least one codebook indicator in the CSI report from the terminal device, wherein the at least one codebook indicator comprises: at least one first amplitude coefficient, at least one second amplitude coefficient, at least one phase coefficient and at least one bitmap for non zero coefficient indication.

In a seventh aspect, there is provided a computer readable medium having instructions stored thereon, the instructions, when executed on at least one processor, causing the at least one processor to carry out the method according to the fifth or sixth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a flowchart of a method implemented at a terminal device according to some example embodiments of the present disclosure;

FIG. 4 illustrates a flowchart of a method implemented at a network device according to some example embodiments of the present disclosure; and

FIG. 5 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Every thing (IoE) devices, machine type communication (MTC) devices, device on vehicle for V2X communication where X means pedestrian, vehicle, or infrastructure/network, devices for Integrated Access and Backhaul (IAB), Space bome vehicles or Air bome vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (910 MHz to 7125 MHz), FR2 (24.25 GHz to 71 GHz), FR2-2 (52.6 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum.’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is.

It should be understood that although feature(s)/operation(s) are discussed in specific example embodiments separately, unless clearly indicated to the contrary, these feature(s)/operation(s) described in different example embodiments may be used in any suitable combination.

Principles and implementations of the present disclosure will be described in detail below with reference to the figures.

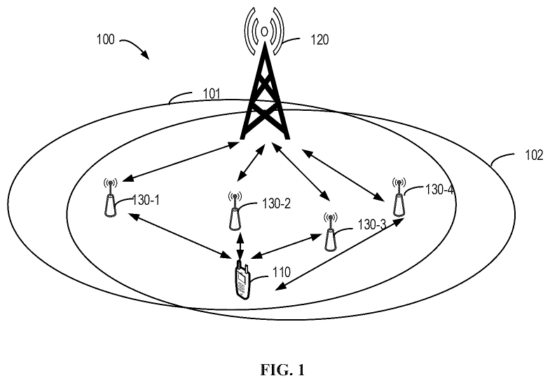

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 102 to serve one or more terminal devices. In this example, the terminal device 110 is located in the cell 102 and is served by the network device 120. In the example of FIG. 1, the terminal device 110 may be a UE and the network device 120 may be a base station serving the UE. The serving area of the network device 120 may be called a cell 102.

For example, the network device 120 may be configured with at least one of four TRPs/panels 130-1, 130-2, 130-3 and 130-4 (collectively referred to as TRPs 130 or individually referred to as TRP 130). It is to be understood that the number of network devices, terminal devices and TRPs as shown in FIG. 1 is only for the purpose of illustration without suggesting any limitations to the present disclosure. The network 100 may include any suitable number of devices adapted for implementing embodiments of the present disclosure. Although not shown, it would be appreciated that one or more additional devices may be located in the cell 102, and one or more additional cells may be deployed in the communication environment 100. It is noted that although illustrated as a network device, the network device 120 may be another device than a network device. Although illustrated as a terminal device, the terminal device 110 may be other device than a terminal device. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, if the terminal device 110 is a terminal device and the network device 120 is a network device, a link from the network device 120 to the terminal device 110 is referred to as a downlink (DL), while a link from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver). In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As shown in FIG. 1, the network device 120 may communicate with the terminal device 110 via at least one of the TRPs 130-1, 130-2, 130-3 and 130-4. In the following text, the TRP 130-1 may be also referred to as the first TRP, the TRP 130-2 may be also referred to as the second TRP, the TRP 130-3 may be also referred to as the third TRP and the TRP 130-4 may be also referred to as the fourth TRP. Each of the TRPs 130 may provide a plurality of beams for communication with the terminal device 110. It is noted that the number of TRPs shown in FIG. 1 is only an example not limitation.

In some embodiments, the first TRP and/or the second TRP and/or the third TRP and/or the fourth TRP may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 130 and the terminal device 110.

In some embodiments, before transmitting data (such as, via the TRP 130-1 and/or 130-2 and/or 130-3 and/or 130-4) to the terminal device 110, the network device 120 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information are not limited to the ones as listed above. Embodiments of the present disclosure may equally applicable to control information including any transmission parameters.

In the context of the present application, the terms “TCI state”, “set of QCL parameter(s)”, “QCL parameter(s)”. “QCL assumption” and “QCL configuration” can be used interchangeably. The terms “TCI field”, “TCI state field”, and “transmission configuration indication” can be used interchangeably.

In the context of the present application, the terms “precoding matrix”, “precoding”, “beam”, “beamforming”, “vector”, “first vector”, “first basis”, “first basis vector”, “codebook” and “precoder” may be used interchangeably. The terms “vector”, “bases” and “basis” can be used interchangeably.

In the context of the present application, the terms “single TRP”, “single TC state”, “single TCI”, “S-TCI”, “single CORESET”, “single control resource set pool”, “S-TRP” and “S-TCI state” can be used interchangeably.

In the context of the present application, the terms “multiple TRPs”. “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

In the context of the present application, the terms “pool”, “set”, “subset”, “group”, “unit” and “subgroup” can be used interchangeably.

In the context of the present application, the terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field”, “bitwidth” and “field size” can be used interchangeably.

In the context of the present application, the terms “first vector”, “a CSI-RS port”, “an antenna port”, “first beam”, “beam”, “first bases”, “first basis vector”, “spatial domain/SD basis vector”, “spatial domain/SD vectors”, “spatial domain/SD basis”, “spatial domain/SD bases”, “spatial domain/SD basis vectors corresponding to a TRP index”, “spatial domainSD vectors corresponding to a TRP index”, “spatial domain/SD basis corresponding to a TRP index”, “spatial domain/SD bases corresponding to a TRP index”, “first basis corresponding to a TRP index” and “first basis” can be used interchangeably.

In the context of the present application, the terms “second vector”, “second basis”, “frequency domain/FD basis vector”, “frequency domain/FD vector”, “frequency domain/FD basis”, “frequency domain/FD bases”, “second bases”. “second vector corresponding to a TRP index”, “second bases corresponding to a TRP index”, “frequency domain/FD basis vectors corresponding to a TRP index”, “frequency domain/FD vectors corresponding to a TRP index”, “frequency domain/FD basis corresponding to a TRP index”, “frequency domain/FD bases corresponding to a TRP index” and “second basis corresponding to a TRP index” can be used interchangeably.

In the context of the present application, the terms “third vector”, “third bases”, “doppler domain/DD basis vectors”, “doppler domain/DD vectors”, “doppler domain/DD basis”, “doppler domain/DD bases”, “third basis”, “third vector corresponding to a TRP index”, “third bases corresponding to a TRP index”, “doppler domain/DD basis vectors corresponding to a TRP index”, “doppler domain/DD vectors corresponding to a TRP index”, “doppler domain/DD basis corresponding to a TRP index”, “doppler domain/DD bases corresponding to a TRP index”, and “third basis corresponding to a TRP index” can be used interchangeably. In the context of the present application, the terms “doppler domain”, “time domain”, “TD” and “DD” can be used interchangeably.

In the context of the present application, the terms “a TRP”, “a TRP group”, “a CSI-RS resource” and “a group of CSI-RS ports” can be used interchangeably.

In the context of the present application, the terms “refinement” and “enhancement” can be used interchangeably.

In the context of the present application, the terms “report” and “feedback” can be used interchangeably.

In the context of the present application, the terms “a first codebook configuration”, “a first codebook”, “CSI enhancement for CJT”, “Coherent-joint transmission (CJT)”, “Release (Rel)-16/17 Type-II codebook refinement for CJT mTRP”, “Release (Rel)-16/17 Type-II codebook refinement for CJT”, “Release (Rel)-16 Type-II codebook refinement for CJT”, “Release (Rel)-17 Type-II codebook refinement for CJT”, “Type-II codebook refinement for CJT mTRP”, “Type-II codebook refinement for CJT”, “CSI enhancement for CJT,” “multi-TRP CJT”, “Rel-18 CJT codebook”, “Rel-18 CJT”, “CJT codebook”, “CJT CSI”, “CSI for CJT” and “CJT CSI enhancement” can be used interchangeably.

In the context of the present application, the terms “a second codebook configuration”. “a second codebook”, “CSI enhancement for high/medium velocity”, “CSI enhancement for velocity”, “codebook enhancement for high/medium velocity”, “codebook enhancement for velocity”, “CSI for high/medium velocity”. “CSI for velocity”, “codebook for high/medium velocity”, “codebook for velocity”, “high/medium velocity”, “velocity”, “CSI feedback with third vector”, “CSI feedback with doppler domain basis”, “CSI feedback with doppler domain vector”, “codebook with third vector”, “codebook with doppler domain basis”, “codebook with doppler domain vector”, “Release (Rel)-16/17 Type-II codebook refinement for high/medium velocity”. “Release (Rel)-16/17 Type-II codebook refinement for velocity”, “Release (Rel)-16 Type-II codebook refinement for velocity”, “Release (Rel)-17 Type-II codebook refinement for velocity”, “Type-II codebook refinement for high/medium velocity”, “Type-II codebook refinement for high/medium velocity”. “CSI enhancement for high/medium velocity”, “Rel-18 high/medium velocity codebook”, “Rel-18 velocity codebook”, “velocity codebook”, “velocity CSI”, “CSI for velocity”, “velocity CSI enhancement”, “high/medium velocity codebook”, “high/medium velocity CSI”, “CSI for high/medium velocity” and “high/medium velocity CSI enhancement” can be used interchangeably.

In the context of the present application, the terms “a TRP index”, “a TRP group index”, “a CSI-RS resource index”, “a group of CSI-RS port indexes” and “a group of CSI-RS ports index” can be used interchangeably.

In the context of the present application, the terms “element of indication field”, “parameter” and “indication” can be used interchangeably.

In the context of the present application, the terms “CSI report”, “CSI reporting”, “CSI report setting”, “CSI feedback”, “codebook”, “codebook configuration”, “codebookConfig” and “CSI” can be used interchangeably. In the context of the present application, the terms “strongest amplitude coefficient”, “strongest amplitude coefficient indication”, “strongest coefficient indication”, “indication of the strongest coefficient”, “indication of the strongest amplitude coefficient” and “strongest coefficient” can be used interchangeably.

In the context of the present application, the terms “first type of codebook”, “codebook enhancement based on Rel-16 codebook” and “CSI enhancement based on Rel-16 codebook” can be used interchangeably. In the context of the present application, the terms “second type of codebook”, “codebook enhancement based on Rel-17 codebook” and “CSI enhancement based on Rel-17 codebook” can be used interchangeably.

In the context of the present application, the terms “first mode of codebook structure”, “codebook mode 1”, “codebook mode-1”, “first mode”, “mode 1” and “mode-1” can be used interchangeably. In the context of the present application, the terms “second mode of codebook structure”, “codebook mode 2”. “codebook mode-2”, “second mode”, “mode 2” and “mode-2” can be used interchangeably.

In the context of the present application, the terms “plurality of CSI-RS resources” and “N_{TRP} CSI-RS resources” can be used interchangeably. In the context of the present application, the terms “second plurality of CSI-RS resources” and “N CSI-RS resources” can be used interchangeably.

In the context of the present application, the terms “plurality of CSI-RS resources”, “second plurality of CSI-RS resources”, ““selected CSI-RS resources” in the CSI report” and “selected CSI-RS resources” can be used interchangeably.

In the context of the present application, the terms “first vector with index”, “first index” and “index of first vector” can be used interchangeably. In the context of the present application, the terms “second vector with index”, “second index” and “index of second vector” can be used interchangeably.

In the context of the present application, the embodiments described for the first vector may be applied for the second vector and/or for the third vector and/or for the FD basis vector and/or for the SD basis vector and/or for the DD basis vector. In the context of the present application, the embodiments described for the second vector may be applied for the first vector and/or for the third vector and/or for the FD basis vector and/or for the SD basis vector and/or for the DD basis vector.

In addition to normal data communications, the network device 120 may send a RS to the terminal device 110 in a downlink. Similarly, the terminal device 110 may transmit a RS to the network device 120 in an uplink. Generally speaking, a RS is a signal sequence (also referred to as “RS sequence”) that is known by both the network device 120 and the terminal devices 110. For example, a RS sequence may be generated and transmitted by the network device 120 based on a certain rule and the terminal device 110 may deduce the RS sequence based on the same rule. For another example, a RS sequence may be generated and transmitted by the terminal device 110 based on a certain rule and the network device 120 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking. Positioning Reference Signal (PRS) and so on.

In addition to normal data communications, the network device 120 may transmit DCI via a PDCCH to the terminal device 110. The DCI may indicate resource allocation for data transmission in a DL or UL. Concurrently, a DMRS associated with the PDCCH may also be transmitted from the network device 120 to the terminal device 110. The DMRS may be used by the terminal device 110 for channel demodulation. Then, the terminal device 110 may attempt to blindly decode the DCI in a PDCCH in a search space which is associated with a control resource set (CORESET). As used herein, a “CORESET” and/or a search space refers to a set of resource element groups (REGs) within which the terminal device 110 attempts to blindly decode the DCI. A search space indicating the start time and a periodicity for monitoring a PDCCH in the CORESET may be indicated to the terminal device 110. In response to decoding the DCI successfully, the terminal device 110 may perform the UL and/or DL data transmission (for example, data transmission via PDSCH and/or Physical Uplink Shared Channel (PUSCH)) with the network device 120 accordingly.

The network device 120 may communicate data and control information to the terminal device 110 via a plurality of beams (also referred to as “DL beams”). The terminal device 110 may also communicate data and control information to the network device 120 via a plurality of beams (also referred to as “UL beams”). In 3GPP specifications for new radio (NR), a beam is also defined and indicated by parameters of a transmission configuration indicator. For example, there may be a transmission configuration indication (TCI) field in DCI. A value of the TCI field may be referred to as a “TCI codepoint”. A TCI codepoint may indicate one or more TCI states. Each TCI state contains parameters for configuring a quasi co-location (QCL) relationship between one or two DL and/or UL reference signals and the DMRS ports of the PDSCH, the DMRS ports of PDCCH, the DMRS ports of PUSCH, the DMRS ports of PUCCH, the SRS ports of a SRS resource or the CSI-RS ports of a CSI-RS resource.

In addition, in the following description, some interactions are performed among the terminal device 110 and the network device 120 (such as, exchanging configuration (s) and so on). It is to be understood that the interactions may be implemented either in one single signaling/message/configuration or multiple signaling/messages/configurations, including system information, radio resource control (RRC) message, downlink control information (DCI) message, uplink control information (UCI) message, media access control (MAC) control element (CE) and so on. The present disclosure is not limited in this regard.

In some embodiments, the terminal device may be configured with at least one of a first codebook configuration and a second codebook configuration for one CST report. In some embodiments, the terminal device may be configured with at least one of a first type of codebook and a second type of codebook for one CST report. In some embodiments, the terminal device may be configured with at least one of a first type of codebook and a second type of codebook for the first codebook configuration for the CSI report. In some embodiments, the terminal device may be configured with at least one of a first type of codebook and a second type of codebook for the second codebook configuration for the CSI report. For example, through RRC signalling. In some embodiments, for the first type of codebook, the enhancements may be based on Rel-16 codebook or based on enhanced Type II codebook. In some embodiments, for the second type of codebook, the enhancements may be based on Rel-17 port selection codebook or based on further enhanced Type II port selection codebook.

In some embodiments, the terminal device 110 may be configured with at least one of a first mode of codebook structure and a second mode of codebook structure for the CSI report. In some embodiments, the terminal device 110 may be configured with at least one of the first mode of codebook structure and the second mode of codebook structure for the CSI report. For example, for the first codebook configuration for the CST report. For example, through RRC signalling.

In some embodiments, the terminal device 110 may be configured with the first type of codebook and the first mode of codebook structure and/or the first codebook configuration for the CSI report. In some embodiments, the terminal device 110 may be configured with the first type of codebook and the second mode of codebook structure and/or the first codebook configuration for the CST report. In some embodiments, the terminal device 110 may be configured with the second type of codebook and the first mode of codebook structure and/or the first codebook configuration for the CSI report. In some embodiments, the terminal device 110 may be configured with the second type of codebook and the second mode of codebook structure and/or the first codebook configuration for the CSI report. For example, through RRC signalling.

In some embodiments, the terminal device 110 may be configured with the first type of codebook and/or the second codebook configuration for the CSI report. In some embodiments, the terminal device 110 may be configured with the second type of codebook and/or the second codebook configuration for the CSI report. For example, through RRC signalling.

In some embodiments, the terminal device 110 may receive, from the network device, at least one configuration for one CSI report, wherein the at least one configuration may include at least one of: a plurality of CSI-RS resources for channel measurement for the CSI report, a set of combinations of values for first vector for the CSI report (For example, for the first codebook configuration. For example, the set of combinations of values for first vector may be represented as {Lₜ} with 1≤t≤N or 1≤t≤N_{TRP}. (For example, for the first type of codebook). For another example, the set of combinations of values for first vector may be represented as {αₜ} with 1≤t≤N or 1≤t≤N_{TRP}. (For example, for the second type of codebook). For example, t may be a positive integer.), a value for first vector for the CSI report (For example, for the second codebook configuration. For example, the value for first vector may be represented as L (For example, for the first type of codebook). For another example, the value for first vector may be represented as {α} (For example, for the second type of codebook)), at least one value for second vector (e.g. represented as Mᵥ or represented as M) for the CSI report, at least one value for a first parameter (e.g. represented as β) for the CSI report, at least one parameter for antenna port configuration (e.g. a first parameter for antenna port configuration N₁ and a second parameter for antenna port configuration N₂), a type of codebook (For example, the first type of codebook and/or the second type of codebook), a codebook configuration (For example, the first codebook configuration and/or the second codebook configuration), a mode of codebook structure (For example, the first mode of codebook structure and/or the second mode of codebook structure), at least one parameter for codebook, a total number of precoding matrices in the CSI report (e.g. represented as N₃), the number of a plurality of third vectors (e.g. represented as Q), at least one value for a second parameter for codebook (e.g. represented as pᵥ), a third parameter for codebook (e.g. represented as R), the number of a plurality of time units (e.g. represented as N₄), the number of slots of one time unit (e.g. represented as Tᵤ or Tᵢ), and a size of one time unit (e.g. represented as Tᵤ or Tᵢ) and a fourth parameter for codebook (e.g. represented as N_{f}). In some embodiments, the fourth parameter for codebook N_{f} may be configured when the terminal device 110 is configured with second type of codebook. In some embodiments, the fourth parameter for codebook N_{f} may be a size of window for second vectors. In some embodiments, the value of N_{f} may be at least one of {1, 2, 4} or {2, 4}.

In some embodiments, the terminal device 110 may receive, from the network device, at least one configuration indicating the number of physical resource blocks (PRBs) in a bandwidth part (BWP), the number of a plurality of subbands, a size of one subband, the number of PRBs of one subband, the number of a plurality of time units (e.g. represented as N₄), the number of slots of one time unit or one time interval (e.g. represented as Ta), and a size of one time unit or one time interval (e.g. represented as Tᵤ). For example, through RRC signalling.

In some embodiments, N₄ may be a positive integer. In some embodiments, N₄ may be at least one of {1, 2, 3, 4, 5, 6, 8, 10, 16, 32} or at least one of {1, 2, 4, 8}. In some embodiments, 1≤N₄≤32. In some embodiments, Tᵤ may be a positive integer. In some embodiments, Tᵤ may be at least one of {1, 2, 3, 4, 5, 6, 8, 10, 12, 16, 32}. In some embodiments, 1≤Tᵤ≤32 or 1≤Tᵤ≤16.

In some embodiments, the terminal device 110 may be configured with a plurality of CSI-RS resources. In some embodiments, the at least one configuration for the CSI report may comprise or indicate the plurality of CSI-RS resources for channel measurement for the CSI report.

In some embodiments, the number of a plurality of third vectors Q for the CSI report may be at least one of {1, 2, 3, 4, 5, 6, 7, 8}. In some embodiments, Q may be a positive integer. In some embodiments, 1≤Q≤8 or 2≤Q≤8 or 2≤Q≤4 or Q=2. In some embodiments, the index for the Q third vectors may be q. In some embodiments, q may be a non-negative integer or a positive integer. In some embodiments, 1≤q≤Q or In some embodiments, 0≤q≤Q−1.

In some embodiments, the terminal device may be configured with the first codebook configuration. In some embodiments, the plurality of CSI-RS resources may comprise N_{TRP} or N CSI-RS resources. In some embodiments, the plurality of CSI-RS resources may be the N_{TRP} or N CSI-RS resources. In some embodiments, the number of CSI-RS resources in the plurality of CSI-RS resources may be N_{TRP} or N. In some embodiments, N_{TRP} may be a positive integer, and 1≤N_{TRP}≤8 or 1≤N_{TRP}≤4 or 2≤N_{TRP}≤4. In some embodiments, N_{TRP} may be at least one of {1, 2, 3, 4} or at least one of {2, 3, 4}. In some embodiments, N may be a positive integer, and 1≤N≤8 or 1≤N≤4 or 2≤N≤4 or 1≤N≤16. In some embodiments, N may be at least one of {1, 2, 3, 4} or at least one of {2, 3, 4}. For example, for the first codebook configuration. In some embodiments, N may be at least one of {4, 5, 8, 12, 16}. For example, for the second codebook configuration. For another example, in case of aperiodic CSI-RS configuration.

In some embodiments, the time interval between two CSI-RS resource in the plurality of CSI-RS resources may be at least one of {1, 2, 4, 5, 8, 12, 16} slots. For example, for the second codebook configuration.

In some embodiments, N_{TRP} and N may be used interchangeably in this disclosure. For example, N may be replace with N_{TRP} in at least one formula in this disclosure.

In some embodiments, the terminal device 110 may indicate or select or determine or report a second plurality of CSI-RS resources based on the plurality of CSI-RS resources. In some embodiments, the second plurality of CSI-RS resources may be same as the plurality of CSI-RS resources. In some embodiments, the second plurality of CSI-RS resources may be a subset of the plurality of CSI-RS resources. In some embodiments, the second plurality of CSI-RS resources may comprise N CSI-RS resource. In some embodiments, the second plurality of CSI-RS resources may be N CSI-RS resources. In some embodiments, the number of CSI-RS resources in the second plurality of CSI-RS resources may be N. In some embodiments, N may be a positive integer, and 1≤N S N_{TRP}. In some embodiments, N may be at least one of {1, 2, 3, 4} or at least one of {2, 3, 4}. In some embodiments, N may be less than or equal to N_{TRP}.

In some embodiments, for the first codebook configuration, the terminal device may be configured with N_{TRP} CSI-RS resources for channel measurement for one CSI report. In some embodiments. N_{TRP} may be a positive integer. In some embodiments, N_{TRP} may be at least one of {1, 2, 3, 4} or {2, 3, 4}. In some embodiments, the terminal device may be configured based on at least one configuration to determine or select or report N CSI-RS resources from the N_{TRP} CSI-RS resources for channel measurement for one CSI report. In some embodiments, the selection of N CSI-RS resources may be performed by the terminal device. In some embodiments, the selection of N CSI-RS resource may be reported as a part of the one CSI report. In some embodiments, N may be a positive integer. In some embodiments, N may be in a range from 1 to N_{TRP}. In some embodiments, 1≤=N≤=N_{TRP}. In some embodiments, N may be at least one of {1} or {1, 2} or {1, 2, 3} or {1, 2, 3, 4}. In some embodiments, N may represent the number of cooperating CSI-RS resources for the CSI report. In some embodiments, N_{TRP} is the maximum number of cooperating CSI-RS resources configured by the network device via higher-layer signaling. In some embodiments, the selection of N out of N_{TRP} CSI-RS resources may be reported via N_{TRP}-bit second bitmap in CSI part 1. In some embodiments, a restricted configuration (for example, configured by the network device via higher-layer signaling) may indicate N=N_{TRP} is supposed. For example, N_{TRP}-bit second bitmap may not be reported when the restriction or the restricted configuration is configured.

In some embodiments, each CSI-RS resource in the plurality of CSI-RS resources or in the second plurality of CSI-RS resources may be represented as a CSI-RS with index t. In some embodiments, t may be a non-negative integer. For example, 0≤t≤N_{TRP}−1 or 0≤t≤N−1. In some embodiments, t may be a positive integer. For example, 1≤t≤N_{TRP} or 1≤t≤N. In some embodiments, the first CSI-RS resource in the plurality of CSI-RS resources or in the second plurality of CSI-RS resources may be represented as CSI-RS resource with index t=1. In some embodiments, the second CSI-RS resource in the plurality of CSI-RS resources or in the second plurality of CSI-RS resources may be represented as CSI-RS resource with index t=2. In some embodiments, the third CSI-RS resource in the plurality of CSI-RS resources or in the second plurality of CSI-RS resources may be represented as CSI-RS resource with index t=3. In some embodiments, the fourth CSI-RS resource in the plurality of CSI-RS resources or in the second plurality of CSI-RS resources may be represented as CSI-RS resource with index t=4.

In some embodiments, the second plurality of CSI-RS resources may be indicated or reported based on a second bitmap in the CSI report. In some embodiments, the number of bits in the second bitmap may be N_{TRP}. In some embodiments, a bit in the second bitmap may be represented as bₜ, and the value of bₜ may be either 0 or 1. In some embodiments, the bit bₜ in the second bitmap may indicate whether the corresponding CSI-RS resource with index tin the plurality of CSI-RS resources selected or not. In some embodiments, the bit bₜ in the second bitmap may indicate whether the corresponding CSI-RS resource with index t in the plurality of CSI-RS resources included or selected in the second plurality of CSI-RS resources or not. In some embodiments, the second bitmap may be represented as {bₜ}, wherein 1≤t≤N_{TRP} or 0≤t≤N_{TRP}−1. In some embodiments, a CSI-RS resource with index t in the plurality of CSI-RS resources corresponding to a bit value be is selected or is included in the second plurality of CSI-RS resources if the value bₜ=1. In some embodiments, at least one bit in the second bitmap may be with value 1.

In some embodiments, there may be a reference CSI-RS resource in the plurality of CSI-RS resources or in the second plurality of CSI-RS resources. In some embodiments, the reference CSI-RS resource may be a CSI-RS resource corresponding to a strongest coefficient indication or a strongest coefficient or an indication in the first bitmap (or in the third bitmap and the fourth bitmap) for non zero coefficients indication in the CSI report. In some embodiments, the strongest coefficient or the strongest coefficient indication may be indicated or reported in a field in the CSI report. In some embodiments, the reference CSI-RS resource may be the first one of CSI-RS resource or the last one of CSI-RS resource or the latest one of CSI-RS resource in time in the plurality of CSI-RS resources or the second plurality of CSI-RS resources. In some embodiments, the reference CSI-RS resource may be with index t_{ref}. In some embodiments, t_{ref} may be a positive integer. For example, 1≤t_{ref}≤N_{TRP} or 1≤t_{ref}≤N. In some embodiments, t_{ref} may be a non-negative integer. For example, 0≤t_{ref}≤N_{TRP}−1 or 0≤t_{ref}≤N−1.

In some embodiments, the CSI report may comprise at least one of: a rank indicator (or indication of a number of layers), at least one wideband channel quality indicator (CQI) (For example, each one of the at least one wideband CQI may correspond to at least one time unit), at least one subband differential CQI corresponding to one subband with index S_{sub}, and indication of a number of nonzero coefficients. In some embodiments, the at least one codebook indicator may comprise at least one of; indication of at least one first vector (For example, each one of the at least one first vector may correspond to the CSI report or correspond to a CSI-RS resource with index t for the CSI report), indication of rotation of the at least one first vector (For example, each one of the at least one rotation of the at least one first vector may correspond to the CSI report or correspond to a CSI-RS resource with index t for the CSI report), indication of at least one second vector (For example, each one of the at least one second vector may correspond to the CSI report or correspond to a CSI-RS resource with index t for the CSI report), indication of at least one third vector, indicator of at least one strongest coefficient for the CSI report (For example, each one of the at least one strongest coefficient may correspond to a layer with index r), indication of at least one first amplitude coefficient, indication of at least one second amplitude coefficient, indication of at least one phase coefficient, indication of a number of nonzero coefficients, indication of at least one first bitmap for indicating nonzero coefficients, indication of one third bitmap and one fourth bitmap for indicating nonzero coefficients and indication of the second bitmap for the second plurality of CSI-RS resources. In some embodiments, the at least one codebook indicator may be based on the number of layers or the Rank indicator. In some embodiments, the first bitmap may indicate location of non zero coefficients corresponding to first vector with index i and/or corresponding to second vector index f and/or corresponding to second vector index q and/or corresponding to layer with r. In some embodiments, the third bitmap and the fourth bitmap may indicate location of non zero coefficients corresponding to first vector with index i and/or corresponding to second vector index f and/or corresponding to second vector index q and/or corresponding to layer with r.

In some embodiments, the terminal device 110 may transmit the CSI report to the network device 120 based on the at least one configuration for the CSI report.

In some embodiments, S_{sub} may be a non-negative integer. For example, 0≤S_{sub}≤18 or 0≤S_{sb}≤17.

In some embodiments, the terminal device 110 may receive at least one configuration for one channel state information (CSI) report, wherein the at least one configuration indicates a plurality of channel state information reference signal (CSI-RS) resources. In some embodiments, the terminal device 110 may determine, based on the at least one configuration, at least one first amplitude coefficient, at least one second amplitude coefficient, at least one phase coefficient and at least one bitmap for non zero coefficient indication comprised in at least one codebook indicator and a first index corresponding to a strongest coefficient. In some embodiments, the terminal device 110 may determine, priority for the at least one codebook indicator corresponding to the first index based on a first priority order and priority for the at least one codebook indicator corresponding to a second index based on a second priority order, wherein the first index is different from the second index. In some embodiments, the terminal device 110 may transmit the at least one codebook indicator in the CSI report to the network device 120.

In some embodiments, the first index may be a first index corresponding to a first CSI-RS resource in the plurality of CSI-RS resources, and the second index may be a second index corresponding to a second CSI-RS resource in the plurality of CSI-RS resources.

In some embodiments, the first priority order corresponding to the first index may be based on at least one index of second vector corresponding to the first index. In some embodiments, the first priority order corresponding to the first index may be based on

$$π ( f , {t}_{ref} ) = min ( 2 \cdot {n}_{3 , r}^{( f , {t}_{ref} )} , 2 \cdot ( {N}_{3} - {n}_{3 , r}^{( f , {t}_{ref} )} ) - 1 ) ,$$

wherein

$${n}_{3 , r}^{( f , {t}_{ref} )}$$

may be the index of second vector corresponding to the first index, f∈{0, 1, . . . N₃−1} and t_{ref} may be the first index.

In some embodiments, the second priority order corresponding to the second index may be based on at least one index of second vector corresponding to the second index and at least one of: an offset for at least one second vector corresponding to the second index, an index of the first one of the at least one second vector corresponding to the second index and an index of starting position for second vector selection. In some embodiments, the second priority order corresponding to the second index may be based on

$${n}_{3 , r}^{( f , t )}$$

wherein

$$( f , t ) = min ( ( 2 \cdot ( ( {n}_{3 , r}^{( f , t )} - {φ}_{n , t} ) mod {N}_{3} ) ) , ( 2 \cdot ( ( {N}_{3} - {n}_{3 , r}^{( f , t )} - 1 - {φ}_{n , t} ) mod {N}_{3} ) ) ) ,$$

may be the index of second vector corresponding to the second index, f∈{0, 1, . . . N₃−1} and t may be the second index.

In some embodiments, the terminal device 110 may receive, at least one configuration for one channel state information (CSI) report, wherein the at least one configuration may indicate a plurality of channel state information reference signal (CSI-RS) resources and more than one codebook subset restriction, and each CSI-RS resource in the plurality of CSI-RS resources may correspond to at least one codebook subset restriction. In some embodiments, the terminal device 110 may determine, based on the at least one configuration, a first index corresponding to a strongest coefficient and at least one codebook indicator comprising: at least one first amplitude coefficient, at least one second amplitude coefficient corresponding to the first index and at least one second amplitude coefficient a second index, wherein a first average amplitude calculated based on the at least one first amplitude coefficient and the at least one second amplitude coefficient may be restricted based on the codebook subset restriction corresponding to the first index, and a second average amplitude calculated based on the at least one first amplitude coefficient and the at least one second amplitude coefficient may be restricted based on the codebook subset restriction corresponding to the second index. In some embodiments, the terminal device 110 may transmit at least one first amplitude coefficient, at least one second amplitude coefficient corresponding to the first index and at least one second amplitude coefficient a second index in the CSI report to the network device.

In some embodiments, the terminal device 110 may determine, the at least one first amplitude coefficient, the at least one second amplitude coefficient corresponding to the first index based on a first codebook subset restriction corresponding to the first index, in response to the second CSI-RS resource comprised in a second plurality of CSI-RS resources or the number of CSI-RS resources in the second plurality of CSI-RS resources is larger than 1. In some embodiments, the terminal device 110 may determine the at least one first amplitude coefficient, the at least one second amplitude coefficient corresponding to the first index based on a first codebook subset restriction corresponding to the first index, in response to the second CSI-RS resource not comprised in the second plurality of CSI-RS resources or the number of CSI-RS resources in the second plurality of CSI-RS resources is 1.

In some embodiments, the terminal device 110 may determine the second plurality of CSI-RS resources from the plurality of CSI-RS resources, wherein the second plurality of CSI-RS resources may be same or a subset of the plurality of CSI-RS resources.

In some embodiments, the terminal device 110 may determine a first bitmap and a second bitmap to indicating at least one non zero coefficient corresponding to one layer based on the at least one configuration for the CSI report. In some embodiments, the terminal device 110 may determine CSI group 1 and CSI group 2 for the CSI report based on a priority rule. In some embodiments, the terminal device 110 may transmit to the network device, the CSI report that comprises CSI group 1 only or both CSI group 1 and CSI group 2.

In some embodiments, the first bitmap may indicate at least one nonzero coefficient corresponding to at least one pair of one first vector and one second vector, and the second bitmap may indicate at least one non zero coefficient corresponding to one third vector and at least one indicated pair of first vector and one second vector based on the first bitmap.

In some embodiments, the first bitmap and the second bitmap may be comprised in CSI group 1. In some embodiments, the first bitmap and a set of highest priority elements in the second bitmap for non zero coefficients indication may be comprised in CSI group 1, a remaining set of lowest priority elements in the second bitmap for non zero coefficients indication may be comprised in CSI group 2. In some embodiments, a set of highest priority elements in the first bitmap and a set of highest priority elements in the second bitmap for non zero coefficients indication may be comprised in CSI group 1, a remaining set of lowest priority elements in the first bitmap and a remaining set of lowest priority elements in the second bitmap for non zero coefficients indication may be comprised in CSI group 2.

In some embodiments, a first slot corresponding to the CSI report may be slot with index n, in response to a value n_ref for reference resource slot is larger than or equal to a value of product of a number of time units for the CSI report and a number of slots corresponding to one time unit. In some embodiments, the first slot corresponding to the CSI report may be slot with index n−n_ref, in response to the value of n_ref is less than the value of product of the number of time units for the CSI report and the number of slots corresponding to one time unit. In some embodiments, the number of time units for the CSI report and the number of slots corresponding to one time unit may be comprised in the at least one configuration, and the value for reference resource slot may be 4 or 5.

In some embodiments, the network device 120 may transmit at least one configuration for one channel state information (CSI) report, wherein the at least one configuration indicates a plurality of channel state information reference signal (CSI-RS) resources. In some embodiments, the network device 120 may receive from the terminal device, at least one codebook indicator in the CSI report from the terminal device, wherein the at least one codebook indicator may comprise, at least one first amplitude coefficient, at least one second amplitude coefficient, at least one phase coefficient and at least one bitmap for non zero coefficient indication.

In some embodiments, the network device 120 may transmit, to the terminal device 110, at least one configuration for one channel state information (CSI) report, wherein the at least one configuration may indicate a plurality of channel state information reference signal (CSI-RS) resources and more than one codebook subset restriction, and each CSI-RS resource in the plurality of CSI-RS resources corresponds to at least one codebook subset restriction. In some embodiments, the network device 120 may receive, from the terminal device 110, at least one first amplitude coefficient, at least one second amplitude coefficient corresponding to a first index and at least one second amplitude coefficient a second index in the CSI report from the terminal device.

In some embodiments, the network device 120 may transmit to the terminal device 110, at least one configuration for a channel state information (CST) report, wherein the at least one configuration comprises: a number of time units for the CSI report and a number of slots corresponding to one time unit. In some embodiments, the network device 120 may receive, from the terminal device, a first bitmap and a second bitmap to indicating at least one non zero coefficient corresponding to one layer in the CSI report that comprises CSI group 1 only or both CSI group 1 and CSI group 2, wherein CSI group 1 and CSI group 2 are determined based on a priority rule.

In some embodiments, a value n_ref for reference resource slot may be larger than or equal to a value of product of the number of time units and the number of slots corresponding to one time unit, if a first slot corresponding to the CSI report is configured to be slot with index n−n_ref.

In some embodiments, the terminal device 110 may determine or report a number of layers and at least one codebook indicator based on the at least one configuration to the network device. In some embodiments, the number of layers (e.g. represented as v) may be one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤v. For example, r may be one of {1, 2, . . . v} or {1, 2} or {1, 2, 3, 4} or {1, 2, 3, 4, 5, 6, 7, 8}.

In some embodiments, the terminal device 110 may determine or report or indicate an indication of a strongest coefficient corresponding to a layer with index r (r∈{1, 2, . . . v}). In some embodiments, the field size or the number of bits for the indication of the strongest coefficient corresponding to the layer with index r may be

$$⌈ {log}_{2} {\sum }_{t = 1}^{N or {N}_{TRP}} ( 2 {L}_{t} ) ⌉ .$$

For example, phase rotation or second vector remapping may be applied. In some embodiments, the field size or the number of bits for the indication of the strongest coefficient corresponding to the layer with index r may be

$$⌈ {log}_{2} {\sum }_{t = 1}^{N or {N}_{TRP}} ( 2 {L}_{t} * {M}_{v} ) ⌉ or ⌈ {log}_{2} {K}^{NZ} ⌉ .$$

In some embodiments, the field size or the number of bits for the indication of the strongest coefficient may be ┌log₂ K^{NZ}┐ if the number of layers is 1 (e.g. v=1). In some embodiments, the field size or the number of bits for the indication of the strongest coefficient may be ┌log₂ C(K^{NZ}, v)┐ or

$$⌈ {log}_{2} ( {K}_{v}^{NZ} ) ⌉$$

if the number of layers is larger than 1 (e.g. v>1 or 1<v≤4). In some embodiments, the indication of the strongest coefficient may indicate or correspond to v values or indexes. In some embodiments, the vsc-th value or the vsc-th index of the indication of strongest coefficient may correspond to the strongest coefficient corresponding to the layer with index r=vsc. For example, vsc may be positive integer. For example, vsc∈{1, 2, 3, 4} or vsc∈{1, 2, . . . v}. For example, the first value or the first index to the last value or the last index of the indication of strongest coefficient may correspond to the strongest coefficient corresponding to the layer with index r=1 to r=v in order, respectively. For example, phase rotation or second vector remapping may not be applied. For another example, the first codebook configuration may be configured to the terminal device 110.

In some embodiments, the terminal device 110 may determine or report or indicate an indication of a strongest coefficient corresponding to a layer with index r (r∈{1, 2, . . . v}). In some embodiments, the field size or the number of bits for the indication of the strongest coefficient corresponding to the layer with index r may be ┌log₂(2L·Q)┐. For example, phase rotation or second vector remapping may be applied. In some embodiments, the field size or the number of bits for the indication of the strongest coefficient corresponding to the layer with index r may be ┌log₂(2L·Mᵥ·Q)┐ or ┌log₂ K^{NZ}┐. In some embodiments, the field size or the number of bits for the indication of the strongest coefficient may be ┌log₂ K^{NZ}┐ if the number of layers is 1 (e.g. v=1). In some embodiments, the field size or the number of bits for the indication of the strongest coefficient may be ┌log₂ C(K^{NZ}, v)┐ or

$$⌈ {log}_{2} ( {K}_{v}^{NZ} ) ⌉$$

if the number of layers is larger than 1 (e.g. v>1 or 1≤v≤4). In some embodiments, the indication of the strongest coefficient may indicate or correspond to v values or indexes. In some embodiments, the vsc-th value or the vsc-th index of the indication of strongest coefficient may correspond to the strongest coefficient corresponding to the layer with index r=vsc. For example, vsc may be positive integer. For example, vsc∈{1, 2, 3, 4} or vsc∈{1, 2, . . . v}. For example, the first value or the first index to the last value or the last index of the indication of strongest coefficient may correspond to the strongest coefficient corresponding to the layer with index r=1 to r=v in order, respectively. For example, phase rotation or second vector remapping may not be applied. For another example, the second codebook configuration may be configured to the terminal device 110.

In some embodiments, one coefficient or one bit may correspond to a first index i or iₜ or i+L or iₜ+Lₜ and correspond to a second vector with index f or index fₜ and/or correspond to a third vector with index q and/or correspond to a CSI-RS resource with index t and/or correspond to a layer with index r. In some embodiments, the one coefficient or the bit may be at least one of one first amplitude coefficient, one second amplitude coefficient, one phase coefficient, one strongest coefficient one bit in the third bitmap and one bit in the fourth bitmap and one bit in the first bitmap. In some embodiments, the one coefficient or the one bit corresponding to first index i or iₜ or i+L or iₜ+Lₜ may correspond to the first vector with index i or it.

In some embodiments, i or iₜ or i_{SCI} may be a non-negative integer. In some embodiments, i or iₜ or i_{SCI}∈{0, 1, . . . 2Lₜ_{_{ref}}−1}. In some embodiments, i or iₜ or i_{SCI}∈{0, 1, . . . 2Lₜ−1}. In some embodiments, i or iₜ or i_{SCI}∈{0, 1, . . . 2L−1}. In some embodiments, i or iₜ or i_{SCI}∈{0, 1, . . . Lₜ_{_{ref}}−1}. In some embodiments, i or iₜ or i_{SCI}∈{0, 1, . . . Lₜ−1}. In some embodiments, i or iₜ or i_{SCI}∈{0, 1, . . . L−1}.

In some embodiments, Lₜ may be the number of first vectors corresponding to the CSI-RS resource with index t. In some embodiments, L may be the number of first vectors corresponding to one CSI-RS resource in the plurality of CSI-RS resources or in the second plurality of CSI-RS resources or corresponding to the CSI report. In some embodiments, Lₜ_{_{ref}} may be the number of first vectors corresponding to the reference CSI-RS resource (e.g. CSI-RS resource with index t_{ref}).

In some embodiments, the one coefficient or the one bit corresponding to the first index iₐₜ or iₐ may correspond to the first vector with index iₐₜ or iₐ and/or correspond to the CSI-RS with index t. In some embodiments, the one coefficient or the one bit corresponding to index iₐₜ or iₐ may correspond or may be comprised in the first group of coefficients. In some embodiments, the one coefficient or the one bit corresponding to the first index i_{ct} or i_{c} or iₐ+L or iₐₜ+Lₜ or iₐ+Lₜ_{_{ref}} may correspond to the first vector with index iₐₜ or iₐ. In some embodiments, the one coefficient or the one bit corresponding to index i_{ct} or i_{c} or iₐ+L or iₐₜ+Lₜ or iₐ+Lₜ_{_{ref}} may correspond or may be comprised in the second group of coefficients. In some embodiments, iₐ∈{0, 1, . . . Lₜ_{_{ref}}−1} or iₐₜ∈{0, 1, . . . Lₜ−1} or iₐ∈{0, 1, . . . L−1}. In some embodiments, i_{ct} or i_{c} may be iₐ+L or iₐₜ+Lₜ or iₐ+Lₜ_{_{ref}}.

In some embodiments, i or iₜ or

$${i}_{SCI} ∈ \{ 0 , 1 , … {\sum }_{t = 1}^{N or {N}_{TRP}} ( 2 {L}_{t} ) - 1 \} .$$

In some embodiments, i or iₜ or

$${i}_{SCI} ∈ \{ 0 , 1 , … {\sum }_{t = 1}^{N or {N}_{TRP}} ( {L}_{t} ) - 1 \} .$$

In some embodiments, the one coefficient or the one bit corresponding to the first index iₐ₁∈{0, 1, . . . 2L₁−1} may correspond to the first vector with index iₐ₁ if iₐ₁≤L₁−1 and may correspond to the first vector with index iₐ₁−L₁ if L₁≤iₐ₁≤2L₁−1 and/or may correspond to the CSI-RS resource with index t=1. In some embodiments, the one coefficient or the one bit corresponding to the first index iₐ₂∈{2L₁, 2L₁+1, . . . 2L₂+2L₁−1} may correspond to the first vector with index iₐ₂−L₁ if 2L₁≤iₐ₂≤2L₁+L₂−1 and may correspond to the first vector with index iₐ₂−L₁−L₂ if 2L₁+L₂≤iₐ₂≤2L₂+2L₁−1 and/or may correspond to the CSI-RS resource with index t=2. In some embodiments, the one coefficient or the one bit corresponding to the first index iₐ₃∈{2L₂+2L₁,2L₂+2L₁+1, . . . 2L₃+2L₂+2L₁−1} may correspond to the first vector with index iₐ₃−L₁−L₂ if 2L₂+2L₁≤iₐ₃≤2L₂+2L₁+L₃−1 and may correspond to the first vector with index iₐ₃−L₁−L₂−L₃ if 2L₂+2L₁+L₃≤iₐ₃≤2L₂+2L₁+2L₃−1 and/or may correspond to the CSI-RS resource with index t=3. In some embodiments, the one coefficient or the one bit corresponding to the first index iₐ₃∈{2L₃+2L₂+2L₁, 2L₃+2L₂+2L₁+1, . . . 2L₄+2L₃+2L₂+2L₁−1} may correspond to the first vector with index iₐ₄−L₁−L₂−L₃ if 2L₃+2L₂+2L₁≤iₐ₄≤2L₃+2L₂+2L₁+L₄−1 and may correspond to the first vector with index iₐ₄−L₁−L₂−L₃−L₄ if 2L₂+2L₁+2L₃+L₄≤iₐ₄≤2L₂+2L₁+2L₃+2L₄−1 and/or may correspond to the CSI-RS resource with index t=4.

In some embodiments, the one coefficient or the one bit corresponding to the first index {0, 1, . . . L₁−1} and/or

$$\{ {\sum }_{t = 1}^{N or {N}_{TRP}} ( {L}_{t} ) , {\sum }_{t = 1}^{N or {N}_{TRP}} ( {L}_{t} ) + 1 , … {\sum }_{t = 1}^{N or {N}_{TRP}} ( {L}_{t} ) + {L}_{1} - 1 \}$$

may correspond to the first vector with index {0, 1, . . . L₁−1}, respectively, and/or may correspond to the CSI-RS resource with index t=1. In some embodiments, the one coefficient or the one bit corresponding to the first index {L₁, L₁+1, . . . L₂+L₁−1} and/or

$$\{ {\sum }_{t = 1}^{N or {N}_{TRP}} ( {L}_{t} ) + 1 , {\sum }_{t = 1}^{N or {N}_{TRP}} ( {L}_{t} ) + {L}_{1} + 1 , … {\sum }_{t = 1}^{N or {N}_{TRP}} ( {L}_{t} ) + {L}_{2} + {L}_{1} - 1 \}$$

may correspond to the first vector with index {L₁, L₁+1, . . . L₂+L₁−1}, respectively, and/or may correspond to the CSI-RS resource with index t=2. In some embodiments, the one coefficient or the one bit corresponding to the first index {L₂+L₁, L₂+L₁+1, . . . L₃+L₂+L₁−1} and/or

$$\{ {\sum }_{t = 1}^{N or {N}_{TRP}} ( {L}_{t} ) + {L}_{1} + {L}_{2} , {\sum }_{t = 1}^{N or {N}_{TRP}} ( {L}_{t} ) + {L}_{1} + {L}_{2} + 1 , … {\sum }_{t = 1}^{N or {N}_{TRP}} ( {L}_{t} ) + {L}_{3} + {L}_{2} + {L}_{1} - 1 \}$$

may correspond to the first vector with index L₂+L₁, L₂+L₁+1 . . . . L₃+L₂+L₁−1), respectively, and/or may correspond to the CSI-RS resource with index t=3. In some embodiments, the one coefficient or the one bit corresponding to the first index {L₃+L₂+L₁, L₃+L₂+L₁+1, . . . L₄+L₃+L₂+L₁−1} and/or

$$\{ {\sum }_{t = 1}^{N or {N}_{TRP}} ( {L}_{t} ) + {L}_{1} + {L}_{2} + {L}_{3} , {\sum }_{t = 1}^{N or {N}_{TRP}} ( {L}_{t} ) + {L}_{1} + {L}_{2} + {L}_{3} + 1 , … {\sum }_{t = 1}^{N or {N}_{TRP}} ( {L}_{t} ) + {L}_{4} + {L}_{3} + {L}_{2} + {L}_{1} - 1 \}$$

may correspond to the first vector with index {L₃+L₂+L₁, L₃+L₂+L₁₊₁, . . . L₄+L₃+L₂+L₁−1}, respectively, and/or may correspond to the CSI-RS resource with index t=4.

In some embodiments, the one coefficient or the one bit corresponding to the first index of i_{b} may correspond to the first vector with index i_{b}. In some embodiments, the one coefficient or the one bit corresponding to index i_{b} may correspond or may be comprised in the first group of coefficients. In some embodiments,

$${i}_{b} ∈ \{ 0 , 1 , … {\sum }_{t = 1}^{N or {N}_{TRP}} ( {L}_{t} ) - 1 \} .$$

In some embodiments, i_{b} may be within range {0, 1, . . . L₁−1} (e.g. i_{b1}) and/or range {2L₁, 2L₁+1, . . . L₂+2L₁−1} (e.g. i_{b2}) and/or range {2L₂+2L₁, 2L₂+2L₁+1, . . . L₃+2L₂+2L₁−1} (e.g. i_{b3}) and/or range {2L₃+2L₂+2L₁, 2L₃+2L₂+2L₁+1, . . . L₄+2L₃+2L₂+2L₁−1} (e.g. i_{b4}). In some embodiments, the one coefficient or the one bit corresponding to index i_{d} or

$${i}_{b} + {\sum }_{t = 1}^{N or {N}_{TRP}} ( {L}_{t} )$$

may correspond or may be comprised in the second group of coefficients. In some embodiments, the one coefficient or the one bit corresponding to index (e.g. i_{d}) within range {L₁, L₁+1, . . . 2L₁−1} (e.g. i_{d1}) and/or range {L₂+2L₁, L₂+2L₁+1, . . . 2L₂+2L₁−1} (e.g. i_{d2}) and/or range {L₃+2L₂+2L₁, L₃+2L₂+2L, +1, . . . 2L₃+2L₂+2L₁−1} (e.g. i_{d3}) and/or range {L₄+2L₃+2L₂+2L₁, L₄+2L₃+2L₂+2L₁+1, . . . 2L₄+2L₃+2L₂+2L₁−1} (e.g. i_{d4}) may correspond or may be comprised in the second group of coefficients. In some embodiments, i_{bt} may correspond to a range as described, wherein t∈{1, 2, 3, 4}. In some embodiments, i_{dt} may correspond to a range as described, wherein t∈{1, 2, 3, 4}.

In some embodiments, f or fₜ or f_{SCI} may be a non-negative integer. In some embodiments, f or fₜ or f_{SCI}∈{0, 1, . . . Mᵥ−1}. In some embodiments, f or fₜ or f_{SCI}∈{0, 1, . . . N·Mᵥ−1} or ∈{0, 1, . . . N_{TRP}·Mᵥ−1}. In some embodiments, for the second vector with index within range of {0, 1, . . . Mᵥ−1), the second vector may be corresponding to the CSI-RS resource with index t=1. In some embodiments, for the second vector with index within range of {Mᵥ, Mᵥ+1, . . . 2Mᵥ−1}, the second vector may be corresponding to the CSI-RS resource with index t=2. In some embodiments, for the second vector with index within range of {2Mᵥ, 2Mᵥ+1, . . . 3Mᵥ−1}, the second vector may be corresponding to the CSI-RS resource with index t=3. In some embodiments, for the second vector with index within range of βMᵥ, 3Mᵥ+1, . . . 4Mᵥ−1}, the second vector may be corresponding to the CSI-RS resource with index t=4.

In some embodiments, the strongest coefficient or the indication of the strongest coefficient may correspond to a first index i_{SCI} (For example, the first index i_{SCI} may correspond to a first vector with index i_{SCI} or i_{SCI}−L or i_{SCI}−Lₜ) and correspond to a second vector with index f_{SCI} and/or correspond to a CSI-RS resource with index t_{ref} and/or correspond to a layer with index r. In some embodiments, i_{SCI} may be a non-negative integer. In some embodiments, i_{SCI}∈{0, 1, . . . 2Lₜ−1}. In some embodiments, Lₜ_{_{ref}} may be the number of first vectors corresponding to the reference CSI-RS resource (e.g. CSI-RS resource with index t_{ref}). In some embodiments, the value of f_{SCI} may be 0. For example, phase rotation or second vector remapping may be applied. For example, the first codebook configuration may be configured to the terminal device 110.

In some embodiments, the strongest coefficient or the indication of the strongest coefficient may correspond to a first index i_{SCI} (For example, the first index i_{SCI} may correspond to a first vector with index i_{SCI} or i_{SCI}−L or i_{SCI}−Lₜ) and correspond to a second vector with index f_{SCI} and correspond to a third vector with index esc, and/or correspond to a layer with index r. In some embodiments, i_{SCI} may be a non-negative integer. In some embodiments, i_{SCI}∈{0, 1, . . . 2L−1}. In some embodiments, L may be the number of first vectors for the CSI report. In some embodiments, L may be at least one of {2, 4, 6}. In some embodiments, f_{SCI} may be a non-negative integer. For example, f_{SCI}∈{0, 1, . . . Mᵥ−1}. In some embodiments, the value of f_{SCI} may be 0. For example, phase rotation or second vector remapping may be applied. In some embodiments, esc, may be a non-negative integer. In some embodiments, q_{SCI}∈{0, 1, . . . Q−1}. In some embodiments, q_{SCI}∈{1, 2, . . . Q}. In some embodiments, the value of q_{SCI} may be 0. For example, phase rotation or third vector remapping may be applied. For example, the second codebook configuration may be configured to the terminal device 110.

In some embodiments, there may be two groups of coefficients, wherein one group of coefficients may comprise at least one of: at least one first amplitude coefficient, at least one second amplitude coefficient, at least one phase coefficient and at least one bit (or a subset of bits) in the first bitmap (or in the third bitmap and the fourth bitmap) for non zero coefficients indication. In some embodiments, the two groups of coefficients may comprise a first group of coefficients and a second group of coefficients. In some embodiments, one group of coefficients may be with index s or index sₜ. In some embodiments, the value of s or sₜ may be 0 or 1. In some embodiments, the first group of coefficients may be the group of coefficients with index s=0 or sₜ=0. In some embodiments, the second group of coefficients may be the group of coefficients with index s=1 or sₜ=1. In some embodiments, the group of coefficients with index sₜ may correspond to the CSI-RS resource with index t. For example, s or sₜ may be for two polarizations. In some embodiments, s or s, may be for different groups of first vectors. In some embodiments, the first polarization may be with s=0 or s, =0. In some embodiments, the second polarization may be with s=1 or sₜ=1.

In some embodiments, the number of at least one first amplitude coefficient corresponding to one layer with index r in the CSI report may be 2 or 1 or 2·N_{TRP} or 2·N_{TRP}−1 or 2·N or 2·N−1. In some embodiments, one of the at least one first amplitude coefficient may be fixed as 1. For example, no need to be reported in the CSI report. In some embodiments, one first amplitude coefficient may correspond to one layer with index r and correspond to one group of coefficients with index s or/and correspond to one CSI CSI-RS resource with index t. In some embodiments, one first amplitude coefficient may be represented as

$${P}_{r , s , t}^{( 1 )} or {P}_{r , ⌊ \frac{i}{{L}_{t}} ⌋ , t}^{( 1 )} or {P}_{r , s}^{( 1 )} or {P}_{r , ⌊ \frac{i}{{L}_{t}} ⌋}^{( 1 )} or {P}_{r , {s}_{t} , t}^{( 1 )} or {P}_{r , {s}_{t}}^{( 1 )} .$$

In some embodiments,

$${P}_{r , s , t}^{( 1 )} or {P}_{r , ⌊ \frac{i}{{L}_{t}} ⌋ , t}^{( 1 )} or {P}_{r , {s}_{t} , t}^{( 1 )} or {P}_{r , {s}_{t}}^{( 1 )}$$

may be the first amplitude coefficient corresponding to layer with index r and corresponding to the CSI-RS resource with index t and/or corresponding to the group of coefficients with index s or sₜ or

$$⌊ \frac{i}{{L}_{t}} ⌋ .$$

In some embodiments,

$${P}_{r , s}^{( 1 )} or {P}_{r , ⌊ \frac{i}{{L}_{t}} ⌋}^{( 1 )}$$

may be the first amplitude coefficient corresponding to layer with index r and/or corresponding to the group of first amplitude coefficients with index s or

$$⌊ \frac{i}{{L}_{t}} ⌋ .$$

In some embodiments,

$$s = ⌊ \frac{i}{{L}_{t}} ⌋ or {s}_{t} = ⌊ \frac{i}{{L}_{t}} ⌋ or {s}_{t} = ⌊ \frac{i}{{Σ}_{t = 1}^{N or {N}_{TRP}} ( {L}_{t} )} ⌋ .$$

In some embodiments, i may be replaced with it or iₐ or i_{b} or i_{SCI}. In some embodiments, Lₜ may be replaced with Lₜ_{_{ref}} or L.

In some embodiments, if the first group of coefficients comprises or correspond to a first index with value i_{SCI}, the first amplitude coefficient corresponding to the first group of coefficients may be fixed as 1. For example, no need of report in the CSI report. In some embodiments, if

$$⌊ \frac{{i}_{SCI}}{{L}_{t}} ⌋ = 0 or ⌊ \frac{{i}_{SCI}}{L} ⌋ = 0 or ⌊ \frac{{i}_{SCI}}{{Σ}_{t = 1}^{N or {N}_{TRP}} ( {L}_{t} )} ⌋ = 0$$

or if i_{SCI} is within range of iₐ or within range or i_{b} or within range {0, 1, . . . L₁−1} and/or range {2L₁, 2L₁+1, . . . L₂+2L₁−1} and/or range{2L₂+2L, 2L₂+2L₁+1, . . . L₃+2L₂+2L₁−1} and/or range {2L₃+2L₂+2L₁, 2L₃+2L₂+2L₁+1, . . . L₄+2L₃+2L₂+2L₁−1}, the first amplitude coefficient corresponding to the first group of coefficients may be fixed as 1. For example,

$${P}_{r , 0 , t}^{( 1 )} or {P}_{r , 0}^{( 1 )}$$

may be fixed as 1. For another example, the value of

$${P}_{r , 1 , t}^{( 1 )} or {P}_{r , 1}^{( 1 )}$$

may be reported. In some embodiments, if the second group of coefficients comprises or correspond to a first index with value i_{SCI}, the first amplitude coefficient corresponding to the second group of coefficients may be fixed as 1. For example, no need of report in the CSI report. In some embodiments, if

$$⌊ \frac{{i}_{SCI}}{{L}_{t}} ⌋ = 1 or ⌊ \frac{{i}_{SCI}}{L} ⌋ = 1 or ⌊ \frac{{i}_{SCI}}{{Σ}_{t = 1}^{N or {N}_{TRP}} ( {L}_{t} )} ⌋ = 1$$

or if i_{SCI} is within range of i_{c} or within range or i_{d} or within range {L₁, L₁+1, . . . 2L₁−1} and/or range {L₂+2L₁, L₂+2L₁+1, . . . 2L₂+2L₁−1} and/or range {L₃+2L₂+2L₁, L₃+2L₂+2L, +1, . . . 2L₃+2L₂+2L₁−1} and/or range {L₄+2L₃+2L₂+2L₁, L₄+2L₃+2L₂+2L₁+1, . . . 2L₄+2L₃+2L₂+2L₁−1}, the first amplitude coefficient corresponding to the second group of coefficients may be fixed as 1. For example,

$${P}_{r , 1 , t}^{( 1 )} or {P}_{r , 1}^{( 1 )}$$

may be fixed as 1. For another example, the value of

$${P}_{r , 0 , t}^{( 1 )} or {P}_{r , 0}^{( 1 )}$$

may be reported.

In some embodiments, L may be the number of first vectors for the CSI report. In some embodiments, Lₜ may be the number of first vectors corresponding to the CSI-RS resource with index t. In some embodiments, Lₜ or L may be a positive integer or a non-negative integer. In some embodiments, 0≤Lₜ≤6 or 0≤L≤6. In some embodiments, L, or L may be at least one of {0, 2, 4, 6} or at least one of {2, 4, 6}. In some embodiments, L, or L may be the value corresponding to the selected one of the set of combinations of values for first vector and/or corresponding to the CSI-RS resource with index t.

In some embodiments, L may be the number of first vectors for the CSI report. In some embodiments, Lₜ may be the number of first vectors corresponding to the CSI-RS resource with index t. In some embodiments, Lₜ=K_{1,t}/2 or L=K₁/2. In some embodiments, K_{1,t} may be the number of ports selected from P ports corresponding to the CSI-RS resource with index t. In some embodiments, K₁ may be the number of ports selected from P ports corresponding to at least one CSI-RS resource in the plurality of CSI-RS resources or in the second plurality of CSI-RS resources. In some embodiments, K_{1,t}=αₜ*P. In some embodiments, K₁=α*P. In some embodiments, at or a may be at least one of {0, ½, ¾, 1} or at least one of {½, ¾, 1}. In some embodiments, a, may be the value corresponding to the selected one of the set of combinations of values for first vector and/or corresponding to the CSI-RS resource with index t. For example, configured for the second type of codebook. In some embodiments, Lₜ or L may be a positive integer or a non-negative integer. In some embodiments, 0≤Lₜ≤16 or 0≤L≤16. In some embodiments, 1≤Lₜ≤16 or 1≤L 16. For example, the terminal device 110 may be configured with the second type of codebook.

In some embodiments, K_{1,t} ports may be selected from P ports corresponding to the CSI-RS resource with index t based on L, first vectors vₘ_{^{(i,t)}}. In some embodiments, i=0, 1, . . . Lₜ−1. In some embodiments, m=[m⁽⁰⁾ . . . m^{(L}^{ₜ}⁻¹⁾]. In some embodiments,

$${m}^{( i , t \}} ∈ \{ 0 , 1 , … , \frac{P}{2} - 1 \} .$$

In some embodiments, the first vectors may be indicated based on an index i_{1,2}, and i_{1,2}

$$∈ \{ 0 , 1 , … , ( \begin{matrix}{P}_{CSI - RS} / 2 \\ {L}_{t}\end{matrix} ) - 1 \} .$$

In some embodiments, K₁ ports may be selected from P ports corresponding to at least one RS resource in the plurality of CSI-RS resources or in the second plurality of CSI-RS resources based on L first vectors vₘ_{⁽ⁱ⁾}. In some embodiments, i=0, 1, . . . L−1. In some embodiments, m=[m⁽⁰⁾ . . . m^{(L-1)}]. In some embodiments,

$${m}^{( i )} ∈ \{ 0 , 1 , … , \frac{P}{2} - 1 \} .$$

In some embodiments, the first vectors may be indicated based on an index i_{1,2}, and

$${i}_{1 , 2} ∈ \{ 0 , 1 , … , ( \begin{matrix}{P}_{CSI - RS} / 2 \\ L\end{matrix} ) - 1 \} .$$

In some embodiments,

$${P}_{r , i , f , t}^{( 2 )} or {P}_{r , i , f}^{( 2 )} or {P}_{r , {i}_{a} , f}^{( 2 )} or {P}_{r , {i}_{b} , f}^{( 2 )} or {P}_{r , {i}_{c} , f}^{( 2 )} or {P}_{r , {i}_{d} , f}^{( 2 )}$$

may be second amplitude coefficient corresponding to the layer with index r and corresponding to a first index i or iₐ or i_{b} or i_{c} or i_{d} (for example, corresponding to one first vector with index i or iₐ or i_{b}) and corresponding to second vector with index f and/or corresponding to the CSI-RS resource with index t. In some embodiments, f may be replaced with fₜ. In some embodiments,

$${P}_{r , {i}_{a} , f}^{( 2 )} or {P}_{r , {i}_{b} , f}^{( 2 )}$$

may correspond to the first group of coefficients (e.g. with index 0). In some embodiments,

$${P}_{r , {i}_{c} , f}^{( 2 )} or {P}_{r , {i}_{d} , f}^{( 2 )}$$

may correspond to the second group of coefficients (e.g. with index 1). In some embodiments,

$${P}_{r , i , f , t}^{( 2 )} or {P}_{r , i , f}^{( 2 )} or {P}_{r , {i}_{a} , f}^{( 2 )} or {P}_{r , {i}_{b} , f}^{( 2 )} or {P}_{r , {i}_{c} , f}^{( 2 )} or {P}_{r , {i}_{d} , f}^{( 2 )}$$

may be used interchangeably.

In some embodiments,

$${P}_{r , i , f , q}^{( 2 )} or {P}_{r , i + L , f , q}^{( 2 )}$$

may be second amplitude coefficient corresponding to the layer with index r and corresponding to a first index i or i+L (for example, corresponding to one first vector with index i) and/or corresponding to second vector with index f and/or corresponding to third vector with index q. In some embodiments,

$${P}_{r , i , f , q}^{( 2 )}$$

may correspond to the first group of coefficients (e.g. with index 0). In some embodiments,

$${P}_{r , i + L , f , q}^{( 2 )}$$

may correspond to the second group of coefficients (e.g. with index 1).

In some embodiments, φ_{r,i,f,t} or φ_{r,i,f} or φ_{r,i}_{ₐ}_{,f} or φ_{r,i}_{_{b}}_{,f} or φ_{r,i}_{_{c}}_{,f} or φ_{r,i}_{_{d}}_{,f} may be phase coefficient corresponding to the layer with index r and corresponding to a first index i or iₐ or i_{b} or i_{c} or i_{d} (for example, corresponding to one first vector with index i or iₐ or i_{b}) and corresponding to second vector with index f and/or corresponding to the CSI-RS resource with index t. In some embodiments, φ_{r,i}_{ₐ}_{,f} or φ_{r,i}_{_{b}}_{,f} may correspond to the first group of coefficients (e.g. with index 0). In some embodiments, φ_{r,i}_{_{c}}_{,f} or φ_{r,i}_{_{d}}_{,f} may correspond to the second group of coefficients (e.g. with index 1). In some embodiments, φ_{r,i,f,t} or φ_{r,i,f} or φ_{r,i}_{ₐ}_{,f} or φ_{r,i}_{_{b}}_{,f} or φ_{r,i}_{_{c}}_{,f} or φ_{r,i}_{_{d}}_{,f} may be used interchangeably.

In some embodiments, φ_{r,i,f,q} or φ_{r,i+L,f,q} may be phase coefficient corresponding to the layer with index r and corresponding to a first index i or i+L (for example, corresponding to one first vector with index i) and/or corresponding to second vector with index f and/or corresponding to third vector with index q. In some embodiments, φ_{r,i,f,q} may correspond to the first group of coefficients (e.g. with index 0). In some embodiments, φ_{r,i+L,f,q} may correspond to the second group of coefficients (e.g. with index 1).

In some embodiments, the second amplitude coefficient corresponding to the first index i_{SCI} (For example, the first index i_{SCI} may correspond to a first vector with index i_{SCI} or i_{SCI}−L or i_{SCI}−Lₜ) and corresponding to the second vector with index f_{SCI} and/or corresponding to a CSI-RS resource with index t_{ref} and/or corresponding to a layer with index r may be 1. For example, no need to be reported in the CSI report.

In some embodiments, the phase coefficient corresponding to the first index i_{SCI} (For example, the first index i_{SCI} may correspond to a first vector with index i_{SCI} or i_{SCI}−L or i_{SCI}−Lₜ) and corresponding to the second vector with index f_{SCI} and/or corresponding to a CSI-RS resource with index t_{ref} and/or corresponding to a layer with index r may be 1. For example, no need to be reported in the CSI report.

In some embodiments, the terminal device 110 may receive at least one CSI-RS resource in the plurality of CSI-RS resources or in the second plurality of CSI-RS resources based on the number of antenna ports for a CSI-RS resource.

In some embodiments, for each one CSI-RS resource in the plurality of CSI-RS resources, there may be P ports. In some embodiments, P may be a positive integer. In some embodiments, P) may be at least one of {2, 4, 8, 12, 16, 24, 32}.

In some embodiments, a value of the first parameter of antenna port configuration may be represented as N₁. For example, N₁ may be a positive integer. For example, N₁ may be one of {2, 3, 4, 6, 8, 12, 16}. In some embodiments, a value of the second parameter of antenna port configuration may be represented as N₂. For example, N₂ may be a positive integer. For example, N₂ may be one of {1, 2, 3, 4}. In some embodiments, the first parameter of antenna port configuration and the second parameter of antenna port configuration may be configured in one higher layer parameter.

In some embodiments, the terminal device may be configured with the second codebook configuration. In some embodiments, the plurality of CSI-RS resources may comprise Nᵥₑ CSI-RS resources. In some embodiments, the plurality of CSI-RS resources may be the Nᵥₑ CSI-RS resources. In some embodiments, the number of CSI-RS resources in the plurality of CSI-RS resources may be Nᵥₑ. In some embodiments, Nᵥₑ may be a positive integer. For example, 2≤Nᵥₑ≤8 or 2≤Nᵥₑ≤16 or 2≤Nᵥₑ≤4.

In some embodiments, the number of antenna ports for each CSI-RS resource in the plurality of CSI-RS resources or in the second plurality of CSI-RS resources may be determined based on the first parameter of antenna port configuration and a second parameter of antenna port configuration. In some embodiments, the number of antenna ports for the CSI-RS resource may be P=N₁·N₂·2.

In some embodiments, each value in a combination of values for first vector may correspond to a CSI-RS resource with index t or correspond to one TRP or correspond to one TRP group.

In some embodiments, the terminal device 110 may be configured with a number of PRBs for a bandwidth part (BWP) or with a size for the BWP. In some embodiments, the number of PRBs for the BWP (e.g. represented as

$${N}_{BWP}^{size} )$$

may be a positive integer. For example, N_{BWP} may be a positive integer. For example,

$$24 \leq {N}_{BWP}^{size} \leq 275.$$

In some embodiments, the terminal device 110 may be configured with a starting position of the BWP (e.g. represented as

$${N}_{BWP}^{start} ) .$$

For example,

$${N}_{BWP}^{start}$$

may be a non-negative integer. For example,

$$0 \leq {N}_{BWP}^{start} \leq 275.$$

In some embodiments, the starting position of the BWP and the number of PRBs for the BWP may be configured in one higher layer parameter.

In some embodiments, subband may correspond to a subband for CQI or CQI subband or CSI subband.

In some embodiments, the size of one subband or the number of PRBs of one subband may be represented as

$${N}_{PRB}^{SB} , and {N}_{PRB}^{SB}$$

is a positive integer. For example,

$$1 \leq {N}_{PRB}^{SB} \leq 32.$$

For example.

$${N}_{PRB}^{SB}$$

may be at least one of {4, 8, 16, 32}. In some embodiments

$${N}_{PRB}^{SB}$$

may be based on the value of N_{BWP}. In some embodiments, if 24≤N_{BWP}≤72,

$${N}_{PRB}^{SB}$$

may be 4 or 8. For example,

$${N}_{PRB}^{SB}$$

may be configured to be 4 or 8 based on one higher layer parameter for subband. In some embodiments, if 73≤N_{BWP}≤144,

$${N}_{PRB}^{SB}$$

may be 8 or 16. For example,

$${N}_{PRB}^{SB}$$

may be configured to be 8 or 16 based on the higher layer parameter for subband. In some embodiments, if 145≤N_{BWP}≤275,

$${N}_{PRB}^{SB}$$

may be 16 or 32. For example,

$${N}_{PRB}^{SB}$$

NPR may be configured to be 16 or 32 based on the higher layer parameter for subband.

In some embodiments, the third parameter for codebook (for example, represented as R) may be a positive integer. For example, R may be a positive integer. For example, R may be one of {1, 2}. In some embodiments, the total number of precoding matrices N₃ may be determined based on the third parameter for codebook and the number of the plurality of subbands. In some embodiments, the third parameter for codebook may control the total number of precoding matrices N₃ indicated by the PMI as a function of the number of configured subbands or the number of the plurality of subbands, the size of one subband and of the number of PRBs for the BWP. In some embodiments, if the second plurality of CSI-RS resources includes only one CSI-RS resource, the value of R may be either 1 or 2. In some embodiments, if the second plurality of CSI-RS resources includes more than one CSI-RS resource, the value of R may be 1.

In some embodiments, the total number of precoding matrices N₃ or the size or the length of one second vector may be a positive integer. For example, 9≤N₃≤36. For another example, 1≤N₃≤36. In some embodiments, the number of the plurality of second vectors Mᵥ may be a positive integer. For example,

$${M}_{υ} = ⌈ {p}_{υ} \frac{{N}_{3}}{R} ⌉ .$$

For example, 1≤Mᵥ≤9. For example, Mᵥ may be at least one of {1, 2, 3, 4, 5, 6, 7, 8, 9, 10}.

In some embodiments, a plurality of recoding matrices may be determined from L+Mᵥ vectors or Lₜ+Mᵥ vectors or

$${Σ}_{t = 1}^{{N}_{TRP}} {L}_{t} + {M}_{υ}$$

vectors or

$${Σ}_{t = 1}^{N} {L}_{t} + {M}_{υ}$$

vectors or

$${Σ}_{t = 1}^{{N}_{TRP}} {L}_{t} + {N}_{TRP} \cdot {M}_{υ}$$

vectors or

$${Σ}_{t = 1}^{N} {L}_{t} + N \cdot {M}_{υ}$$

vectors.

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a. In some embodiments, b!=1*2* . . . *(b−1)*b. In some embodiments, (a−b)!=1*2* . . . *(a−b−1)*(a−b). In some embodiments, C(a, b) and/or

$$( \begin{matrix}a \\ b\end{matrix} )$$

may be nchoosek(a, b). In some embodiments, a and/or b may be positive integer. In some embodiments, a may be larger than or no less than b. In some embodiments, 1≤a≤32. In some embodiments, 1≤b≤32. In some embodiments, 1≤b≤a.

In some embodiments, the terminal device may receive the at least one configuration via at least one of RRC, MAC CE and DCI.

In some embodiments, if the terminal device 110 is configured with the first mode of codebook structure and/or configured with the second mode of codebook structure and/or configured with first type of codebook and/or configured with second type of codebook, the number of first vectors for each CSI-RS resource in the plurality of CSI-RS resources or in the second plurality of CSI-RS resources may be same or different or independent. In some embodiments, if the terminal device 110 is configured with the first mode of codebook structure and/or configured with the second mode of codebook structure and/or configured with first type of codebook and/or configured with second type of codebook, the first vectors for each CSI-RS resource in the plurality of CSI-RS resources or in the second plurality of CSI-RS resources may be independent or different.

In some embodiments, if the terminal device 110 is configured with the first mode of codebook structure, the terminal device 110 may determine or select a number of first vectors corresponding to each CSI-RS resource in the plurality of CSI-RS resources or in the second plurality of CSI-RS resources, and the terminal device 110 may determine or select a number of second vectors corresponding to each CSI-RS resource in the plurality of CSI-RS resources or in the second plurality of CSI-RS resources. In some embodiments, if the terminal device 110 is configured with the first mode of codebook structure, the terminal device 110 may determine or select independent second vectors across CSI-RS resources in the plurality of CSI-RS resources or in the second plurality of CSI-RS resources. In some embodiments, if the terminal device 110 is configured with the first mode of codebook structure, the second vectors for each CSI-RS resource in the plurality of CSI-RS resources or in the second plurality of CSI-RS resources may be different or independent.

In some embodiments, if the terminal device 110 is configured with the first mode of codebook structure, the terminal device 110 may determine or select Mᵥ second vectors for each CSI-RS resource in the plurality of CSI-RS resources or in the second plurality of CSI-RS resources. For example, the terminal device 110 may be configured with the first type of codebook and/or the first codebook configuration. In some embodiments, the number of second vectors Mᵥ for each CSI-RS resource in the plurality of CSI-RS resources or in the second plurality of CSI-RS resources may be same. In some embodiments, the value of Mᵥ may be positive integer. For example, 1≤Mᵥ≤9. In some embodiments, the total number of second vectors for the CSI report may be Mᵥ*N_{TRP} or Mᵥ*N.

In some embodiments, if the terminal device 110 is configured with the first mode of codebook structure, the terminal device 110 may determine or select M second vectors for each CSI-RS resource in the plurality of CSI-RS resources or in the second plurality of CSI-RS resources. For example, the terminal device 110 may be configured with the second type of codebook and/or the first codebook configuration. In some embodiments, the number of second vectors M for each CSI-RS resource in the plurality of CSI-RS resources or in the second plurality of CSI-RS resources may be same. In some embodiments, the value of M may be positive integer. For example, M may be 1 or 2. For another example, M may be 1, if the number of CSI-RS resources in the second plurality of CSI-RS resources is larger than 1 or larger than 2. In some embodiments, the total number of second vectors for the CSI report may be M*N_{TRP} or M*N.

In some embodiments, if the terminal device 110 is configured with the first mode of codebook structure, the first vectors and/or the second vectors selection may be per CSI-RS resource in the plurality of CSI-RS resources or in the second plurality of CSI-RS resources or per TRP or per TRP group, the first mode of codebook structure may allow independent second vectors selection across CSI-RS resources in the plurality of CSI-RS resources or in the second plurality of CSI-RS resources or across TRPs or across TRP groups.

In some embodiments, an example formulation for the first mode of codebook structure may be:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] .$$

In some embodiments, if the terminal device 110 is configured with the second mode of codebook structure, the terminal device 110 may determine or select a number of first vectors corresponding to each CSI-RS resource in the plurality of CSI-RS resources or in the second plurality of CSI-RS resources, and the terminal device 110 may determine or select a number of same second vectors corresponding to each CSI-RS resource in the plurality of CSI-RS resources or in the second plurality of CSI-RS resources. In some embodiments, if the terminal device 110 is configured with the second mode of codebook structure, the terminal device 110 may determine or select same or common second vectors across CSI-RS resources in the plurality of CSI-RS resources or in the second plurality of CSI-RS resources. In some embodiments, if the terminal device 110 is configured with the second mode of codebook structure, the terminal device 110 may determine or select same or common second vectors across CSI-RS resources in the plurality of CSI-RS resources or in the second plurality of CSI-RS resources. In some embodiments, if the terminal device 110 is configured with the second mode of codebook structure, the second vectors for each CSI-RS resource in the plurality of CSI-RS resources or in the second plurality of CSI-RS resources may be same or common.

In some embodiments, if the terminal device 110 is configured with the second mode of codebook structure, the terminal device 110 may determine or select Mᵥ second vectors for all CSI-RS resources in the plurality of CSI-RS resources or in the second plurality of CSI-RS resources. In some embodiments, if the terminal device 110 is configured with the second mode of codebook structure, the determined or selected Mᵥ second vectors may be common or same for each one of the plurality of CSI-RS resources or for each one of the second plurality of CSI-RS resources. For example, the terminal device 110 may be configured with the first type of codebook and/or the first codebook configuration. In some embodiments, the number of second vectors Mᵥ for each one of the plurality of CSI-RS resources or each one of the second plurality of CSI-RS resources may be same. In some embodiments, the value of Mᵥ may be positive integer. For example, 1≤Mᵥ≤9. In some embodiments, the total number of second vectors for the CSI report may be Mᵥ.

In some embodiments, if the terminal device 110 is configured with the second mode of codebook structure, the terminal device 110 may determine or select M second vectors for all CSI-RS resources in the plurality of CSI-RS resources or in the second plurality of CSI-RS resources. In some embodiments, if the terminal device 110 is configured with the second mode of codebook structure, the determined or selected M second vectors may be common or same for each one of the plurality of CSI-RS resources or for each one of the second plurality of CSI-RS resources. For example, the terminal device 110 may be configured with the second type of codebook and/or the first codebook configuration. In some embodiments, the number of second vectors M for each one of the plurality of CSI-RS resources or each one of the second plurality of CSI-RS resources may be same. In some embodiments, the value of M may be positive integer. For example, M may be 1 or 2. For another example, M may be 1, if the number of CSI-RS resources in the second plurality of CSI-RS resources is larger than 1 or larger than 2. In some embodiments, the total number of second vectors for the CSI report may be M.

In some embodiments, if the terminal device 110 is configured with the second mode of codebook structure, the first vectors and/or the second vectors selection may be same or common for each CSI-RS resource or for each TRP or for each TRP group or for all CSI-RS resources or for all TRPs or for all TRP groups. For example, the second mode of codebook structure may determine or select common or joint second vectors across CSI-RS resources or across TRPs or across TRP groups.

In some embodiments, an example formulation for the second mode of codebook structure may be:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] .$$

In some embodiments, the terminal device may be configured with at least one of a first codebook configuration and a second codebook configuration. In some embodiments, the first codebook configuration may be the codebook enhancement or the CSI enhancement for coherent joint transmission. In some embodiments, the first codebook configuration may be the codebook for coherent joint transmission or the CSI for coherent joint transmission. For example, based on at least one TRP or based on multi-TRP. In some embodiments, the second codebook configuration may be the codebook enhancement or the CSI enhancement for velocity or high/medium velocity. In some embodiments, the second codebook configuration may be the codebook with third vector or the codebook with doppler domain vector or the CSI with third vector or the CSI with doppler domain vector. In some embodiments, the first codebook configuration and/or the second codebook configuration may comprise at least one first vector and/or at least one second vector.

In some embodiments, for the first codebook configuration, regarding the spatial domain (SD) basis selection or the first vector selection, for a configured value of N_{TRP}, a set of N_{L} combinations, of values for {L₁, . . . , L_{N}_{_{TRP}}} may be configured by the network device via higher layer (for example, radio resource control (RRC)) signaling. In some embodiments, the value of N_{L} may be a positive integer. In some embodiments, the value of N_{L} may be at least one of {1, 2, 3, 4, 5, 6, 7, 8}. In some embodiments, when N_{L}>1, the selected combination of values for {L₁, . . . , L_{N}_{_{TRP}}} may be reported in CSI part 1 using an indication, and the combination of values for {L₁, . . . , L_{N}_{_{TRP}}} may be selected from the N_{L} configured combinations. In some embodiments, the SD basis selection or the first vector selection for the n-th (n=1, . . . , N) selected CSI-RS resource may be indicted in CSI part 2 using a combinatorial indicator selected from a set of

$$( \begin{matrix}{P}_{CSI - RS} / 2 \\ {L}_{t}\end{matrix} )$$

codepoints, wherein, for the first type of codebook, P_{CSI-RS}=2*N₁N₂. In some embodiments, the supported candidate values for each of the Le parameters may be at least one of {2, 4, 6} for the first type of codebook. In some embodiments, for the second type of codebook, the network device may configure a set of N_{L} combinations for {α₁, . . . , α_{N}_{_{TRP}}}. In some embodiments, Lₜ=αₜ*P_{CSI-RS}/2. In some embodiments, αₜ may be at least one of {½, ¾, 1}. In some embodiments, P_{CSI-RS} may be the number of antenna ports for one CSI-RS in the plurality of CSI-RS resources or in the second plurality of CSI-RS resources. In some embodiments, P_{CSI-RS} may be same as P.

In some embodiments, for the first codebook configuration, and for codebook mode-1 or for the first mode of codebook structure, at least one of the following embodiments may be selected. In some embodiments, the use of per-CSI-RS-resource frequency domain (FD) basis selection offset (relative to a reference CSI-RS resource) for independent FD basis selection across N CSI-RS resources. For example,

$${W}_{f , t} = diag ( [ 1 {e}^{j \frac{2 π}{{N}_{3}} {φ}_{t}} {e}^{j \frac{2 π}{{N}_{3}} 2 \cdot {φ}_{t}} … {e}^{j \frac{2 π}{{N}_{3}} ( {N}_{3} - 1 ) \cdot {φ}_{t}} ] ) \cdot {W}_{f} ,$$

where φₜ may be the FD basis selection offset for CSI-RS resource with index t relative to a reference CSI-RS resource with index t_{ref} with φₜ_{_{ref}}=0 and W_{f} may be at least one second vector which may be commonly selected across N CSI-RS resources. In some embodiments, W_{f,t} may be at least one second vector which may be independently selected across N CSI-RS resources (for example, without any per-CSI-RS-resource FD basis selection offset). In some embodiments, W_{f,t} may be at least one second vector corresponding to the CSI-RS resource with index t in the N CSI-RS resources. In some embodiments, the use of per-CSI-RS-resource FD basis selection offset (relative to a reference CSI-RS resource) for independent FD basis selection across N CSI-RS resources, for example:

$${W}_{f , t} = diag ( [ 1 {e}^{j \frac{2 π}{{N}_{3}} {φ}_{t}} {e}^{j \frac{2 π}{{N}_{3}} 2 \cdot {φ}_{t}} … {e}^{j \frac{2 π}{{N}_{3}} ( {N}_{3} - 1 ) \cdot {φ}_{t}} ] ) \cdot {W}_{f} ,$$

where φₜ may be the FD basis selection offset for CSI-RS resource with index t relative to a reference CSI-RS resource with index t_{ref} with φₜ_{_{ref}}=0 with φₜ_{_{ref}}=0 and \tilde{W}_{f,t} may be at least one second vector which may be commonly selected across N CSI-RS resources. In some embodiments, for the first codebook configuration, regarding the codebook parameter pᵥ, it may support the additional value of pᵥ=½ for v=1, 2, 3, 4. For example, the additional value of pᵥ=½ for v=1, 2, 3, 4 may be applied with the following condition: only to be used in combination with other parameter value(s) to limit the increase in precoding matrix indicator (PMI) overhead comparable to the maximum overhead of the Rel-16/17 Type-II codebooks.

In some embodiments, W_{1,t} may be a matrix comprising the first vectors corresponding to the CSI-RS resource with index t. In some embodiments,

$${W}_{1 , t} = [ \begin{matrix}{B}_{t} & 0 \\ 0 & {B}_{t}\end{matrix} ] ,$$

wherein

$${B}_{t} = {v}_{{m}_{1}^{( 0 , t )} , {m}_{2}^{( 0 , t )}} {v}_{{m}_{1}^{( 1 , t )} , {m}_{2}^{( 1 , t )}} … {v}_{{m}_{1}^{( {L}_{t} - 1 , t )} , {m}_{2}^{( {L}_{t} - 1 , t )} .}$$

For example, size of W_{1,t} may be (2*N₁*N₂)*(2*Lₜ). For example, there may be 2*N₁*N₂ rows and 2*Lₜ columns in W_{1,t}. For example, a size of Bₜ and “0” in W_{1,t} may be (Nₜ*N₂)*Lₜ. For example, N₁*N₂ rows and Lₜ columns. For example. “0” in W_{1,t} may be a zero matrix with size (N₁*N₂)*Lₜ. For example, N₁*N₂ rows and Lₜ columns.

In some embodiments,

$${W}_{1 , t} = [ \begin{matrix}\begin{matrix}{v}_{{m}_{1}^{( 0 , t )} , {m}_{2}^{( 0 , t )}} {v}_{{m}_{1}^{( 1 , t )} , {m}_{2}^{( 1 , t )}} … \\ {v}_{{m}_{1}^{( {L}_{t} - 1 , t )} , {m}_{2}^{( {L}_{t} - 1 , t )}}\end{matrix} & 0 \\ 0 & \begin{matrix}{v}_{{m}_{1}^{( 0 , t )} , {m}_{2}^{( 0 , t )}} {v}_{{m}_{1}^{( 1 , t )} , {m}_{2}^{( 1 , t )}} … \\ {v}_{{m}_{1}^{( {L}_{t} - 1 , t )} , {m}_{2}^{( {L}_{t} - 1 , t )}}\end{matrix}\end{matrix} ] .$$

In some embodiments,

$${v}_{{m}_{1}^{( i , t )} , {m}_{2}^{( i , t )}}$$

may be the first vector with index i and/or corresponding to the CSI-RS resource with index t. In some embodiments,

$${v}_{{m}_{1}^{( i )} , {m}_{2}^{( i )}} or {v}_{{m}_{1}^{( {i}_{t} )} , {m}_{2}^{( {i}_{t} )}}$$

may be the first vector with index i or iₜ and/or corresponding to the CSI-RS resource with index t.

In some embodiments, there may be a vector uₘ_{₂}. In some embodiments, uₘ_{₂} may be a DFT vector. In some embodiments, if N₂>1,

$${u}_{{m}_{2}} = [ 1 , {e}^{j \frac{2 π {m}_{2}}{{O}_{2} {N}_{2}}} , … , {e}^{j \frac{2 π {m}_{2} ( {N}_{2} - 1 )}{{O}_{2} {N}_{2}}} ] .$$

In some embodiments, if N₂=2,

$${u}_{{m}_{2}} = [ 1 , {e}^{j \frac{2 π {m}_{2}}{{O}_{2} {N}_{2}}} ] .$$

In some embodiments, if N₂=1, uₘ_{₂}=1. In some embodiments, m₂ may be a non-negative integer. For example, 0≤m₂≤O₂N₂−1. In some embodiments, there may be a vector vₘ_{₁}_{,m}_{₂}. In some embodiments,

$${v}_{{m}_{1} , {m}_{2}} = {[ {u}_{{m}_{2}} , {u}_{{m}_{2}} * {e}^{j \frac{2 π {m}_{1}}{{O}_{1} {N}_{1}}} , … , {u}_{{m}_{2}} * {e}^{j \frac{2 π {m}_{1} ( {N}_{1} - 1 )}{{O}_{1} {N}_{1}}} ]}^{T} .$$

In some embodiments, if N₁=2 and N₂=2,

$${v}_{{m}_{1} , {m}_{2}} = {[ 1 , {e}^{j \frac{2 π {m}_{2}}{{O}_{2} {N}_{2}}} , {e}^{j \frac{2 π {m}_{1}}{{O}_{1} {N}_{1}}} , {e}^{j \frac{2 π {m}_{2}}{{O}_{2} {N}_{2}}} * {e}^{j \frac{2 π {m}_{1}}{{O}_{1} {N}_{1}}} ]}^{T} .$$

In some embodiments, if N₁=4 and N₂=1,

$${v}_{{m}_{1} , {m}_{2}} = {[ 1 , {e}^{j \frac{2 π {m}_{1}}{{O}_{1} {N}_{1}}} , {e}^{j \frac{2 π {m}_{1} * 2}{{O}_{1} {N}_{1}}} , {e}^{j \frac{2 π {m}_{1} * 3}{{O}_{1} {N}_{1}}} ]}^{T} .$$

In some embodiments, m₁ may be a non-negative integer.

For example, 0≤m₁≤O₁N₁−1. In some embodiments, [ ]^{T} may represent a transposition of a vector or a matrix.

In some embodiments, \tilde{W}_{2,t} may be a matrix comprising at least one of the first amplitude coefficients, the second amplitude coefficients, and the phase coefficients and/or corresponding to the CSI-RS resource with index t.

In some embodiments, f may be an index of one second vector for the CSI report. For example, f=0, 1, . . . Mᵥ−1. In some embodiments, fₜ may be an index of one second vector corresponding to the CSI-RS resource with index t for the CSI report. For example, fₜ=0, 1, . . . Mᵥ−1. In some embodiments, f may be replaced with fₜ.

In some embodiments, there may be a parameter “O₁”, and “O₁” may represent a first discrete fourier transform (DFT) oversampling in the first dimension. For example, “O₁” may be one of {1, 2, 4}. For another example, “O” may be 2 or 4. In some embodiments, there may be a parameter “O₂”, and “O₂” may represent a second DFT oversampling in the second dimension. For example, “O₂” may be one of {1, 2, 4}. For another example, “O₂” may be 2 or 4.

In some embodiments, one configuration of (N₁,N₂) may correspond to one configuration of (O₁,O₂). In some embodiments, one configuration of (O₁,O₂) may correspond to one configuration of (N₁,N₂). In some embodiments, the example configurations of (N₁,N₂) and (O₁,O₂) may be at least one of row and/or column in Table 1.

TABLE 1
Supported configurations of
(N₁, N₂) and (O₁, O₂)

| Number of | | |
|---|---|---|
| CSI-RS | | |
| antenna ports, | | |
| P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

In some embodiments, a value of one phase coefficient may be e^{j2π·c}^{ₚ}^{/N}^{_{PSK}}. In some embodiments, cₚ, may be a value of one indicator or one field for the phase coefficient. In some embodiments, cₚ, may be a non-negative integer. In some embodiments, cₚ, may be at least one of {0, 1, 2, 3} or {0, 1, 2, 3, 4, 5, 6, 7} or {0, 1, 2, 3, 4, 5, 6, 7, 8, 9, 10, 11, 12, 13, 14, 15}. In some embodiments. N_{PSK} may be the size for indication of cₚ. In some embodiments, N_{PSK} may be a positive integer. In some embodiments, N_{PSK} may be at least one of {2, 4, 8, 16}.

In some embodiments, a value of one second amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, a value of one first amplitude coefficient may be at least one of

$$\{ 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} \text{} or \{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{8} )}^{1 / 4} , \frac{1}{\sqrt{2}} , {( \frac{1}{2} )}^{1 / 4} , 1 \} \text{} \text{} or \{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} or \{ 0 , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} or \{ \frac{1}{\sqrt{2}} , 1 \} or \{ \frac{1}{2 \sqrt{2}} , \frac{1}{2} , \frac{1}{\sqrt{2}} , 1 \}$$

In some embodiments,

$${W}_{f , t}^{H}$$

may be a matrix comprising the second vectors corresponding to the CSI-RS resource with index t. For example, the terminal device 110 is configured with the first mode of codebook structure. In some embodiments,

$${W}_{f}^{H}$$

may be a matrix comprising the second vectors corresponding to all or each one of CSI-RS resource in the plurality of CSI-RS resources or corresponding to all or each one of CSI-RS resource in the second plurality of CSI-RS resources. For example, the terminal device 110 is configured with the second mode of codebook structure. In some embodiments, [ ]^{H} may represent a conjugate transpose or conjugate transposition of a vector or a matrix.

In some embodiments, for second vectors (e.g. represented as W_{f} or

$${W}_{f}^{H} or {W}_{f , t}^{H} )$$

corresponding to layer with index r and/or corresponding to the CSI-RS resource with index t,

$${W}_{f} or {W}_{f}^{H} or {W}_{f , t}^{H} = {[ {F}_{{n}_{3 , r}^{( 0 )}} {F}_{{n}_{3 , r}^{( 1 )}} {…F}_{{n}_{3 , r}^{( {M}_{v} - 1 )}} ]}^{T} .$$

In some embodiments, the size of W_{f} or

$${W}_{f}^{H} or {W}_{f , t}^{H}$$

may be Mᵥ*N₃.

In some embodiments,

$${n}_{3 , r}^{( f )} ∈ \{ 0 , 1 , … , {N}_{3} - 1 \} .$$

In some embodiments,

$${n}_{3 , r , t}^{( f )} ∈ \{ 0 , 1 , … , {N}_{3} - 1 \}$$

corresponding to layer with index r and corresponding to the CSI-RS resource with index t. In some embodiments,

$${n}_{3 , t}^{( f )} ∈ \{ 0 , 1 , … , {N}_{3} - 1 \}$$

corresponding to the CSI-RS resource with index t. For example, common or same for different layers.

In some embodiments,

$${F}_{{n}_{3 , r}^{( f )}} = {[ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} & … & {e}^{j \frac{2 π * ( {N}_{3} - 1 ) * {n}_{3 , r}^{( f )}}{{N}_{3}}}\end{matrix} ]}^{T}$$

In some embodiments,

$${n}_{4 , r}^{( q )} ∈ \{ 0 , 1 , … , {N}_{4} - 1 \}$$

In some embodiments,

$${n}_{4 , r}^{( q )} ∈ \{ 0 , 1 , … , {N}_{4} - 1 \}$$

may be the parameter for the third vector corresponding to layer with index r.

In some embodiments,

$${F}_{{n}_{4 , r}^{( q )}} = {[ \begin{matrix}1 & {e}^{j \frac{2 π * 1 * {n}_{4 , r}^{( q )}}{{N}_{4}}} & {e}^{j \frac{2 π * 2 * {n}_{4 , r}^{( q )}}{{N}_{4}}} & … & {e}^{j \frac{2 π * ( {N}_{4} - 1 ) * {n}_{4 , r}^{( q )}}{{N}_{4}}}\end{matrix} ]}^{T} .$$

In some embodiments, for the first type of codebook and/or for the second type of codebook and/or first mode of codebook structure and/or first codebook configuration corresponding to layer with index r, the precoding matrix with index z₁ may be

$${W}_{{z}_{1}}^{r} = \frac{1}{\sqrt{{N}_{1} {N}_{2} {γ}_{{z}_{1 ,} r}}} [ \begin{matrix}{Σ}_{i = 0}^{{L}_{1} - 1} {v}_{{m}_{1}^{( i , 1 )} , {m}_{2}^{( i , 1 )}} {P}_{r , 0 , 1}^{( 1 )} {Σ}_{f = 0}^{{M}_{v} - 1} {y}_{{z}_{1} , r , 1}^{( f )} {P}_{r , i , f , 1}^{( 2 )} {φ}_{r , i , f , 1} \\ ⋯ \\ {Σ}_{i = 0}^{{L}_{N} - 1} {v}_{{m}_{1}^{( i , N )} , {m}_{2}^{( i , N )}} {P}_{r , 0 , N}^{( 1 )} {Σ}_{f = 0}^{{M}_{v} - 1} {y}_{{z}_{1} , r , N}^{( f )} {P}_{r , i , f , N}^{( 2 )} {φ}_{r , i , f , N} \\ {Σ}_{i = 0}^{{L}_{1} - 1} {v}_{{m}_{1}^{( i , 1 )} , {m}_{2}^{( i , 1 )}} {P}_{r , 1 , 1}^{( 1 )} {Σ}_{f = 0}^{{M}_{v} - 1} {y}_{{z}_{1} , r , 1}^{( f )} {P}_{r , i + {L}_{1} , f , 1}^{( 2 )} {φ}_{r , i + {L}_{1} , f , 1} \\ ⋯ \\ {Σ}_{i = 0}^{{L}_{N} - 1} {v}_{{m}_{1}^{( i , N )} , {m}_{2}^{( i , N )}} {P}_{r , 1 , N}^{( 1 )} {Σ}_{f = 0}^{{M}_{v} - 1} {y}_{{z}_{1} , r , N}^{( f )} {P}_{r , i + {L}_{N} , f , N}^{( 2 )} {φ}_{r , i + {L}_{N} , f , N}\end{matrix} ]$$

$$Or$$

$${W}_{{z}_{1}}^{r} = \frac{1}{\sqrt{{N}_{1} {N}_{2} {γ}_{{z}_{1 ,} r}}} [ \begin{matrix}{\sum }_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 0 , 1}^{( 1 )} {{\sum }^{{M}_{v} - 1}}_{f = 0} {y}_{{z}_{1} , r}^{( {f}_{1} )} {P}_{r , {i}_{1} , f}^{( 2 )} {φ}_{r , {i}_{1} , f} \\ ⋯ \\ {\sum }_{\{ {i}_{N} ∈ {i}_{a N} or {i}_{N} ∈ {i}_{b N} \}} {v}_{{m}_{1}^{( i , N )} , {m}_{2}^{( i , N )}} {P}_{r , 0 , N}^{( 1 )} {{\sum }^{{M}_{v} - 1}}_{f = 0} {y}_{{z}_{1} , r}^{( {f}_{N} )} {P}_{r , {i}_{N} , f}^{( 2 )} {φ}_{r , {i}_{N} , f} \\ {\sum }_{\{ {i}_{1} ∈ {i}_{c 1} or {i}_{1} ∈ {i}_{d 1} \}} {v}_{{m}_{1}^{( i , 1 )} , {m}_{2}^{( i , 1 )}} {P}_{r , 1 , 1}^{( 1 )} {{\sum }^{{M}_{v} - 1}}_{f = 0} {y}_{{z}_{1} , r}^{( {f}_{1} )} {P}_{r , {i}_{1} , f}^{( 2 )} {φ}_{r , {i}_{1} , f} \\ ⋯ \\ {\sum }_{\{ {i}_{N} ∈ {i}_{c N} or {i}_{N} ∈ {i}_{d N} \}} {v}_{{m}_{1}^{( i , N )} , {m}_{2}^{( i , N )}} {P}_{r , 1 , N}^{( 1 )} {{\sum }^{{M}_{v} - 1}}_{f = 0} {y}_{{z}_{1} , r}^{( {f}_{N} )} {P}_{r , {i}_{N} , f}^{( 2 )} {φ}_{r , {i}_{N} , f}\end{matrix} ]$$

$$Or$$

$${W}_{{z}_{1}}^{r} = \frac{1}{\sqrt{{N}_{1} {N}_{2} {γ}_{{z}_{1 ,} r}}} [ \text{} \begin{matrix}{Σ}_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 0 , 1}^{( 1 )} {Σ}_{f = 0}^{{M}_{v} - 1} {y}_{{z}_{1} , r}^{( {f}_{1} )} {P}_{r , {i}_{1} , f}^{( 2 )} {φ}_{r , {i}_{1} , f} \\ ⋯ \\ {Σ}_{\{ {i}_{N} ∈ {i}_{a N} or {i}_{N} ∈ {i}_{b N} \}} {v}_{{m}_{1}^{( i , N )} , {m}_{2}^{( i , N )}} {P}_{r , 0 , N}^{( 1 )} {Σ}_{f = 0}^{{M}_{v} - 1} {y}_{{z}_{1} , r}^{( {f}_{N} )} {P}_{r , {i}_{N} , f}^{( 2 )} {φ}_{r , {i}_{N} , f} \\ {Σ}_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 1 , 1}^{( 1 )} {Σ}_{f = 0}^{{M}_{v} - 1} {y}_{{z}_{1} , r , 1}^{( f )} {P}_{r , i + {L}_{1} , f}^{( 2 )} {φ}_{r , {i}_{1} + {L}_{1} , f} \\ ⋯ \\ {Σ}_{\{ {i}_{N} ∈ {i}_{a N} or {i}_{N} ∈ {i}_{b N} \}} {v}_{{m}_{1}^{( i , N )} , {m}_{2}^{( i , N )}} {P}_{r , 1 , N}^{( 1 )} {Σ}_{f = 0}^{{M}_{v} - 1} {y}_{{z}_{1} , r}^{( {f}_{N} )} {P}_{r , {i}_{N} + {L}_{N} , f}^{( 2 )} {φ}_{r , {i}_{N} + {L}_{N} , f}\end{matrix} ]$$

In some embodiments,

$${y}_{{z}_{1} , r , t}^{( f )} or {y}_{{z}_{1} , r}^{( f )} or {y}_{{z}_{1} , r}^{( {f}_{t} )}$$

may be an element in the second vector with index f or fₜ corresponding to layer with index r and/or corresponding to the CSI-RS resource with index t and/or corresponding to the precoding matrix with index z₁. In some embodiments,

$${y}_{{z}_{1} , r , t}^{( f )} = {e}^{j \frac{2 π * {z}_{1} * {n}_{3 , r , t}^{( f )}}{{N}_{3}}} or {y}_{{z}_{1} , r}^{( f )} = {e}^{j \frac{2 π * {z}_{1} * {n}_{3 , r}^{( f )}}{{N}_{3}}} or {y}_{{z}_{1} , r}^{( {f}_{t} )} = {e}^{j \frac{2 π * {z}_{1} * {n}_{3 , r , t}^{( f )}}{{N}_{3}}} .$$

In some embodiments, if the terminal device 110 is configured with first mode of codebook structure, the value of

$${y}_{{z}_{1} , r , t}^{( f )} or {y}_{{z}_{1} , r}^{( f )} or {y}_{{z}_{1} , r}^{( {f}_{t} )} or {n}_{3 , r , t}^{( f )}$$

may be independent or different with different values of t. In some embodiments, if the terminal device 110 is configured with second mode of codebook structure, the value of

$${y}_{{z}_{1} , r , t}^{( f )} or {y}_{{z}_{1} , r}^{( f )} or {y}_{{z}_{1} , r}^{( {f}_{t} )} or {n}_{3 , r , t}^{( f )}$$

may be same with different values of t. In some embodiments, if the terminal device 110 is configured with second mode of codebook structure, the value of

$${y}_{{z}_{1} , r}^{( f )} or {n}_{3 , r}^{( f )}$$

may be same or common for different values of t. In some embodiments,

$${y}_{{z}_{1} , r}^{( f )} = {e}^{j \frac{2 π * {z}_{1} * {n}_{3 , r}^{( f )}}{{N}_{3}}} .$$

In some embodiments,

$${y}_{{z}_{1} , r}^{( f )}$$

may be an element in the second vector with index f corresponding to layer with index r and common or same to each CSI-RS resource in the plurality of CSI-RS resources or in the second plurality of CSI-RS resources and/or corresponding to the precoding matrix with index z₁.

In some embodiments, if the terminal device 110 is configured with second mode of codebook structure, for the first type of codebook and/or first codebook configuration corresponding to layer with index r, the precoding matrix with index z₁ may be

$${W}_{{z}_{1}}^{r} = \frac{1}{\sqrt{{N}_{1} {N}_{2} {γ}_{{z}_{1} , r}}} [ \begin{matrix}{\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{υ} - 1} {y}_{{z}_{1} , r}^{( f )} {P}_{r , i , f , 1}^{( 2 )} {φ}_{r , i , f , 1} \\ … \\ {\sum }_{i = 0}^{{L}_{N} - 1} {v}_{{m}_{1}^{( i , N )} , {m}_{2}^{( i , N )}} {P}_{r , 0 , N}^{( 1 )} {\sum }_{f = 0}^{{M}_{υ} - 1} {y}_{{z}_{1} , r}^{( f )} {P}_{r , i , f , N}^{( 2 )} {φ}_{r , i , f , N} \\ {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{υ} - 1} {y}_{{z}_{1} , r}^{( f )} {P}_{r , i + {L}_{1} , f , 1}^{( 2 )} {φ}_{r , i + {L}_{1} , f , 1} \\ … \\ {\sum }_{i = 0}^{{L}_{N} - 1} {v}_{{m}_{1}^{( i , N )} , {m}_{2}^{( i , N )}} {P}_{r , 1 , N}^{( 1 )} {\sum }_{f = 0}^{{M}_{υ} - 1} {y}_{{z}_{1} , r}^{( f )} {P}_{r , i + {L}_{N} , f , N}^{( 2 )} {φ}_{r , i + {L}_{N} , f , N}\end{matrix} ] .$$

$$Or$$

$${W}_{{z}_{1}}^{r} = \frac{1}{\sqrt{{N}_{1} {N}_{2} {γ}_{{z}_{1} , r}}} [ \begin{matrix}{\sum }_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 0 , 1}^{( 1 )} {{{\sum }_{f = 0}}^{{M}_{υ} - 1}}_{}^{} {y}_{{z}_{1} , r}^{( f )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{bN} \}} {v}_{{m}_{1}^{( i , N )} , {m}_{2}^{( i , N )}} {P}_{r , 0 , N}^{( 1 )} {{{\sum }_{f = 0}}^{{M}_{υ} - 1}}_{}^{} {y}_{{z}_{1} , r}^{( f )} {P}_{r , {i}_{N} , f}^{( 2 )} {φ}_{r , {i}_{N} , f} \\ {\sum }_{\{ {i}_{1} ∈ {i}_{a 1} or {i}_{1} ∈ {i}_{d 1} \}} {v}_{{m}_{1}^{( i , 1 )} , {m}_{2}^{( i , 1 )}} {P}_{r , 1 , 1}^{( 1 )} {{{\sum }_{f = 0}}^{{M}_{υ} - 1}}_{}^{} {y}_{{z}_{1} , r}^{( f )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{dN} \}} {v}_{{m}_{1}^{( i , N )} , {m}_{2}^{( i , N )}} {P}_{r , 1 , N}^{( 1 )} {{{\sum }_{f = 0}}^{{M}_{υ} - 1}}_{}^{} {y}_{{z}_{1} , r}^{( f )} {P}_{r , {i}_{N} , f}^{( 2 )} {φ}_{r , {i}_{N} , f}\end{matrix} ]$$

$$Or$$

$${W}_{{z}_{1}}^{r} = \frac{1}{\sqrt{{N}_{1} {N}_{2} {γ}_{{z}_{1} , r}}} [ \begin{matrix}{\sum }_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 0 , 1}^{( 1 )} {\sum }_{f = 0}^{{M}_{υ} - 1} {y}_{{z}_{1} , r}^{( f )} {P}_{r , {i}_{1} , f}^{( 2 )} {φ}_{r , {i}_{1} , f} \\ … \\ \begin{matrix}{\sum }_{\{ {i}_{N} ∈ {i}_{aN} or {i}_{N} ∈ {i}_{bN} \}} {v}_{{m}_{1}^{( i , N )} , {m}_{2}^{( i , N )}} {P}_{r , 0 , N}^{( 1 )} \\ {\sum }_{f = 0}^{{M}_{υ} - 1} {y}_{{z}_{1} , r}^{( f )} {P}_{r , {i}_{N} , f}^{( 2 )} {φ}_{r , {i}_{N} , f}\end{matrix} \\ \begin{matrix}{\sum }_{\{ {i}_{1} ∈ {i}_{a 1} or {i}_{1} ∈ {i}_{b 1} \}} {v}_{{m}_{1}^{( i , 1 )} , {m}_{2}^{( i , 1 )}} {P}_{r , 1 , 1}^{( 1 )} \\ {\sum }_{f = 0}^{{M}_{υ} - 1} {y}_{{z}_{1} , r}^{( f )} {P}_{r , {i}_{1} + {L}_{1} , f}^{( 2 )} {φ}_{r , {i}_{1} + {L}_{1} , f}\end{matrix} \\ … \\ \begin{matrix}{\sum }_{\{ {i}_{N} ∈ {i}_{a N} or {i}_{N} ∈ {i}_{b N} \}} {v}_{{m}_{1}^{( i , N )} , {m}_{2}^{( i , N )}} {P}_{r , 1 , N}^{( 1 )} \\ {\sum }_{f = 0}^{{M}_{υ} - 1} {y}_{{z}_{1} , r}^{( f )} {P}_{r , {i}_{N} + {L}_{N} , f}^{( 2 )} {φ}_{r , {i}_{N} + {L}_{N} , f}\end{matrix}\end{matrix} ]$$

In some embodiments, for the second type of codebook and/or first mode of codebook structure and/or first codebook configuration corresponding to layer with index r, the precoding matrix with index z₁ may be

$${W}_{{z}_{1}}^{r} = \frac{1}{\sqrt{{γ}_{{z}_{1} , r}}} [ \begin{matrix}{\sum }_{i = 0}^{{L}_{1} - 1} {v}_{{m}^{( i , 1 )}} {P}_{r , 0 , 1}^{( 1 )} {\sum }_{f = 0}^{M - 1} {y}_{{z}_{1} , 1}^{( f )} {P}_{r , i , f , 1}^{( 2 )} {φ}_{r , i , f , 1} \\ … \\ \begin{matrix}{\sum }_{i = 0}^{{L}_{N} - 1} {v}_{{m}^{( i , N )}} {P}_{r , 0 , N}^{( 1 )} {\sum }_{f = 0}^{{M}_{} - 1} {y}_{{z}_{1} , N}^{( f )} {P}_{r , i , f , N}^{( 2 )} {φ}_{r , i , f , N} \\ {\sum }_{i = 0}^{{L}_{1} - 1} {v}_{{m}^{( i , 1 )}} {P}_{r , 1 , 1}^{( 1 )} {\sum }_{f = 0}^{{M}_{} - 1} {y}_{{z}_{1} , 1}^{( f )} {P}_{r , i + {L}_{1} , f , 1}^{( 2 )} {φ}_{r , i + {L}_{1} , f , 1}\end{matrix} \\ … \\ {\sum }_{i = 0}^{{L}_{N} - 1} {v}_{{m}^{( i , N )}} {P}_{r , 1 , N}^{( 1 )} {\sum }_{f = 0}^{{M}_{} - 1} {y}_{{z}_{1} , N}^{( f )} {P}_{r , i + {L}_{N} , f , N}^{( 2 )} {φ}_{r , i + {L}_{N} , f , N}\end{matrix} ]$$

$$Or$$

$${W}_{{z}_{1}}^{r} = \frac{1}{\sqrt{{γ}_{{z}_{1} , r}}} [ \begin{matrix}{\sum }_{\{ {i}_{1} ∈ {i}_{a 1} or {i}_{1} ∈ {i}_{b 1} \}} {v}_{{m}_{}^{( i , 1 )}} {P}_{r , 0 , 1}^{( 1 )} {{{\sum }_{f = 0}}^{M - 1}}_{}^{} {y}_{{z}_{1}}^{( {f}_{1} )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{bN} \}} {v}_{{m}^{( i , N )}} {P}_{r , 0 , N}^{( 1 )} {{{\sum }_{f = 0}}^{M - 1}}_{}^{} {y}_{{z}_{1}}^{( {f}_{N} )} {P}_{r , {i}_{N} , f}^{( 2 )} {φ}_{r , {i}_{N} , f} \\ {\sum }_{\{ {i}_{1} ∈ {i}_{a 1} or {i}_{1} ∈ {i}_{d 1} \}} {v}_{{m}^{( i , 1 )}} {P}_{r , 1 , 1}^{( 1 )} {{{\sum }_{f = 0}}^{{M}_{υ} - 1}}_{}^{} {y}_{{z}_{1}}^{( {f}_{1} )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{d N} \}} {v}_{{m}^{( i , N )}} {P}_{r , 1 , N}^{( 1 )} {{{\sum }_{f = 0}}^{{M}_{υ} - 1}}_{}^{} {y}_{{z}_{1}}^{( {f}_{N} )} {P}_{r , {i}_{N} , f}^{( 2 )} {φ}_{r , {i}_{N} , f}\end{matrix} ]$$

$$Or$$

$${W}_{{z}_{1}}^{r} = \frac{1}{\sqrt{{γ}_{{z}_{1} , r}}} [ \begin{matrix}{\sum }_{\{ {i}_{1} ∈ {i}_{a 1} or {i}_{1} ∈ {i}_{b 1} \}} {v}_{{m}^{( i , 1 )}} {P}_{r , 0 , 1}^{( 1 )} {\sum }_{f = 0}^{M - 1} {y}_{{z}_{1}}^{( {f}_{1} )} {P}_{r , {i}_{1} , f}^{( 2 )} {φ}_{r , {i}_{1} , f} \\ … \\ \begin{matrix}{\sum }_{\{ {i}_{N} ∈ {i}_{aN} or {i}_{N} ∈ {i}_{bN} \}} {v}_{{m}^{( i , N )}} {P}_{r , 0 , N}^{( 1 )} \\ {\sum }_{f = 0}^{M - 1} {y}_{{z}_{1}}^{( {f}_{N} )} {P}_{r , {i}_{N} , f}^{( 2 )} {φ}_{r , {i}_{N} , f}\end{matrix} \\ \begin{matrix}{\sum }_{\{ {i}_{1} ∈ {i}_{a 1} or {i}_{1} ∈ {i}_{b 1} \}} {v}_{{m}^{( i , 1 )}} {P}_{r , 1 , 1}^{( 1 )} \\ {\sum }_{f = 0}^{M - 1} {y}_{{z}_{1}}^{( {f}_{1} )} {P}_{r , {i}_{1} + {L}_{1} , f}^{( 2 )} {φ}_{r , {i}_{1} + {L}_{1} , f}\end{matrix} \\ … \\ \begin{matrix}{\sum }_{\{ {i}_{N} ∈ {i}_{a N} or {i}_{N} ∈ {i}_{b N} \}} {v}_{{m}^{( {i}_{N} )}} {P}_{r , 1 , N}^{( 1 )} \\ {\sum }_{f = 0}^{M - 1} {y}_{{z}_{1}}^{( {f}_{N} )} {P}_{r , {i}_{N} + {L}_{N} , f}^{( 2 )} {φ}_{r , {i}_{N} + {L}_{N} , f}\end{matrix}\end{matrix} ]$$

In some embodiments,

$${y}_{{z}_{1} , t}^{( f )} or {y}_{{z}_{1}}^{( f )} or {y}_{{z}_{1}}^{( {f}_{t} )}$$

may be an element in the second vector with index f or fₜ and/or corresponding to the CSI-RS resource with index t and/or corresponding to the precoding matrix with index z₁. In some embodiments,

$${y}_{{z}_{1} , t}^{( f )} = {e}^{j \frac{2 π * {z}_{1} * {n}_{3 , t}^{( f )}}{{N}_{3}}} or {y}_{{z}_{1}}^{( f )} = {e}^{j \frac{2 π * {z}_{1} * {n}_{3}^{( f )}}{{N}_{3}}} or {y}_{{z}_{1}}^{( {f}_{t} )} = {e}^{j \frac{2 π * {z}_{1} * {n}_{3 , t}^{( f )}}{{N}_{3}}} .$$

For example, common to any layer.

In some embodiments,

$${y}_{{z}_{1}}^{( f )}$$

may be an element in the second vector with index f and same or common to each CSI-RS resource in the plurality of CSI-RS resources or in the second plurality of CSI-RS resources and/or corresponding to the precoding matrix with index z. In some embodiments,

$${y}_{{z}_{1}}^{( f )} = {e}^{j \frac{2 π * {z}_{1} * {n}_{3}^{( f )}}{{N}_{3}}} .$$

In some embodiments, if the terminal device 110 is configured with first mode of codebook structure, the value of

$${y}_{{z}_{1} , t}^{( f )} or {y}_{{z}_{1}}^{( f )} or {y}_{{z}_{1}}^{( {f}_{t} )} or {n}_{3 , t}^{( f )}$$

may be independent or different with different values of t. In some embodiments, if the terminal device 110 is configured with second mode of codebook structure, the value of

$${y}_{{z}_{1} , t}^{( f )} or {y}_{{z}_{1}}^{( f )} or {y}_{{z}_{1}}^{( {f}_{t} )} or {n}_{3 , t}^{( f )}$$

may be same with different values of t.

In some embodiments, if the terminal device 110 is configured with second mode of codebook structure, the value of

$${y}_{{z}_{1}}^{( f )} or {n}_{3}^{( f )}$$

may be same or common for different values of t.

In some embodiments,

$${y}_{{z}_{1} , t}^{( f )} or {y}_{{z}_{1}}^{( f )} or {y}_{{z}_{1}}^{( {f}_{t} )} or {n}_{3 , t}^{( f )}$$

may be same or common for different layers. For example, when the number of layers is larger than 1. For example, the terminal device 110 may be configured with second type of codebook.

In some embodiments, the second vector with index f or fₜ (For example, f or fₜ∈{0, . . . , M−1}) may be identified by n₃. In some embodiments,

$${n}_{3} = [ {n}_{3}^{( 0 )} … {n}_{3}^{( M - 1 )} ] .$$

In some embodiments,

$${n}_{3}^{( f )} ∈ \{ \begin{matrix}\{ 0 \} & M = 1 \\ \{ 0 , 1 , … , min ( {N}_{f} , {N}_{3} ) - 1 \} & M = 2\end{matrix} .$$

In some embodiments, the fourth parameter for codebook N_{f} may be a size of window for second vectors. In some embodiments, the value of N_{f} may be at least one of {1, 2, 4} or {2, 4}. In some embodiments, the indices f∈{0, . . . , M−1} may be assigned such that

$${n}_{3}^{( f )}$$

increases with f.

In some embodiments, if the terminal device 110 is configured with second mode of codebook structure, for the second type of codebook and/or first codebook configuration corresponding to layer with index r, the precoding matrix with index z₁ may be

$${W}_{{z}_{1}}^{r} = \frac{1}{\sqrt{{γ}_{{z}_{1} , r}}} [ \begin{matrix}{\sum }_{i = 0}^{{L}_{1} - 1} {v}_{{m}^{( i , 1 )}} {P}_{r , 0 , 1}^{( 1 )} {\sum }_{f = 0}^{M - 1} {y}_{{z}_{1}}^{( f )} {P}_{r , i , f , 1}^{( 2 )} {φ}_{r , i , f , 1} \\ … \\ {\sum }_{i = 0}^{{L}_{N} - 1} {v}_{{m}^{( i , N )}} {P}_{r , 0 , N}^{( 1 )} {\sum }_{f = 0}^{M - 1} {y}_{{z}_{1}}^{( f )} {P}_{r , i , f , N}^{( 2 )} {φ}_{r , i , f , N} \\ {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{{z}_{1}}^{( f )} {P}_{r , i + {L}_{1} , f , 1}^{( 2 )} {φ}_{r , i + {L}_{1} , f , 1} \\ … \\ {\sum }_{i = 0}^{{L}_{N} - 1} {v}_{{m}^{( i , N )}} {P}_{r , 1 , N}^{( 1 )} {\sum }_{f = 0}^{M - 1} {y}_{{z}_{1}}^{( f )} {P}_{r , i + {L}_{N} , f , N}^{( 2 )} {φ}_{r , i + {L}_{N} , f , N}\end{matrix} ] .$$

$$Or$$

$${W}_{{z}_{1}}^{r} = \frac{1}{\sqrt{{γ}_{{z}_{1} , r}}} [ \begin{matrix}{\sum }_{\{ {i}_{1} ∈ {i}_{a 1} or {i}_{1} ∈ {i}_{b 1} \}} {v}_{{m}^{( i , 1 )}} {P}_{r , 0 , 1}^{( 1 )} {\sum }_{f = 0}^{M - 1} {y}_{{z}_{1}}^{( f )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{b N} \}} {v}_{{m}^{( i , N )}} {P}_{r , 0 , N}^{( 1 )} {\sum }_{f = 0}^{M - 1} {y}_{{z}_{1}}^{( f )} {P}_{r , {i}_{N} , f}^{( 2 )} {φ}_{r , {i}_{N} , f} \\ {\sum }_{\{ {i}_{1} ∈ {i}_{c 1} or {i}_{1} ∈ {i}_{d 1} \}} {v}_{{m}^{( i , 1 )}} {P}_{r , 1 , 1}^{( 1 )} {\sum }_{f = 0}^{{M}_{υ} - 1} {y}_{{z}_{1}}^{( f )} {P}_{r , {i}_{1} , f}^{( 2 )} {φ}_{r , {i}_{1} , f} \\ … \\ {\sum }_{\{ {i}_{N} ∈ {i}_{cN} or {i}_{1} ∈ {i}_{d N} \}} {v}_{{m}^{( i , N )}} {P}_{r , 1 , N}^{( 1 )} {\sum }_{f = 0}^{{M}_{υ} - 1} {y}_{{z}_{1}}^{( f )} {P}_{r , {i}_{N} , f}^{( 2 )} {φ}_{r , {i}_{N} , f}\end{matrix} ]$$

$$Or$$

$${W}_{{z}_{1}}^{r} = \frac{1}{\sqrt{{γ}_{{z}_{1} , r}}} [ \begin{matrix}{\sum }_{\{ {i}_{1} ∈ {i}_{a 1} or {i}_{1} ∈ {i}_{b 1} \}} {v}_{{m}^{( {i}_{1} )}} {P}_{r , 0 , 1}^{( 1 )} {\sum }_{f = 0}^{M - 1} {y}_{{z}_{1}}^{( f )} {P}_{r , {i}_{1} , f}^{( 2 )} {φ}_{r , {i}_{1} , f} \\ … \\ {\sum }_{\{ {i}_{N} ∈ {i}_{a N} or {i}_{N} ∈ {i}_{bN} \}} {v}_{{m}^{( {i}_{N} )}} {P}_{r , 0 , N}^{( 1 )} {\sum }_{f = 0}^{M - 1} {y}_{{z}_{1}}^{( f )} {P}_{r , {i}_{N} , f}^{( 2 )} {φ}_{r , {i}_{N} , f} \\ {\sum }_{\{ {i}_{1} ∈ {i}_{a 1} or {i}_{1} ∈ {i}_{b 1} \}} {v}_{{m}^{( {i}_{1} )}} {P}_{r , 1 , 1}^{( 1 )} {\sum }_{f = 0}^{M - 1} {y}_{{z}_{1}}^{( f )} {P}_{r , {i}_{1} + {L}_{1} , f}^{( 2 )} {φ}_{r , {i}_{1} + {L}_{1} , f} \\ … \\ {\sum }_{\{ {i}_{N} ∈ {i}_{aN} or {i}_{N} ∈ {i}_{b N} \}} {v}_{{m}^{( {i}_{N} )}} {P}_{r , 1 , N}^{( 1 )} {\sum }_{f = 0}^{M - 1} {y}_{{z}_{1}}^{( f )} {P}_{r , {i}_{N} + {L}_{N} , f}^{( 2 )} {φ}_{r , {i}_{N} + {L}_{N} , f}\end{matrix} ] .$$

In some embodiments, z₁ may be an index of the plurality of precoding matrices for the CSI report. For example, in frequency domain. For example, z₁={0, 1, . . . . N₃−1}.

In some embodiments, vₘ_{^{(i,t)}} or

may be the first vector with index i or it corresponding to the CSI-RS resource with index t.

In some embodiments, vₘ_{^{(i,t)}} or

may be a P/2-element column vector containing a value of 1 in element (For example, the element with index m^{(i,t)}mod(P/2)) and zeros elsewhere. In some embodiments, the first element in vₘ_{^{(i,t)}} of
may be element 0 or element with index 0.

In some embodiments, if the number of layers is 1, the codebook with index z₁ may be

$${W}_{{z}_{1}}^{( 1 )} = {W}_{{z}_{1}}^{1} .$$

In some embodiments, if the number of layers is 2, the codebook with index z₁ may be

$${W}_{{z}_{1}}^{( 2 )} = \frac{1}{\sqrt{2}} [ {W}_{{z}_{1}}^{1} {W}_{{z}_{1}}^{2} ] .$$

In some embodiments, if the number of layers is 3, the codebook with index z₁ may be

$${W}_{{z}_{1}}^{( 3 )} = \frac{1}{\sqrt{3}} [ {W}_{{z}_{1}}^{1} {W}_{{z}_{1}}^{2} {W}_{{z}_{1}}^{3} ] .$$

In some embodiments, if the number of layers is 4, the codebook with index z₁ may be

$${W}_{{z}_{1}}^{( 4 )} = \frac{1}{2} [ {W}_{{z}_{1}}^{1} {W}_{{z}_{1}}^{2} {W}_{{z}_{1}}^{3} {W}_{{z}_{1}}^{4} ] .$$

In some embodiments, γ_{z}_{₁}_{,r} may be a variant for power calculation or power normalization. In some embodiments, γ_{z}_{₁}_{,r} may be based on the at least one first amplitude coefficient, the at least one second amplitude coefficient and the at least one phase coefficient and/or the number of CSI-RS resources in the plurality of CSI-RS resources or in the second plurality of CSI-RS resources. In some embodiments, at least one first amplitude coefficient and/or the at least one second amplitude coefficient and/or the at least one phase coefficient may correspond to the layer with index r and/or corresponding to one CSI-RS resource in the plurality of CSI-RS resources or in the second plurality of CSI-RS resources. In some embodiments, at least one first amplitude coefficient and/or the at least one second amplitude coefficient and/or the at least one phase coefficient may correspond to the layer with index r and/or corresponding to all CSI-RS resources in the plurality of CSI-RS resources or in the second plurality of CSI-RS resources. In some embodiments, γ_{z}_{₁}_{,r} may correspond to one unit with index z₁ and/or correspond to the layer with index r. In some embodiments,

$${γ}_{{z}_{1} , r} = {\sum }_{i = 0}^{2 L - 1} {( {p}_{r , ⌊ \frac{i}{L} ⌋}^{( 1 )} )}^{2} {\vert {\sum }_{f = 0}^{{M}_{υ} - 1} {y}_{{z}_{1} , r}^{( f )} {p}_{r , i , f}^{( 2 )} {φ}_{r , i , f} \vert}^{2}$$

For example, for the first type of codebook.

In some embodiments, the precoding matrix with index z₁ may be normalized or the value of γ_{z}_{₁}_{,r} may be based on a maximum value among a first set of values calculated based on the at least one first amplitude coefficient and/or the at least one second amplitude coefficient and/or the at least one phase coefficient. In some embodiments, each value in the first set of values may correspond to one CSI-RS resource in the second plurality of CSI-RS resources or in the plurality of CSI-RS resources and/or corresponding to a layer with index r. In some embodiments, each of the at least one first amplitude coefficient and/or each of the at least one second amplitude coefficient and/or each of the at least one phase coefficient for calculating one value in the first set of values may correspond to a same CSI-RS resource in the second plurality of CSI-RS resources or in the plurality of CSI-RS resources and/or corresponding to a layer with index r. In some embodiments, the t-th value in first the set of values may correspond to the CSI-RS resource with index t and/or corresponding to a layer with index r. In some embodiments, the first set of values may be represented as γ_{z}_{₁}_{,r,t}, wherein t∈{1, 2, . . . N}. In some embodiments, one value in the first set of values γ_{z}_{₁}_{,r,t} (For example, for one value of t) may be based on at least one first amplitude coefficient

$${P}_{r , s}^{( 1 )} or {P}_{r , s , t}^{( 1 )}$$

(For example, s∈{0, 1}) and/or at least one second amplitude coefficient

$${P}_{r , i , f , t}^{( 2 )}$$

(For example, i∈{0, 1, . . . 2Lₜ−1}) or at least one second amplitude coefficient

$${P}_{r , {i}_{t} , f}^{( 2 )}$$

(For example, iₜ∈{0, 1, . . . 2Lₜ−1}) or at least one second amplitude coefficient

$${P}_{r , {i}_{t} , f}^{( 2 )} and {P}_{r , {i}_{t} + {L}_{t} , f}^{( 2 )}$$

(For example, iₜ∈{0, 1, . . . 2Lₜ−1}) or at least one second amplitude coefficient

$${P}_{r , {i}_{at} , f}^{( 2 )} and {P}_{r , {i}_{ct} , f}^{( 2 )}$$

or at least one second amplitude coefficient

$${P}_{r , {i}_{bt} , f}^{( 2 )} and {P}_{r , {i}_{dt} , f}^{( 2 )}$$

and/or at least one phase coefficient φ_{r,i,f,t} (For example, i∈{0, 1, . . . 2Lₜ−1}) or at least one second amplitude coefficient φ_{r,i}_{ₜ}_{,f} (For example, iₜ∈{0, 1, . . . 2Lₜ−1}) or at least one second amplitude coefficient φ_{r,i}_{ₜ}_{,f} and φ_{r,i}_{ₜ}₊ᵢ_{ₜ}_{,f} (For example, iₜ∈{0, 1, . . . 2Lₜ−1}) or at least one second amplitude coefficient φ_{r,i}_{ₐₜ}_{,f} and φ_{r,i}_{_{ct}}_{,f} or at least one second amplitude coefficient φ_{r,i}_{_{bt}}_{,f} and φ_{r,i}_{_{dt}}_{,f}.

In some embodiments,

$${γ}_{{z}_{1} , r} = {max}_{t ∈ \{ 1 , …N \}} ( {γ}_{{z}_{1} , r , t} ) .$$

In some embodiments,

$${γ}_{{z}_{1} , r} = {\sum }_{t = 1}^{N} {γ}_{{z}_{1} , r , t} .$$

In some embodiments,

$${γ}_{{z}_{1} , r , t} = {\sum }_{i = 0}^{2 {L}_{t} - 1} {( {p}_{r , ⌊ \frac{i}{{L}_{t}} ⌋ , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2} .$$

In some embodiments,

$${γ}_{{z}_{1} , r , t} = {\sum }_{i = 0}^{2 {L}_{t} - 1} {( {p}_{r , s , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2} .$$

In some embodiments,

$${γ}_{{z}_{1} , r , t} = ( {\sum }_{i = 0}^{{L}_{t} - 1} {( {p}_{r , 0 , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2} + {\sum }_{i = 0}^{{L}_{t} - 1} {( {p}_{r , 1 , t}^{( 1 )} )}^{2} {\vert {\sum }_{f = 0}^{{M}_{v} - 1} {y}_{{z}_{1} , r , t}^{( f )} {p}_{r , i + {L}_{t} , f , t}^{( 2 )} {φ}_{r , i + {L}_{t} , f , t} \vert}^{2} ) .$$

In some embodiments,

$${p}_{r , ⌊ \frac{i}{{L}_{t}} ⌋ , t}^{( 1 )}$$

may be replaced with

$${p}_{r , ⌊ \frac{i}{{L}_{t}} ⌋ .}^{( 1 )}$$

In some embodiments,

$${p}_{r , s , t}^{( 1 )}$$

may be replaced with

$${p}_{r , s}^{( 1 )} .$$

In some embodiments,

$${y}_{{z}_{1} , r , t}^{( f )}$$

may be replaced with

$${y}_{{z}_{1} , r}^{( {f}_{t} )} or {y}_{{z}_{1} , r , t}^{( f )} or {y}_{{z}_{1}}^{( {f}_{t} )} or {y}_{{z}_{1} , t}^{( f )} or {y}_{{z}_{1}}^{( f )} .$$

In some embodiments,

$${p}_{r , i , f , t}^{( 2 )}$$

may be replaced with

$${p}_{r , {i}_{t} , f}^{( 2 )} .$$

In some embodiments,

$${p}_{r , i + {L}_{t ,} f , t}^{( 2 )}$$

may be replaced with

$${p}_{r , {i}_{t} + {L}_{t ,} f}^{( 2 )} .$$

In some embodiments, φ_{r,i,f,t} may be replaced with φ_{r,i}_{ₜ}_{,f}. In some embodiments, φ_{r,i+L}_{ₜ}_{,f,t} may be replaced with φ_{r,i}_{ₜ}_{+L}_{ₜ}_{,f}. In some embodiments, Mᵥ may be replaced with M.

In some embodiments,

$${γ}_{{z}_{1} , r} = {max}_{t ∈ \{ 1 , … N \}} {\sum }_{i = 0}^{2 {L}_{t} - 1} {( {p}_{r , ⌊ \frac{i}{{L}_{t}} ⌋ , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2}$$

In some embodiments,

$${γ}_{{z}_{1} , r} = {max}_{t ∈ \{ 1 , … N \}} {\sum }_{i = 0}^{2 {L}_{t} - 1} {( {p}_{r , s , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} ( {\sum }_{i = 0}^{{L}_{t} - 1} {( {p}_{r , 0 , t}^{( 1 )} )}^{2} {\vert {\sum }_{f = 0}^{{M}_{v} - 1} {y}_{{z}_{1} , r , t}^{( f )} {p}_{r , i , f , t}^{( 2 )} {φ}_{r , i , f , t} \vert}^{2} + {\sum }_{i = 0}^{{L}_{t} - 1} {( {p}_{r , 1 , t}^{( 1 )} )}^{2} {\vert {\sum }_{f = 0}^{{M}_{v} - 1} {y}_{{z}_{1} , r , t}^{( f )} {p}_{r , i + {L}_{t} , f , t}^{( 2 )} {φ}_{r , i + {L}_{t} , f , t} \vert}^{2} ) .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , ⌊ \frac{i}{{L}_{t}} ⌋ , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , s , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} ( {\sum }_{\{ {i}_{t} ∈ {i}_{at} \}} {( {p}_{r , 0 , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} + {\sum }_{\{ {i}_{t} ∈ {i}_{bt} \}} {( {p}_{r , 1 , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} ( {\sum }_{\{ {i}_{t} ∈ {i}_{ct} \}} {( {p}_{r , 0 , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} + {\sum }_{\{ {i}_{t} ∈ {i}_{dt} \}} {( {p}_{r , 1 , t}^{( 1 )} )}^{2} {\vert {\sum }_{f = 0}^{{M}_{v} - 1} {y}_{{z}_{1} , r}^{( {f}_{t} )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} {\sum }_{i = 0}^{2 {L}_{t} - 1} {( {p}_{r , ⌊ \frac{i}{{L}_{t}} ⌋ , t}^{( 1 )} )}^{2} {\vert {\sum }_{f = 0}^{{M}_{v} - 1} {y}_{{z}_{1} , r}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} {\sum }_{i = 0}^{2 {L}_{t} - 1} {( {p}_{r , s , t}^{( 1 )} )}^{2} {\vert {\sum }_{f = 0}^{{M}_{v} - 1} {y}_{{z}_{1} , r}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} ( {\sum }_{i = 0}^{{L}_{t} - 1} {( {p}_{r , 0 , t}^{( 1 )} )}^{2} {\vert {\sum }_{f = 0}^{{M}_{v} - 1} {y}_{{z}_{1} , r}^{( f )} {p}_{r , i , f , t}^{( 2 )} {φ}_{r , i , f , t} \vert}^{2} + {\sum }_{i = 0}^{{L}_{t} - 1} {( {p}_{r , 1 , t}^{( 1 )} )}^{2} {\vert {\sum }_{f = 0}^{{M}_{v} - 1} {y}_{{z}_{1} , r}^{( f )} {p}_{r , i + {L}_{t} , f , t}^{( 2 )} {φ}_{r , i + {L}_{t} , f , t} \vert}^{2} ) .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , ⌊ \frac{i}{{L}_{t}} ⌋ , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , s , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} .$$

In some

$${γ}_{{z}_{1} , r} = {max}_{t ∈ \{ 1 , … N \}} ( {\sum }_{\{ {i}_{t} ∈ {i}_{at} \}} {( {p}_{r , 0 , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} + {\sum }_{\{ {i}_{t} ∈ {i}_{bt} \}} {( {p}_{r , 1 , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} ( {\sum }_{\{ {i}_{t} ∈ {i}_{ct} \}} {( {p}_{r , 0 , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} + {\sum }_{\{ {i}_{t} ∈ {i}_{dt} \}} {( {p}_{r , 1 , t}^{( 1 )} )}^{2} {\vert {\sum }_{f = 0}^{{M}_{v} - 1} {y}_{{z}_{1} , r}^{( f )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} {\sum }_{i = 0}^{2 {L}_{t} - 1} {( {p}_{r , ⌊ \frac{i}{{L}_{t}} ⌋ , t}^{( 1 )} )}^{2} {\vert {\sum }_{f = 0}^{M - 1} {y}_{{z}_{1} , t}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} {\sum }_{i = 0}^{2 {L}_{t} - 1} {( {p}_{r , s , t}^{( 1 )} )}^{2} {\vert {\sum }_{f = 0}^{M - 1} {y}_{{z}_{1} , t}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} ( {\sum }_{i = 0}^{{L}_{t} - 1} {( {p}_{r , 0 , t}^{( 1 )} )}^{2} {\vert {\sum }_{f = 0}^{M - 1} {y}_{{z}_{1} , t}^{( f )} {p}_{r , i , f , t}^{( 2 )} {φ}_{r , i , f , t} \vert}^{2} + {\sum }_{i = 0}^{{L}_{t} - 1} {( {p}_{r , 1 , t}^{( 1 )} )}^{2} {\vert {\sum }_{f = 0}^{M - 1} {y}_{{z}_{1} , t}^{( f )} {p}_{r , i + {L}_{t} , f , t}^{( 2 )} {φ}_{r , i + {L}_{t} , f , t} \vert}^{2} ) .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , ⌊ \frac{i}{{L}_{t}} ⌋ , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , s , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} ( {\sum }_{\{ {i}_{t} ∈ {i}_{at} \}} {( {p}_{r , 0 , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} + {\sum }_{\{ {i}_{t} ∈ {i}_{bt} \}} {( {p}_{r , 1 , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} ( {\sum }_{\{ {i}_{t} ∈ {i}_{ct} \}} {( {p}_{r , 0 , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} + {\sum }_{\{ {i}_{t} ∈ {i}_{dt} \}} {( {p}_{r , 1 , t}^{( 1 )} )}^{2} {\vert {\sum }_{f = 0}^{M - 1} {y}_{{z}_{1}}^{( {f}_{t} )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} {\sum }_{i = 0}^{2 {L}_{t} - 1} {( {p}_{r , ⌊ \frac{i}{{L}_{t}} ⌋ , t}^{( 1 )} )}^{2} {\vert {\sum }_{f = 0}^{M - 1} {y}_{{z}_{1}}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} ( {\sum }_{i = 0}^{2 {L}_{t} - 1} {( {p}_{r , s , t}^{( 1 )} )}^{2} {\vert {\sum }_{f = 0}^{M - 1} {y}_{{z}_{1}}^{( f )} {p}_{r , i , f , t}^{( 2 )} {φ}_{r , i , f , t} \vert}^{2} .$$

In some embodiments,

$${γ}_{{z}_{1} , r} = {max}_{t ∈ \{ 1 , … N \}} ( {\sum }_{i = 0}^{{L}_{t} - 1} {( {p}_{r , 0 , t}^{( 1 )} )}^{2} {\vert {\sum }_{f = 0}^{M - 1} {y}_{{z}_{1}}^{( f )} {p}_{r , i , f , t}^{( 2 )} {φ}_{r , i , f , t} \vert}^{2} + {\sum }_{i = 0}^{{L}_{t} - 1} {( {p}_{r , 1 , t}^{( 1 )} )}^{2} {\vert {\sum }_{f = 0}^{M - 1} {y}_{{z}_{1}}^{( f )} {p}_{r , i + {L}_{t} , f , t}^{( 2 )} {φ}_{r , i + {L}_{t} , f , t} \vert}^{2} ) .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , ⌊ \frac{i}{{L}_{t}} ⌋ , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} {\sum }_{\{ {i}_{t} ∈ {i}_{at} and {i}_{t} ∈ {i}_{bt} \} or \{ {i}_{t} ∈ {i}_{ct} and {i}_{t} ∈ {i}_{dt} \}} {( {p}_{r , s , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} .$$

In some embodiments,

$${γ}_{{z}_{1} , r} = {max}_{t ∈ \{ 1 , … N \}} ( {\sum }_{\{ {i}_{t} ∈ {i}_{at} \}} {( {p}_{r , 0 , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} + {\sum }_{\{ {i}_{t} ∈ {i}_{bt} \}} {( {p}_{r , 1 , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} ) .$$

In some embodiments,

$${γ}_{{z}_{1} , r} = {max}_{t ∈ \{ 1 , … N \}} ( {\sum }_{\{ {i}_{t} ∈ {i}_{ct} \}} {( {p}_{r , 0 , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} + {\sum }_{\{ {i}_{t} ∈ {i}_{dt} \}} {( {p}_{r , 1 , t}^{( 1 )} )}^{2} {\vert {\sum }_{f = 0}^{M - 1} {y}_{{z}_{1}}^{( f )} {p}_{r , {i}_{t} , f}^{( 2 )} {φ}_{r , {i}_{t} , f} \vert}^{2} ) .$$

In some embodiments, for the first type of codebook and/or for the second type of codebook and/or second codebook configuration corresponding to layer with index r, the precoding matrix with index z₁ and/or index z₂ may be

$${W}_{{z}_{1} , {z}_{2}}^{r} = \frac{1}{\sqrt{{N}_{1} {N}_{2} {γ}_{{z}_{1} , {z}_{2} , r}}} [ \begin{matrix}{\sum }_{i = 0}^{L - 1} {v}_{{m}_{1}^{( i )} , {m}_{2}^{( i )}} {P}_{r , 0}^{( 1 )} {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}_{1}^{( i )} , {m}_{2}^{( i )}} {P}_{r , 0}^{( 1 )} {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , {z}_{2} , r}}} [ \begin{matrix}{\sum }_{i = 0}^{L - 1} {v}_{{m}_{1}^{( i )} , {m}_{2}^{( i )}} {P}_{r , 0}^{( 1 )} {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}_{1}^{( i )} , {m}_{2}^{( i )}} {P}_{r , 1}^{( 1 )} {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , r}}} [ \begin{matrix}{\sum }_{i = 0}^{L - 1} {v}_{{m}_{1}^{( i )} , {m}_{2}^{( i )}} {P}_{r , 0}^{( 1 )} {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}_{1}^{( i )} , {m}_{2}^{( i )}} {P}_{r , 1}^{( 1 )} {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , r}}} [ \begin{matrix}{\sum }_{i = 0}^{L - 1} {v}_{{m}_{1}^{( i )} , {m}_{2}^{( i )}} {P}_{r , 0}^{( 1 )} {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}_{1}^{( i )} , {m}_{2}^{( i )}} {P}_{r , 1}^{( 1 )} {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i + L , f , q}^{( 2 )} {φ}_{r , i + L , f , q}\end{matrix} ] .$$

In some embodiments, the third vector with index q (For example, q∈{0, . . . , Q−1}) may be identified by n₄. In some embodiments,

$${n}_{4} = [ \begin{matrix}{n}_{4}^{( 0 )} & … & {n}_{4}^{( Q - 1 )}\end{matrix} ] .$$

In some embodiments,

$${n}_{4}^{( q )} ∈ \{ \begin{matrix}0 , & 1 , & … & Q - 1\end{matrix} \} .$$

In some embodiments, the at least one configuration may include a fifth parameter. In some embodiments, the fifth parameter for codebook Q_{w} may be a size of window for third vectors. In some embodiments, the value of Q_{w} may be at least one of {1, 2, 4} or {2, 4}. In some embodiments, the indices q∈{0, . . . , Q−1} may be assigned such that

$${n}_{4}^{( q )}$$

increases with q.

In some embodiments,

$${x}_{{z}_{2} , r}^{( q )} =$$

may be an element in the third vector with index q and/or corresponding to layer with index r and/or corresponding to the precoding matrix with index z₂. In some embodiments,

$${x}_{{z}_{2} , r}^{( q )} = {e}^{j \frac{2 π * {z}_{2} * {n}_{4 , r}^{( q )}}{{N}_{4}}} .$$

In some embodiments, for the second type of codebook and/or second codebook configuration corresponding to layer with index r, the precoding matrix with index z₁ and/or index z₂ may be

$${W}_{{z}_{1} , {z}_{2}}^{r} = \frac{1}{\sqrt{{N}_{1} {N}_{2} {γ}_{{z}_{1} , {z}_{2} , r}}} [ \begin{matrix}{\sum }_{i = 0}^{L - 1} {v}_{{m}^{( i )}} {P}_{r , 0}^{( 1 )} {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}^{( i )}} {P}_{r , 1}^{( 1 )} {\sum }_{f = 0}^{M - 1} {\sum }_{q = 1}^{Q} {y}_{{z}_{1}}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , {z}_{2} , r}}} [ \begin{matrix}{\sum }_{i = 0}^{L - 1} {v}_{{m}^{( i )}} {P}_{r , 0}^{( 1 )} {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}^{( i )}} {P}_{r , 1}^{( 1 )} {\sum }_{f = 0}^{M - 1} {\sum }_{q = 0}^{Q - 1} {y}_{{z}_{1}}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , r}}} [ \begin{matrix}{\sum }_{i = 0}^{L - 1} {v}_{{m}^{( i )}} {P}_{r , 0}^{( 1 )} {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}^{( i )}} {P}_{r , 1}^{( 1 )} {\sum }_{f = 0}^{M - 1} {\sum }_{q = 1}^{Q} {y}_{{z}_{1}}^{( f )} {x}_{{z}_{2} , r}^{( q )} {P}_{r , i + L , f , q}^{( 2 )} {φ}_{r , i + L , f , q}\end{matrix} ] . Or$$

$${W}_{{z}_{1} , {z}_{2}}^{r} = \frac{1}{\sqrt{{N}_{1} {N}_{2} {γ}_{{z}_{1} , r}}} [ \begin{matrix}{\sum }_{i = 0}^{L - 1} {v}_{{m}^{( i )}} {P}_{r , 0}^{( 1 )} {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \\ {\sum }_{i = 0}^{L - 1} {v}_{{m}^{( i )}} {P}_{r , 1}^{( 1 )} {\sum }_{f = 0}^{M - 1} {\sum }_{q = 0}^{Q - 1} {y}_{{z}_{1}}^{( f )} {x}_{{z}_{2} , r}^{( q )} {P}_{r , i + L , f , q}^{( 2 )} {φ}_{r , i + L , f , q}\end{matrix} ] .$$

In some embodiments, z₂ may be an index of the plurality of precoding matrices for the CSI report. For example, in time or doppler domain. In some embodiments, z₂ may be an index corresponding to the time unit or time interval of the plurality of precoding matrices for the CSI report. For example, z₂={0, 1, . . . N₄−1}.

In some embodiments, if the number of layers is 1, the codebook with index z, and/or index z₂ may be

$${W}_{{z}_{1} , {z}_{2}}^{( 1 )} = {W}_{{z}_{1} , {z}_{2}}^{1} .$$

In some embodiments, if the number of layers is 2, the codebook with index z₁ and/or index z₂ may be

$${W}_{{z}_{1} , {z}_{2}}^{( 2 )} = \frac{1}{\sqrt{2}} [ {W}_{{z}_{1} , {z}_{2}}^{1} {W}_{{z}_{1} , {z}_{2}}^{2} ] .$$

In some embodiments, if the number of layers is 3, the codebook with index z₁ and/or index z₂ may be

$${W}_{{z}_{1} , {z}_{2}}^{( 3 )} = \frac{1}{\sqrt{3}} [ {W}_{{z}_{1} , {z}_{2}}^{1} {W}_{{z}_{1} , {z}_{2}}^{2} {W}_{{z}_{1} , {z}_{2}}^{3} ] .$$

In some embodiments, if the number of layers is 4, the codebook with index z₁ and/or index z₂ may be

$${W}_{{z}_{1}}^{( 4 )} = \frac{1}{2} [ {W}_{{z}_{1} , {z}_{2}}^{1} {W}_{{z}_{1} , {z}_{2}}^{2} {W}_{{z}_{1} , {z}_{2}}^{3} {W}_{{z}_{1} , {z}_{2}}^{4} ] .$$

In some embodiments, γ_{z}_{₁}_{,z}_{₂}_{,r} or γ_{z}_{₁}_{,r} may be a variant for power calculation or power normalization. In some embodiments, γ_{z}_{₁}_{,z}_{₂}_{,r} or γ_{z}_{₁}_{,r} may be based on the at least one first amplitude coefficient, the at least one second amplitude coefficient and the at least one phase coefficient. In some embodiments, at least one first amplitude coefficient and/or the at least one second amplitude coefficient and/or the at least one phase coefficient may correspond to the layer with index r and/or corresponding to one unit with index z₂ and/or corresponding to one unit with index z₁. In some embodiments, γ_{z}_{₁}_{,r} may correspond to one unit with index z₁ and/or correspond to the layer with index r and/or correspond to one unit with index z₂. In some embodiments, γ_{z}_{₁}_{,r} may correspond to one unit with index z₁ and/or correspond to the layer with index r and/or correspond to one unit with index z₂ which corresponding to a maximum value of γ_{z}_{₁}_{,r} among indexes {0, 1, . . . N₄−1}.

In some embodiments, the precoding matrix with index z₁ and/or index z₂ may be normalized or the value of γ_{z}_{₁}_{,z}_{₂}_{,r} or γ_{z}_{₁}_{,r} may be based on a maximum value among a second set of values calculated based on the at least one first amplitude coefficient and/or the at least one second amplitude coefficient and/or the at least one phase coefficient. In some embodiments, each value in the second set of values may correspond to one unit with index z₂. In some embodiments, each of the at least one first amplitude coefficient and/or each of the at least one second amplitude coefficient and/or each of the at least one phase coefficient for calculating one value in the second set of values may correspond to one unit with index z₂ and/or corresponding to a layer with index r and/or correspond to one unit with index z₁. In some embodiments, the second set of values may be represented as γ_{z}_{₁}_{,z}_{₂}_{,r}, wherein z₂∈{0, 1, . . . N₄−1}. In some embodiments, one value in the second set of values γ_{z}_{₁}_{,z}_{₂}_{,r} (For example, for one value of z₂) may be based on at least one first amplitude coefficient

$${P}_{r , s}^{( 1 )}$$

(For example, s∈{0, 1}) and/or at least one second amplitude coefficient

$${P}_{r , i , f , q}^{( 2 )}$$

(For example, i∈{0, 1, . . . 2L−1}) and/or at least one phase coefficient φ_{r,i,f,q} (For example, i∈{0, 1, . . . 2L−1}).

In some embodiments,

$${γ}_{{z}_{1} , r} = {max}_{{z}_{2} ∈ \{ 0 , 1 , … {N}_{4} - 1 \}} ( {γ}_{{z}_{1} , {z}_{2} , r} ) .$$

In some embodiments,

$${γ}_{{z}_{1} , r} = {\sum }_{{z}_{2} = 0}^{{N}_{4} - 1} {γ}_{{z}_{1} , {z}_{2} , r} .$$

In some embodiments, γ_{z}_{₁}_{,r}=γ_{z}_{₁}_{,z}_{₂}_{,r}.

In some embodiments,

$${γ}_{{z}_{1} , {z}_{2} , r} = {\sum }_{i = 0}^{2 L - 1} {( {p}_{r , ⌊ \frac{i}{L} ⌋}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , s}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , ⌊ \frac{i}{L} ⌋}^{( 1 )} )}^{2} {\vert {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , s}^{( 1 )} )}^{2} {\vert {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = ( {\sum }_{i = 0}^{L - 1} {( {p}_{r , 0}^{( 1 )} )}^{2} {\vert {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{{M}_{v} - 1} {\sum }_{q = 0}^{Q - 1} {y}_{{z}_{1} , r}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , {z}_{2} , r} = ( {\sum }_{i = 0}^{L - 1} {( {p}_{r , 0}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , {z}_{2} , r} = {\sum }_{i = 0}^{2 L - 1} {( {p}_{r , ⌊ \frac{i}{L} ⌋}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , s}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , ⌊ \frac{i}{L} ⌋}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = {\sum }_{i = 0}^{2 L - 1} {( {p}_{r , s}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} .$$

In some embodiments,

$${γ}_{{z}_{1} , {z}_{2} , r} = ( {\sum }_{i = 0}^{L - 1} {( {p}_{r , 0}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , {z}_{2} , r} = ( {\sum }_{i = 0}^{L - 1} {( {p}_{r , 0}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${p}_{r , ⌊ \frac{i}{L} ⌋}^{( 1 )}$$

may be replaced with

$${p}_{r , s}^{( 1 )} .$$

In some embodiments,

$${y}_{{z}_{1} , r}^{( f )}$$

may be replaced with

$${y}_{{z}_{1}}^{( f )} .$$

In some embodiments, Mᵥ may be replaced with M.

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , ⌊ \frac{i}{L} ⌋}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , s}^{( 1 )} )}^{2} {\vert {\sum }_{f = 0}^{{M}_{v} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , ⌊ \frac{i}{L} ⌋}^{( 1 )} )}^{2} {\vert {\sum }_{f = 0}^{{M}_{υ} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , s}^{( 1 )} )}^{2} {\vert {\sum }_{f = 0}^{{M}_{υ} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} )$$

In some embodiments,

$${γ}_{{z}_{1} , r} = {max}_{{z}_{2} ∈ \{ 0 , 1 , … {N}_{4} - 1 \}} ( {\sum }_{i = 0}^{L - 1} {( {p}_{r , 0}^{( 1 )} )}^{2} {\vert {\sum }_{f = 0}^{{M}_{υ} - 1} {\sum }_{q = 1}^{Q} {y}_{{z}_{1} , r}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{{M}_{υ} - 1} {\sum }_{q = 1}^{Q} {y}_{{z}_{1} , r}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , 0}^{( 1 )} )}^{2} {\vert {\sum }_{f = 0}^{{M}_{υ} - 1} {\sum }_{q = 0}^{Q - 1} {y}_{{z}_{1} , r}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{{M}_{υ} - 1} {\sum }_{q = 0}^{Q - 1} {y}_{{z}_{1} , r}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , ⌊ \frac{i}{L} ⌋}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , s}^{( 1 )} )}^{2} {\vert {\sum }_{f = 0}^{M - 1} {\sum }_{q = 0}^{Q} {y}_{{z}_{1}}^{( f )} {x}_{{z}_{2} , r}^{( q )} {P}_{r , i , f , q}^{( 2 )} {φ}_{r , i , f , q} \vert}^{2} ) .$$

In some embodiments

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , ⌊ \frac{i}{L} ⌋}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{2 L - 1} {( {p}_{r , s}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{L - 1} {( {p}_{r , 0}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{M - 1} {\sum }_{q = 1}^{Q} {y}_{{z}_{1}}^{( f )} {x}_{{z}_{2} , r}^{( q )} {P}_{r , i + L , f , q}^{( 2 )} {φ}_{r , i + L , f , q} \vert}^{2} ) .$$

In some embodiments,

$${γ}_{{z}_{1} , r} = {max}_{{z}_{2} ∈ \{ 0 , 1 , … {N}_{4} - 1 \}} ( {\sum }_{i = 0}^{L - 1} {( {p}_{r , 0}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i , f , q}^{( 2 )} {φ}_{r , i , f , q} \vert}^{2} + {\sum }_{i = 0}^{L - 1} {( {p}_{r , 1}^{( 1 )} )}^{2} {\vert {\sum }_{f = 0}^{M - 1} {\sum }_{q = 0}^{Q - 1} {y}_{{z}_{1}}^{( f )} {x}_{{z}_{2} , r}^{( q )} {P}_{r , i + L , f , q}^{( 2 )} {φ}_{r , i + L , f , q} \vert}^{2} ) .$$

In some embodiments, the terminal device 110 may receive, from the network device, at least one configuration for one channel state information (CSI) report, wherein the at least one configuration may indicate or determine at least one of; at least one first number of first vectors, at least one first number of second vectors and a number of a plurality of channel state information reference signal (CSI-RS) resources.

In some embodiments, a CSI report may be divided into two parts. For example, CSI part 1 (or part 1 or a first part of CSI) and CSI part 2 (or part 2 or a second part of CSI). In some embodiments, CSI part 2 may be further divided into three groups. For example, CSI group 0. CSI group 1, and CSI group 2. In some embodiments, a CSI report may comprise PMI fields X₁ and PMI fields X₂. For example, PMI fields X₁ may be comprised in CSI group 0. For another example, PMI fields X₂ may be comprised in CSI group 1 and CSI group 2. For another example, a subset of PMI fields X₂ may be comprised in CSI group 1, and the remaining of PMI fields X₂ may be comprised in CSI group 2.

In some embodiments, in CSI part 1 of a CSI report, there may be at least one of; rand indicator (RI), if reported; wideband channel quality indicator (CQI) for the first transport block (TB), if reported; subband differential CQI with increasing order of subband number/index, if reported and indicator of the total number of non-zero coefficients summed across all layers (e.g. represented as K^{NZ}), if reported.

In some embodiments, the bitwidth for the rank indicator may be min(2, ┌log₂ n_{RI}┐), where n_{RI} may be the number of allowed rank indicator values. In some embodiments, a parameter of number of allowed rank indicator values (e.g. n_{RI}) may be configured by the network device. In some embodiments, the values of the rank indicator (RI) field are mapped to allowed rank indicator values with increasing order, where ‘0’ is mapped to the smallest allowed rank indicator value. In some embodiments, the bitwidth for the wideband CQI may be 4. In some embodiments, the bitwidth for the subband differential CQI may be 2.

In some embodiments, the bitwidth for the indicator of the total number of non-zero coefficients summed across all layers K^{NZ} may be ┌log₂(K₀)┐ if max allowed rank or max allowed number of layers is 1. In some embodiments, the bitwidth for the indicator of the total number of non-zero coefficients K^{NZ} may be ┌log₂(K₀)┐ if max allowed rank or max allowed number of layers is 1. In some embodiments, the bitwidth for the indicator of the total number of non-zero coefficients K^{NZ} may be ┌log₂ (K₀)┐ corresponding to one layer (for example, with index r). In some embodiments, the bitwidth for the indicator of the total number of non-zero coefficients summed across all layers K^{NZ} may be ┌log₂(2K₀)┐ if max allowed rank or max allowed number of layers is larger than 1 (For example, the max allowed rank or max allowed number of layers may be 2 or 3 or 4).

In some embodiments,

$${K}_{0} = ⌈ 2 L ⌈ {p}_{1} \times \frac{{N}_{3}}{R} ⌉ β ⌉ .$$

In some embodiments,

$$⌈ 2 L ⌈ {p}_{1} * \frac{{N}_{3}}{R} ⌉ * Q * β ⌉ .$$

For example, for the second codebook configuration. In some embodiments,

$${K}_{0} = ⌈ β * 2 {\sum }_{t = 1}^{N} {L}_{t} * {M}_{1} ⌉ .$$

For example, for the first codebook configuration. In some embodiments, p₁, N₃, R, and β may be configured or determined by network device according to some embodiments in this disclosure. For example, p₁ may be the parameter of pᵥ when v=1. In some embodiments, the values of the K^{NZ} indicator field may be mapped to the allowed values of K^{NZ} with increasing order, where ‘0’ is mapped to K^{NZ}=1. For example, for a first type of codebook.

In some embodiments, K₀=┌K₁Mβ┐. In some embodiments, K₀=┌K₁*M*β*Q┐. For example, for the second codebook configuration. In some embodiments,

$${K}_{0} = ⌈ β * P * {\sum }_{t = 1}^{N} {α}_{t} M ⌉ .$$

For example, for the first codebook configuration. In some embodiments, K₁, M, and β may be configured or determined by network device according to some embodiments in this disclosure. In some embodiments, the values of the K^{NZ} indicator field may be mapped to the allowed values of K^{NZ} with increasing order, where ‘0’ may be mapped to K^{NZ}=1. For example, for a second type of codebook.

In some embodiments, there may be two first amplitude coefficients (For example, represented as

$${P}_{r , s , t}^{( 1 )} or {P}_{r , ⌊ \frac{i}{{L}_{t}} ⌋ , t}^{( 1 )} or {P}_{r , s}^{( 1 )} or {P}_{r , ⌊ \frac{i}{{L}_{t}} ⌋}^{( 1 )} or {P}_{r , {s}_{t} , t}^{( 1 )} or {P}_{r , {s}_{t}}^{( 1 )} )$$

(For example, a first one of first amplitude coefficient and a second one of first amplitude coefficient) corresponding to one layer with index r and/or corresponding to one CSI-RS resource with index t. In some embodiments, there may be two first amplitude coefficients in the at least one codebook indicator (For example, represented as

$${P}_{r , s}^{( 1 )} or {P}_{r , ⌊ \frac{i}{{L}_{t}} ⌋}^{( 1 )} )$$

(For example, a first one of first amplitude coefficient in the at least one codebook indicator and a second one of first amplitude coefficient in the at least one codebook indicator) corresponding to one layer with index r. In some embodiments, the first one of the first amplitude coefficient may be

$${P}_{r , 0 , t}^{( 1 )} or {P}_{r , 0}^{( 1 )} .$$

In some embodiments, the second one of the first amplitude coefficient may be

$${P}_{r , 1 , t}^{( 1 )} or {P}_{r , 1}^{( 1 )} .$$

In some embodiments, the first one of first amplitude coefficient in the at least one codebook indicator may be

$${P}_{r , 0}^{( 1 )} .$$

In some embodiments, the second one of first amplitude coefficient in the at least one codebook indicator may be

$${P}_{r , 1}^{( 1 )} .$$

In some embodiments, the terminal device 110 may report one value of one first amplitude coefficient (For example, represented as

$${P}_{r}^{( 1 )} \cdot {P}_{r}^{( 1 )}$$

may be one of

$${P}_{r , 0}^{( 1 )} \cdot {P}_{r , 1}^{( 1 )} )$$

corresponding to one layer with index r in the CSI report to the network device 120.

In some embodiments, if the strongest coefficient corresponding to one layer with index r for the CSI report is associated with or corresponds to the first group of coefficients (For example, s=0 or

$$⌊ \frac{{i}_{SCI}}{{L}_{{t}_{ref}}} ⌋ = 0 ) ,$$

the first one of first amplitude coefficient corresponding to the layer with index r in the at least one codebook indicator

$${P}_{r , 0}^{( 1 )}$$

may be assumed/fixed as 1 (For example, not to be reported in the CSI report), and the second one of first amplitude coefficient corresponding to the layer with index r in the at least one codebook indicator

$${P}_{r , 1}^{( 1 )}$$

may be reported. For example,

$${P}_{r}^{( 1 )}$$

may be

$${P}_{r , 1}^{( 1 )} .$$

In some embodiments, if the strongest coefficient corresponding to one layer with index r for the CSI report is associated with or corresponds to the second group of coefficients (For example, s=1 or

$$⌊ \frac{{i}_{SCI}}{{L}_{{t}_{ref}}} ⌋ = 1 ) ,$$

the second one of first amplitude coefficient corresponding to the layer with index r in the at least one codebook indicator

$${P}_{r , 1}^{( 1 )}$$

may be assumed/fixed as 1 (For example, not to be reported in the CSI report), and the first one of first amplitude coefficient corresponding to the laver with index r in the at least one codebook indicator

$${P}_{r , 0}^{( 1 )}$$

may be reported. For example,

$${P}_{r}^{( 1 )}$$

may be

$${P}_{r , 0}^{( 1 )} .$$

In some embodiments, the one of first amplitude coefficient corresponding to the layer with index r in the at least one codebook indicator

$${P}_{r , s}^{( 1 )}$$

may be assumed/fixed as 1 (For example, not to be reported in the CSI report), and the other one of first amplitude coefficient corresponding to the layer with index r in the at least one codebook indicator

$${P}_{r , ( s + 1 ) mod 2}^{( 1 )}$$

may be reported. For example,

$${P}_{r}^{( 1 )}$$

may be

$${P}_{r , ( s + 1 ) mod 2}^{( 1 )} .$$

In some embodiments,

$$S = ⌊ \frac{{i}_{SCI}}{{L}_{{t}_{ref}}} ⌋ .$$

In some embodiments, s may be determined based on the index of the group of coefficients corresponding to the strongest coefficient corresponding to the layer with index r.

In some embodiments, the first one of the first amplitude coefficient

$${P}_{r , 0 , {t}_{ref}}^{( 1 )}$$

corresponding to one layer with index r and corresponding to one CSI-RS resource with index t_{ref} may be same as the first one of first amplitude coefficient

$${P}_{r , 0}^{( 1 )}$$

corresponding to the layer with index r in the at least one codebook indicator. For example,

$${P}_{r , 0 , {t}_{ref}}^{( 1 )} = {P}_{r , 0}^{( 1 )} .$$

In some embodiments, the second one of the first amplitude coefficient

$${P}_{r , 1 , {t}_{ref}}^{( 1 )}$$

corresponding to one layer with index r and corresponding to one CSI-RS resource with index t_{ref} may be same as the second one of first amplitude coefficient

$${P}_{r , 0}^{( 1 )}$$

corresponding to the layer with index r in the at least one codebook indicator. For example,

$${P}_{r , 1 , {t}_{ref}}^{( 1 )} = {P}_{r , 1}^{( 1 )} .$$

For example, for the reference CSI-RS resource (e.g. CSI-RS resource with index t_{ref}).

In some embodiments, the first one of the first amplitude coefficient

$${P}_{r , 0 , t}^{( 1 )}$$

and/or the second one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be indicated or reported or determined based on a first indication or based on one value or one bit in a second indication. In some embodiments, whether the first one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) is same as the first one of first amplitude coefficient

$${P}_{r , 0}^{( 1 )}$$

corresponding to the layer with index r in the at least one codebook indicator or same as the second one of first amplitude coefficient

$${P}_{r , 1}^{( 1 )}$$

corresponding to the layer with index r in the at least one codebook indicator may be indicated or reported or determined based on the first indication or based on one value or one bit in the second indication. In some embodiments, whether the second one of the first amplitude coefficient

$${P}_{r , 1 , t}^{( 1 )}$$

corresponding to one layer with index r and corresponding to one CSI-RS resource with index t (For example, 1≤t≤N and t≠t_{ref}. For another example, 1≤t≤N) is same as the first one of first amplitude coefficient

$${P}_{r , 0}^{( 1 )}$$

corresponding to the layer with index r in the at least one codebook indicator or same as the second one of first amplitude coefficient

$${P}_{r , 1}^{( 1 )}$$

corresponding to the layer with index r in the at least one codebook indicator may be indicated or reported or determined based on the first indication or based on one value or one bit in the second indication. In some embodiments, whether the first one of the first amplitude coefficient

$${P}_{r , 0 , t}^{( 1 )}$$

or the second one of the first amplitude coefficient

$${P}_{r , 1 , t}^{( 1 )}$$

corresponding to one layer with index r and corresponding to one CSI-RS resource with index t (For example, 1≤t≤N and t≠t_{ref}. For another example, 1≤t≤N) is same as the first amplitude coefficient

$${P}_{r}^{( 1 )}$$

corresponding to the layer with index r in the at least one codebook indicator may be indicated or reported or determined based on the first indication or based on one value or one bit in the second indication.

In some embodiments, the at least one codebook indicator may further comprise the first indication or the second indication. In some embodiments, whether the at least one codebook indicator comprising the first indication or the second indication or not may be based on the number of CSI-RS resources in the second plurality of CSI-RS resources or based on the value of N. In some embodiments, the at least one codebook indicator may further comprise the first indication or the second indication in the case when 2≤N≤4. In some embodiments, the at least one codebook indicator may not comprise the first indication or the second indication in the case when N=1.

In some embodiment, the first indication may correspond to the CSI-RS resource with index t. In some embodiments, the field size for the first indication may 1 bit. In some embodiments, the total number of bits for the first indications corresponding to all N or N−1 CSI-RS resources may be N−1. In some embodiments, for the CSI-RS resource with index t (For example, t=t_{ref}), the first indication may be omitted. In some embodiment, the second indication may correspond to the N or N−1 CSI-RS resources (For example, each CSI-RS resource may be with index t. For example, 1≤t≤N and t≠t_{ref}. For another example, 1≤t≤N). In some embodiments, the field size for the second indication may N−1 bit. In some embodiments, each one of the N−1 bits of the second indication may correspond to one CSI-RS resource.

In some embodiments, if the value of the first indication is 0 or if the value of corresponding bit in the second indication is 0 (For example, corresponding to the CSI-RS resource with index t), the first one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be same as the first one of first amplitude coefficient

$${P}_{r , 0}^{( 1 )}$$

or same as

$${P}_{r}^{( 1 )}$$

corresponding to the layer with index r in the at least one codebook indicator. In some embodiments, if the value of the first indication is 0 or if the value of corresponding bit in the second indication is 0 (For example, corresponding to the CSI-RS resource with index t), the second one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be same as the second one of first amplitude coefficient

$${P}_{r , 1}^{( 1 )}$$

or same as

$${P}_{r}^{( 1 )}$$

corresponding to the layer with index r in the at least one codebook indicator.

In some embodiments, if the value of the first indication is 0 or if the value of corresponding bit in the second indication is 0 (For example, corresponding to the CSI-RS resource with index t), the first one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be same as the first amplitude coefficient

$${P}_{r}^{( 1 )}$$

corresponding to the layer with index r in the at least one codebook indicator, and the second one of the first amplitude coefficient

$${P}_{r , 1 , t}^{( 1 )}$$

corresponding to one layer with index r and corresponding to one CSI-RS resource with index t (For example, 1≤t≤N and t≠t_{ref}. For another example, 1≤t≤N) may be 1. For example, not to be reported in the CSI report.

In some embodiments, if the value of the first indication is 1 or if the value of corresponding bit in the second indication is 1 (For example, corresponding to the CSI-RS resource with index t), the first one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be same as the second one of first amplitude coefficient

$${P}_{r , 1}^{( 1 )}$$

or same as

$${P}_{r}^{( 1 )}$$

corresponding to the layer with index r in the at least one codebook indicator. In some embodiments, if the value of the first indication is 1 or if the value of corresponding bit in the second indication is 1 (For example, corresponding to the CSI-RS resource with index t), the second one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be same as the first one of first amplitude coefficient

$${P}_{r , 0}^{( 1 )}$$

or same as

$${P}_{r}^{( 1 )}$$

corresponding to the layer with index r in the at least one codebook indicator.

In some embodiments, if the value of the first indication is 1 or if the value of corresponding bit in the second indication is 1 (For example, corresponding to the CSI-RS resource with index t), the first one of the first amplitude coefficient

$${P}_{r , 0 , t}^{( 1 )}$$

corresponding to one layer with index r and corresponding to one CSI-RS resource with index t (For example, 1≤t≤N and t≠t_{ref}. For another example, 1≤t≤N) may be 1 (For example, not to be reported in the CSI report), and the second one of the first amplitude coefficient

$${P}_{r , 1 , t}^{( 1 )}$$

corresponding to one layer with index r and corresponding to one CSI-RS resource with index t (For example, 1≤t≤N and t≠t_{ref}. For another example, 1≤t≤N) same as the first amplitude coefficient

$${P}_{r}^{( 1 )}$$

corresponding to the layer with index r in the at least one codebook indicator.

In some embodiments, if the value of the first indication is 0 or if the value of corresponding bit in the second indication is 0 (For example, corresponding to the CSI-RS resource with index t),

$${P}_{r , 0 , t}^{( 1 )} = {P}_{r , 0}^{( 1 )}$$

$$and$$

$${P}_{r , 1 , t}^{( 1 )} = {P}_{r , 1}^{( 1 )} .$$

In some embodiments, if the value of the first indication is 0 or if the value of corresponding bit in the second indication is 0 (For example, corresponding to the CSI-RS resource with index t),

$${P}_{r , 0 , t}^{( 1 )} = {P}_{r}^{( 1 )}$$

$$and$$

$${P}_{r , 1 , t}^{( 1 )} = 1.$$

In some embodiments, if the value of the first indication is 1 or if the value of corresponding bit in the second indication is 1 (For example, corresponding to the CSI-RS resource with index t

$${P}_{r , 0 , t}^{( 1 )} = {P}_{r , 1}^{( 1 )}$$

$$and$$

$${P}_{r , 1 , t}^{( 1 )} = {P}_{r , 0}^{( 1 )} .$$

In some embodiments, if the value of the first indication is 1 or if the value of corresponding bit in the second indication is 1 (For example, corresponding to the CSI-RS resource with index t),

$${P}_{r , 1 , t}^{( 1 )} = {P}_{r}^{( 1 )} and {P}_{r , 0 , t}^{( 1 )} = 1.$$

In some embodiments, a value of one first amplitude coefficient (e.g. corresponding to one layer with index r) may be at least one of

$$\{ reserved or 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} or$$

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the number of bits for indication of one first amplitude coefficient corresponding to one layer with index r may be 4. In some embodiments, in the case when N=1.

In some embodiments, a value of one first amplitude coefficient (e.g. corresponding to one layer with index r) may be at least one of

$$\{ {( \frac{1}{\sqrt{128}} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} or$$

$$\{ \frac{1}{\sqrt{128}} , \frac{1}{8} , \frac{1}{2 \sqrt{8}} , \frac{1}{4} , \frac{1}{\sqrt{8}} , \frac{1}{2} , \frac{1}{\sqrt{2}} , 1 \} .$$

In some embodiments, the number of bits for indication of one first amplitude coefficient corresponding to one layer with index r may be 3. In some embodiments, in the case when 2≤N≤4.

In some embodiments, a value of one first amplitude coefficient (e.g. corresponding to one layer with index r) may be at least one of

$$\{ \frac{1}{\sqrt{8}} , \frac{1}{2} , \frac{1}{\sqrt{2}} , 1 \} or \{ \frac{1}{8} , \frac{1}{4} , \frac{1}{2} , 1 \} .$$

In some embodiments, the number of bits for indication of one first amplitude coefficient corresponding to one layer with index r may be 2. In some embodiments, in the case when 2≤N≤4.

In some embodiments, a value of one first amplitude coefficient (e.g. corresponding to one layer with index r) may be at least one of

$$\{ \frac{1}{2} , 1 \} or \{ \frac{1}{4} , 1 \} or \{ \frac{1}{\sqrt{2}} , 1 \} or \{ \frac{1}{2 \sqrt{2}} , 1 \} .$$

In some embodiments, the number of bits for indication of one first amplitude coefficient corresponding to one layer with index r may be 1. In some embodiments, in the case when 2≤N≤4.

In some embodiments, the number of bits for indication of one first amplitude coefficient corresponding to one layer with index r may be based on the number of CSI-RS resources in the second plurality of CSI-RS resources or based on the value of N. In some embodiments, the number of bits for indication of one first amplitude coefficient corresponding to one layer with index r may be 2 or 3 or 1 when 2≤N≤4. In some embodiments, the number of bits for indication of one first amplitude coefficient corresponding to one layer with index r may be 2 or 1 when 3≤N≤4. In some embodiments, the number of bits for indication of one first amplitude coefficient corresponding to one layer with index r may be 1 when N=4. In some embodiments, the number of bits for indication of one first amplitude coefficient corresponding to one layer with index r may be 4 when N=1.

In some embodiments, the number of bits and/or the candidate values for indication of one second amplitude coefficient corresponding to one layer with index r and corresponding to the CSI-RS resource with index t_{ref} may be different from the number of bits and/or the candidate values for indication of one second amplitude coefficient corresponding to the layer with index r and corresponding to the CSI-RS resource with index t (For example, 1≤t≤N and t≠t_{ref}). In some embodiments, the number of bits for indication of one second amplitude coefficient corresponding to one layer with index r and corresponding to the CSI-RS resource with index t_{ref} may be 3. In some embodiments, the number of bits for indication of one second amplitude coefficient corresponding to one layer with index r and corresponding to the CSI-RS resource with index t (For example, 1≤t≤N and t≠t_{ref}) may be 4.

In some embodiments, a value of one second amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, a value of one second amplitude coefficient corresponding to one layer with index r and corresponding to the CSI-RS resource with index t_{ref} may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, a value of one second amplitude coefficient corresponding to one layer with index r and corresponding to the CSI-RS resource with index t (For example, 1≤t≤N and t≠t_{ref}) may be at least one of

$$\{ \frac{1}{\sqrt{2048}} , \frac{1}{\sqrt{512}} , \frac{1}{\sqrt{128}} , \frac{1}{\sqrt{32}} , \frac{1}{2 \sqrt{2}} , \frac{1}{2} , \frac{1}{\sqrt{2}} , 1 \} or$$

$$\{ \frac{1}{\sqrt{16384}} , \frac{1}{\sqrt{4096}} , \frac{1}{\sqrt{1024}} , \frac{1}{\sqrt{256}} , \frac{1}{\sqrt{64}} , \frac{1}{4} , \frac{1}{2} , 1 \} or$$

$$\{ \frac{1}{\sqrt{4096}} , \frac{1}{\sqrt{1024}} , \frac{1}{\sqrt{256}} , \frac{1}{\sqrt{64}} , \frac{1}{4} , \frac{1}{2} , \frac{1}{\sqrt{2}} , 1 \} or$$

$$\{ \frac{1}{32} , \frac{1}{16} , \frac{1}{8} , \frac{1}{4} , \frac{1}{2 \sqrt{2}} , \frac{1}{2} , \frac{1}{\sqrt{2}} , 1 \} .$$

In some embodiments, the minimum value of one second amplitude coefficient corresponding to one layer with index r and corresponding to the CSI-RS resource with index t_{ref} may be larger than the minimum value of one second amplitude coefficient corresponding to one layer with index r and corresponding to the CSI-RS resource with index t (For example, 1≤t≤N and t≠t_{ref}).

In some embodiments, the terminal device 110 may be configured with at least one codebook subset restriction for the CSI report. In some embodiments, one codebook subset restriction may forms a bit sequence B=B₁B₂, wherein bit sequences B₁, and B₂ may be concatenated to form B. In some embodiments, there may be O₁O₂ first vector groups G(r₁,r₂). And G(r₁,r₂)={v_{N}_{₁}ᵣ_{₁}₊ₓ_{₁}_{,N}_{₂}ᵣ_{₂}₊ₓ_{₂}}, and x₁=0, 1, . . . N₁−1, x₂=0, 1, . . . N₂−1, for r₁∈{0, 1, . . . O₁−1}, r₂∈{0, 1, . . . −1}. For example, for the first codebook configuration and the first type of codebook. For example, for the second codebook configuration and the first type of codebook.

In some embodiments, the terminal device 110 may be configured with restrictions for Gᵣ first vector groups indicated by (r₁^{(k)}, r₂^{(k)}) for k=0, 1, . . . Gᵣ−1. The group indices may be g^{(k)}=O₁r₂^{(k)}+r₁^{(k)}. In some embodiments, the group indices may be assigned such that g^{(k)} increased as k increases. In some embodiments, the remaining first vectors groups (e.g. except the Gᵣ first vector groups) may not be restricted. In some embodiments, Gᵣ may be a positive integer. In some embodiments, 1≤Gᵣ≤8 or 1≤Gᵣ≤4. In some embodiments, Gᵣ=4.

In some embodiments, if N₂=1, g^{(k)}=k for k=0, 1, . . . 3. And B₁ may be empty. In some embodiments, if N₂>1,

$${B}_{1} = {b}_{1}^{( 10 )} ... {b}_{1}^{( 0 )}$$

may be the binary representation of the integer β₁ where b₁⁽¹⁰⁾ may be the most significant bit (MSB) and

$${b}_{1}^{( 0 )}$$

may be the least significant bit (LSB). In some embodiments,

$${β}_{1} = {\sum }_{k = 0}^{{G}_{r} - 1} C ( {O}_{1} {O}_{2} - 1 - {g}^{( k )} , {G}_{r} - k ) .$$

In some embodiments, the bit sequence

$${B}_{2} = {B}_{2}^{( 0 )} ... {B}_{2}^{( {G}_{r} - 1 )} or {B}_{2} = {B}_{2}^{( 0 )} {B}_{2}^{( 1 )} {B}_{2}^{( 2 )} {B}_{2}^{( 3 )}$$

may be the concatenation of bit sequences

$${B}_{2}^{( k )} for k = 0 , 1 , ... {G}_{r} - 1 ,$$

corresponding to the group indices g^{(k)}. In some embodiments, the bit sequence

$${B}_{2}^{( k )}$$

may be

$${B}_{2}^{( k )} = {b}_{2}^{( k , 2 {N}_{1} {N}_{2} - 1 )} ... {B}_{2}^{( k , 0 )} .$$

In some embodiments,

$${b}_{2}^{( k , 2 ( {N}_{1} {x}_{2} + {x}_{1} ) + 1 )} … {b}_{2}^{( k , 2 ( {N}_{1} {x}_{2} + {x}_{1} ) )}$$

may indicate the maximum allowed average amplitude γ_{i+sL} (s=0, 1), with i∈{0, 1, . . . , L−1}, of the coefficients associated with the first vector in group g^{(k)} indexed by x₁, x₂. In some embodiments, the maximum amplitudes may be at least one of {0, \sqrt{¼}, \sqrt{½}, 1}. In some embodiments, the maximum amplitudes may be as shown in Table 2.

TABLE 2
Maximum allowed average coefficient amplitudes for restricted first vectors

| Bit | Maximum |
|---|---|
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Average Coefficient Amplitude γ_{i+sL} |
| 00 | 0 |
| 01 | \sqrt{1/4} |
| 10 | \sqrt{1/2} |
| 11 | 1 |

In some embodiments, the terminal device that does not report a parameter (e.g. softAmpRestriction-r16=‘supported’” in its capability signaling may not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01$$

or 10.

In some embodiments, the average coefficient amplitude corresponding to a first vector with index i may be restricted as

$$\sqrt{\frac{1}{{\sum }_{f = 0}^{{M}_{υ} - 1} {k}_{r , i + sL , f}^{( 3 )}} {\sum }_{f = 0}^{{M}_{υ} - 1} {{k}_{r , i + sL , f}^{( 3 )} ( {P}_{r , p}^{( 1 )} {P}_{r , i + sL , f}^{( 2 )} )}^{2}} \leq {γ}_{i + sL} .$$

In some embodiments, the terminal device 110 may be configured with at least one codebook subset restriction (For example, N codebook subset restrictions) for the CSI report. In some embodiments, one of the at least one codebook subset restriction may correspond to one CSI-RS resource with index t. In some embodiments, for the CSI-RS resource with index t, the terminal device 110 may be configured with G_{r,t} first vector groups, for example the first vector group index may be g^{(k,t)}. In some embodiments, for the CSI-RS resource with index t and/or for one of the G_{r,t} first vector groups with index g^{(k,t)}, there may be a set of bits to indicate the maximum allowed average amplitude γᵢ_{ₜ}_{+sL}_{ₜ} (s=0, 1), with iₜ∈{0, 1, . . . , Lₜ−1}, of the coefficients associated with the first vector in group g^{(k,t)} (for example, the first vector in group g^{(k,t)} may be indexed by x₁,x₂). In some embodiments, G_{r,t} may be a positive integer. In some embodiments, 1≤G_{r,t}≤8 or 1≤G_{r,t}≤4. In some embodiments, G_{r,t}=4. In some embodiments, 1≤t≤4. In some embodiments, 1≤t≤N.

In some embodiments, a number of first vectors groups G_{r,t1} in a codebook subset restriction corresponding to a CSI-RS resource with index t1 may be same as or different from a number of first vectors groups G_{r,t2} in a codebook subset restriction corresponding to a CSI-RS resource with index t2. For example, t1 and/or t2 may be positive integer. For example, 1≤t1≤4 or 1≤t1≤N. For example, 1≤t2≤4 or 1≤t2≤N. For example, t1≠t2.

In some embodiments, the number of first vectors groups G_{r,t} in a codebook subset restriction corresponding to a CSI-RS resource with index t may be based on the number of CSI-RS resources in the second plurality of CSI-RS resources or based on the value of N. In some embodiments, the number of first vectors groups G_{r,t} in a codebook subset restriction corresponding to a CSI-RS resource with index t may be 4 (e.g. G_{r,t}=4) if N=1 or if only the CSI-RS resource with index t is selected or included in the second plurality of CSI-RS resources. In some embodiments, the number of first vectors groups G_{r,t} in a codebook subset restriction corresponding to a CSI-RS resource with index t may be 1 or 2 or 3 or 4 or 5 or 6 or 7 or 8 if 1<N≤4.

In some embodiments, the average coefficient amplitude corresponding to a first vector with index i or iₜ and/or corresponding to a CSI-RS resource with index t may be restricted based on a corresponding value calculated based on the at least one first amplitude coefficient corresponding to the CSI-RS resource with index t and/or the at least one second amplitude coefficient corresponding to the CSI-RS resource with index t and/or at least one bit corresponding to the CSI-RS resource with index t in the first bitmap (or in the third bitmap and the fourth bitmap) for non zero coefficients indication.

In some embodiments, the average coefficient amplitude corresponding to a first vector with index i or iₜ and/or corresponding to a CSI-RS resource with index t may be restricted based on a corresponding value calculated based on the at least one first amplitude coefficient corresponding to the CSI-RS resource with index t and/or the at least one second amplitude coefficient corresponding to the CSI-RS resource with index t and/or at least one bit corresponding to the CSI-RS resource with index t in the first bitmap (or in the third bitmap and the fourth bitmap) for non zero coefficients indication and/or at least one bit corresponding to the CSI-RS resource with index t_{ref} in the first bitmap (or in the third bitmap and the fourth bitmap) for non zero coefficients indication and/or a maximum value based on at least one bit corresponding to each of the CSI-RS resource in the plurality of CSI-RS resources in the first bitmap (or in the third bitmap and the fourth bitmap) for non zero coefficients indication.

In some embodiments, the average coefficient amplitude corresponding to a first vector with index i or iₜ and/or corresponding to a CSI-RS resource with index t may be restricted based on a maximum value among a third set of values calculated based on the at least one first amplitude coefficient and/or the at least one second amplitude coefficient. In some embodiments, each value in the third set of values may be based on the at least one first amplitude coefficient corresponding to a CSI-RS resource with index t and/or the at least one second amplitude coefficient corresponding to the CSI-RS resource with index t and/or at least one bit corresponding to the CSI-RS resource with index t in the first bitmap (or in the third bitmap and the fourth bitmap) for non zero coefficients indication.

In some embodiments, the average coefficient amplitude corresponding to a first vector with index i or iₜ and/or corresponding to a CSI-RS resource with index t may be restricted based on a combined corresponding value calculated based on the at least one first amplitude coefficient corresponding to each of the CSI-RS resource and/or the at least one second amplitude coefficient corresponding to each of the CSI-RS resource and/or at least one bit corresponding to each of the CSI-RS resource in the first bitmap (or in the third bitmap and the fourth bitmap) for non zero coefficients indication and/or the at least one phase coefficient.

In some embodiments, the average coefficient amplitude corresponding to a first vector with index i or iₜ and/or corresponding to a CSI-RS resource with index t may be restricted as

$$\sqrt{\frac{1}{{\sum }_{f = 0}^{{M}_{υ} - 1} {k}_{r , i + {sL}_{t} , f , t}^{( 3 )}} {\sum }_{f = 0}^{{M}_{υ} - 1} {{k}_{r , i + {sL}_{t} , ft , t}^{( 3 )} ( {p}_{r , s , t}^{( 1 )} {p}_{r , i + {sL}_{t} , f , t}^{( 2 )} )}^{2}} \leq {γ}_{i + {sL}_{t} , t} .$$

In some embodiments, the average coefficient amplitude corresponding to a first vector with index i or it and/or corresponding to a CSI-RS resource with index t may be restricted as

$$\sqrt{\frac{1}{{max}_{t ∈ \{ 1 , … N \}} {\sum }_{f = 0}^{{M}_{υ} - 1} {k}_{r , i + {sL}_{t} , f , t}^{( 3 )}} {\sum }_{f = 0}^{{M}_{υ} - 1} {{k}_{r , i + {sL}_{t} , ft , t}^{( 3 )} ( {p}_{r , s , t}^{( 1 )} {p}_{r , i + {sL}_{t} , f , t}^{( 2 )} )}^{2}} \leq {γ}_{i + {sL}_{t} , t} .$$

In some embodiments, the average coefficient amplitude corresponding to a first vector with index i or it and/or corresponding to a CSI-RS resource with index t may be restricted as

$$\sqrt{\frac{1}{{\sum }_{f = 0}^{{M}_{υ} - 1} {k}_{r , i + {sL}_{{t}_{ref}} , f , {t}_{ref}}^{( 3 )}} {\sum }_{f = 0}^{{M}_{υ} - 1} {{k}_{r , i + {sL}_{t} , ft , t}^{( 3 )} ( {p}_{r , s , t}^{( 1 )} {p}_{r , i + {sL}_{t} , f , t}^{( 2 )} )}^{2}} \leq {γ}_{i + {sL}_{t} , t} .$$

In some embodiments, may be 0 or 1.

In some embodiments, the average coefficient amplitude corresponding to a first vector with index i or iₜ and/or corresponding to a CSI-RS resource with index t may be restricted as

$$\sqrt{\frac{1}{{\sum }_{t = 1}^{N} {\sum }_{f = 0}^{{M}_{υ} - 1} {\sum }_{l = 0}^{{L}_{t} - 1} {k}_{r , i + {sL}_{t} , f , t}^{( 3 )}} {\sum }_{t = 1}^{N} {\sum }_{f = 0}^{{M}_{υ} - 1} {( {\sum }_{l = 0}^{{L}_{t} - 1} {k}_{r , i + {sL}_{t} , f , t}^{( 3 )} {p}_{r , s , t}^{( 1 )} {p}_{r , i + {sL}_{t} , f , t}^{( 2 )} {φ}_{r , i + {sL}_{t} , f , t} )}^{2}} \leq {γ}_{i + {sL}_{t} , t} or$$

$$\sqrt{\frac{1}{{\sum }_{t = 1}^{N} {\sum }_{f = 0}^{{M}_{υ} - 1} {\sum }_{l = 0}^{{L}_{t} - 1} {k}_{r , i + {sL}_{t} , f , t}^{( 3 )}} {\sum }_{t = 1}^{N} {\sum }_{f = 0}^{{M}_{υ} - 1} {( {\sum }_{l = 0}^{{L}_{t} - 1} {k}_{r , i + {sL}_{t} , f , t}^{( 3 )} {p}_{r , s , t}^{( 1 )} {p}_{r , i + {sL}_{t} , f , t}^{( 2 )} )}^{2}} \leq {γ}_{i + {sL}_{t} , t} .$$

In some embodiments, the average coefficient amplitude corresponding to a first vector with index i or iₜ and/or corresponding to a CSI-RS resource with index t1 may be restricted as

$$\sqrt{\frac{1}{{\sum }_{t = 1 , t \neq t 1}^{N} {\sum }_{f = 0}^{{M}_{υ} - 1} {k}_{r , i + {sL}_{t} , f , t}^{( 3 )} + {\sum }_{f = 0}^{{M}_{υ} - 1} {k}_{r , i + {sL}_{t} , f , t 1}^{( 3 )}} ( {\sum }_{t = 1 , t \neq t 1}^{{M}_{υ} - 1} \begin{matrix}{\sum }_{f = 0}^{{M}_{υ} - 1} {( {\sum }_{l = 0}^{{L}_{t} - 1} {k}_{r , i + {sL}_{t} , f , t 1}^{( 3 )} {p}_{r , s , t}^{( 1 )} {p}_{r , i + {sL}_{t} , f , t}^{( 2 )} {φ}_{r , i + {sL}_{t} , f , t} )}^{2} + \\ {\sum }_{f = 0}^{{M}_{υ} - 1} {{k}_{r , i + {sL}_{t} , f , t 1}^{( 3 )} ( {p}_{r , s , t}^{( 1 )} {p}_{r , i + {sL}_{t} , f , t}^{( 2 )} )}^{2} )\end{matrix}} \leq {γ}_{i + {sL}_{t} , t 1} or$$

$$\sqrt{\frac{1}{{\sum }_{t = 1 , t \neq t 1}^{N} {\sum }_{f = 0}^{{M}_{υ} - 1} {k}_{r , i + {sL}_{t} , f , t}^{( 3 )} + {\sum }_{f = 0}^{{M}_{υ} - 1} {k}_{r , i + {sL}_{t} , f , t 1}^{( 3 )}} ( {\sum }_{t = 1 , t \neq t 1}^{{M}_{υ} - 1} \begin{matrix}{\sum }_{f = 0}^{{M}_{υ} - 1} {( {\sum }_{l = 0}^{{L}_{t} - 1} {k}_{r , i + {sL}_{t} , f , t 1}^{( 3 )} {p}_{r , s , t}^{( 1 )} {p}_{r , i + {sL}_{t} , f , t}^{( 2 )} )}^{2} + \\ {\sum }_{f = 0}^{{M}_{υ} - 1} {{k}_{r , i + {sL}_{t} , f , t 1}^{( 3 )} ( {p}_{r , s , t}^{( 1 )} {p}_{r , i + {sL}_{t} , f , t}^{( 2 )} )}^{2} )\end{matrix}} \leq {γ}_{i + {sL}_{t} , t 1} or$$

$$\sqrt{\frac{1}{{\sum }_{t = 1}^{N} {\sum }_{f = 0}^{{M}_{υ} - 1} {k}_{r , i + {sL}_{t} , f , t}^{( 3 )}} {\sum }_{t = 1}^{N} {\sum }_{f = 0}^{{M}_{υ} - 1} {( {\sum }_{l = 0}^{{L}_{t} - 1} {k}_{r , i + {sL}_{t} , f , t}^{( 3 )} {p}_{r , s , t}^{( 1 )} {p}_{r , i + {sL}_{t} , f , t}^{( 2 )} {φ}_{r , i + {sL}_{t} , f , t} )}^{2}} \leq {γ}_{i + {sL}_{t} , t 1} .$$

In some embodiments, the terminal device may be configured with more than one plurality of first vector groups (e.g. a first plurality of first vector groups and a second plurality of first vector groups) corresponding to one CSI-RS resource with index t for the CSI report, wherein the first plurality of vector groups may be applied for average amplitude restriction in case of more than one CSI-RS resource is selected/indicated for the CSI report (e.g. 1<N≤4). For example, the CSI-RS resource with index t may also be selected/indicated for the CSI report), and the second plurality of vector groups may be applied for average amplitude restriction in case of only the CSI-RS resource with index t is selected/indicated for the CSI report or in case of N=1. For example, in case of only the CSI-RS resource with index t is selected/indicated for the CSI report, the average amplitude may be restricted to reduce interference or other CSI-RS resources or other TRPs.

In some embodiments, the G_{r,t} first vector groups for average amplitude restriction corresponding to CSI-RS resource with index t may be applied if only the corresponding CSI-RS resource with index t is selected/indicated for the CSI report (i.e. single TRP transmission), and in case of more than one CSI-RS resource selected for the CSI report (e.g. 1<N≤4 or in case of multi-TRP transmission), the G_{r,t} first vector groups for amplitude restriction may not be applied.

In some embodiments, the terminal device may be configured with at least one combination of first vector groups (e.g. {g^{(k,1)}, g^{(k,2)}, g^{(k,N)}}), wherein each combination of first vector groups may correspond to a set of CSI-RS resources or a set of selected CSI-RS resources. In some embodiments, if one CSI-RS resource with index t1 is selected, a first combination of first vector groups may be applied (e.g. number of selected CSI-RS resource may be N, including at least one first vector group corresponding to the CSI-RS resource with index t1), and if the CSI-RS resource with index t1 is not selected, a second combination of first vector groups may be applied (e.g. number of selected CSI-RS resource may be N−1, the second combination may not include the at least one first vector group corresponding to the CSI-RS resource with index t1. For example, if one TRP is not selected/reported for the CSI report, the amplitude based on the other TRPs may be reduced/restricted to reduce the interference to the TRP.

In some embodiments, the terminal device may be configured with more than one plurality of first vector groups (e.g. a first plurality of first vector groups and a second plurality of first vector groups) corresponding to one CSI-RS resource with index t2) for the CSI report, wherein the first plurality of vector groups may be applied for amplitude restriction in case of a CSI-RS resource with index t2 (e.g. t1≠t2) is selected/indicated for the CSI report, and the second plurality of vector groups may be applied for amplitude restriction in case of the CSI-RS resource with index t2 (e.g. t1≠t2) is not selected/indicated for the CSI report.

In some embodiments, the terminal device may be further configured with a third plurality of first vector groups corresponding to the CSI-RS resource with index t for the CSI report, wherein in case of more than one CSI-RS resource (including the CSI-RS resource with index t) selected/indicated for the CSI report, only the first vectors included in the third plurality of first vector groups may be selected for the CSI report. In some embodiments, for the first vector groups excluding the third plurality of first vector groups corresponding to the CSI-RS resource with index t, the first vectors will not be selected/reported for the CSI report. In some embodiments, the number of first vector groups in the third plurality of first vector groups may be G_{M,t}, wherein G_{M,t} may be a positive integer, e.g. G_{M,t} may be at least one of {4, 5, 6, 7, 8}. In some embodiments, if N₂=1, G_{M,t}=4. In some embodiments, the first plurality of vector groups and/or the second plurality of vector groups may be selected from the third plurality of vector groups. In some embodiments, the field size for the indication of the first or second plurality of first vector groups may be ┌log₂ C(G_{M,t},G_{r,t})┐. In some embodiments, in case of only one CSI-RS resource selected (e.g. N=1 or single-TRP transmission), the third plurality of first vector groups may not be applied, and the first vectors except the first and/or the second plurality of first vector groups may not be restricted.

In some embodiments, there may be one Mᵢₙᵢₜᵢₐₗ in the at least one codebook indicator, which may be common for all of the N CSI-RS resources for the CSI report. For example, in case of N₃>19. In some embodiments, for the reference CSI-RS resource (e.g. the CSI-RS resource with index t_{ref}), the at least one selected second vector may comprise. Mᵥ−1 second vector(s) selected based on the indication of second vector selection (e.g. the field size may be

$${log}_{2} ( \begin{matrix}2 {M}_{υ} - 1 \\ {M}_{υ} - 1\end{matrix} ) )$$

and the vector of

$${n}_{3 , r}^{( f , t \_ ref )} = 0$$

(e.g. a vector with all ones, For example, there is no need to report the vector of

$${n}_{3 , r}^{( f , t \_ ref )} = 0 ) .$$

In some embodiments, for the CSI-RS resource with index t (For example, 1≤t≤N and t≠t_{ref}), the at least one selected second vector may comprise Mᵥ second vector(s) selected based on the indication of second vector selection (e.g. the field size may be log₂

$$( \begin{matrix}2 {M}_{υ} \\ {M}_{υ}\end{matrix} ) )$$

or may comprise Mᵥ−1 second vector(s) selected based on the indication of second vector selection (e.g. the field size may be

$${log}_{2} ( \begin{matrix}2 {M}_{υ} - 1 \\ {M}_{υ} - 1\end{matrix} ) )$$

and the vector of

$${n}_{3 , r}^{( f , t )} = ( {M}_{initial} + {φ}_{n , t} ) mod {N}_{3} .$$

In some embodiments, φ_{n,t} may be the second vector offset for the CSI-RS resource with index t. In some embodiments, φ_{n,t} may be a non-negative integer. In some embodiments, 0≤φ_{n,t}≤N₃. In some embodiments, φ_{n,t} may be replaced with φₜ.

In some embodiments, for the reference CSI-RS resource (e.g. the CSI-RS resource with index t_{ref}), the at least one selected second vector may comprise: Mᵥ−1 second vector(s) selected based on the indication of second vector selection (e.g. the field size may be

$${log}_{2} ( \begin{matrix}{N}_{3} - 1 \\ {M}_{υ} - 1\end{matrix} ) )$$

and the vector of

$${n}_{3 , r}^{( f , t \_ ref )} = 0$$

(e.g. a vector with all ones, For example, there is no need to report the vector of

$${n}_{3 , r}^{( f , t \_ ref )} = 0 ) .$$

In some embodiments, for the CSI-RS resource with index t (For example, 1≤t≤N and t≠t_{ref}), the at least one selected second vector may comprise Mᵥ second vector(s) selected based on the indication of second vector selection (e.g. the field size may be

$${log}_{2} ( \begin{matrix}{N}_{3} \\ {M}_{υ}\end{matrix} ) )$$

or may comprise Mᵥ−1 second vector(s) selected based on the indication of second vector selection (e.g. the field size may be

$${log}_{2} ( \begin{matrix}{N}_{3} - 1 \\ {M}_{υ} - 1\end{matrix} ) )$$

and the vector of

$${n}_{3 , r}^{( f , t )} = {φ}_{n , t} or {n}_{3 , r}^{( f , t )} = ( {φ}_{n , t} + {n}_{3 , r}^{( 0 , t \_ ref )} ) mod {N}_{3} .$$

For example, there is no need to report the vector of

$${n}_{3 , r}^{( f , t )} .$$

In some embodiments, φ_{n,t} may be the second vector offset for the CSI-RS resource with index t. In some embodiments, φ_{n,t} may be a non-negative integer. In some embodiments, 0≤φ_{n,t}≤N₃. In some embodiments

$${n}_{3 , r}^{( 0 , t \_ ref )}$$

may be the index of the first one of the at least one second vector selected corresponding to the CSI-RS resource with index t_{ref}. For example, in case of N₃≤19.

In some embodiments, for the CSI-RS resource with index t (For example, 1≤t≤N and t≠t_{ref}.), the at least one selected second vector may comprise Mᵥ second vector(s) selected based on the indication of second vector selection (e.g. the field size may be

$${log}_{2} ( \begin{matrix}2 {M}_{υ} \\ {M}_{υ}\end{matrix} ) )$$

or may comprise Mᵥ−1 second vector(s) selected based on the indication of second vector selection (e.g. the field size may be

$${log}_{2} ( \begin{matrix}2 {M}_{υ} - 1 \\ {M}_{υ} - 1\end{matrix} ) )$$

and the vector of

$${n}_{3 , r}^{( f , t )} = {φ}_{n , t} or {n}_{3 , r}^{( f , t )} = ( {φ}_{n , t} + {n}_{3 , r}^{( 0 , t \_ ref )} ) mod {N}_{3} .$$

For example, there is no need to report the vector of

$${n}_{3 , r}^{( f , t )} .$$

In some embodiments, the 2Mᵥ second vectors corresponding to the CSI-RS resource with index t may be identified based on {φ_{n,t}, φ_{n,t}+1 . . . φ_{n,t}+2Mᵥ−1}mod N₃ or based on

$$\{ {φ}_{n , t} + {n}_{3 , r}^{( 0 , t \_ ref )} , {φ}_{n , t} + {n}_{3 , r}^{( 0 , t \_ ref )} + 1 , … {φ}_{n , t} + {n}_{3 , r}^{( 0 , t \_ ref )} + 2 {M}_{υ} - 1 \} mod {N}_{3} .$$

For example, in case of N₃≤19.

In some embodiments, for the CSI-RS resource with index t (For example, 1≤t≤N and t≠t_{ref}), the at least one selected second vector may comprise Mᵥ second vector(s) selected based on the indication of second vector selection (e.g. the field size may be

$${log}_{2} ( \begin{matrix}2 {M}_{υ , {t}_{ref}} \\ {M}_{υ}\end{matrix} ) )$$

or may comprise Mᵥ−1 second vector(s) selected based on the indication of second vector selection (e.g. the field size may be

$${log}_{2} ( \begin{matrix}2 {M}_{υ , {t}_{ref}} - 1 \\ {M}_{υ} - 1\end{matrix} ) )$$

and the vector of

$${n}_{3 , r}^{( f , t )} = {φ}_{n , t} or {n}_{3 , r}^{( f , t )} = ( {φ}_{n , t} + {n}_{3 , r}^{( 0 , t \_ ref )} ) mod {N}_{3} .$$

For example, there is no need to report the vector of

$${n}_{3 , r}^{( f , t )} .$$

In some embodiments, the 2M_{v,t}_{_{ref}} second vectors corresponding to the CSI-RS resource with index t may be identified based on {φ_{n,t}, φ_{n,t}+1, . . . , φ_{n,t}+2M_{v,t}_{_{ref}}−1}mod N₃ or based on

$$\{ {φ}_{n , t} + {n}_{3 , r}^{( 0 , t \_ ref )} , {φ}_{n , t} + {n}_{3 , r}^{( 0 , t \_ ref )} + 1 ,$$

$$… {φ}_{n , t} + {n}_{3 , r}^{( 0 , t \_ ref )} + 2 {M}_{v , {t}_{ref}} - 1 \} mod {N}_{3} .$$

In some embodiments, the value of M_{v,t}_{_{ref}} may be based on the index of the first one of second vector and the last one of the second vector corresponding to the reference CSI-RS resource (e.g. the CSI-RS resource with index t_{ref}). For example,

$${M}_{v , t \_ ref} = {n}_{3 , r}^{( {M}_{v} - 1 , {t}_{ref} )} - {n}_{3 , r}^{( 0 , {t}_{ref} )} .$$

For example, in case of N₃≤19.

In some embodiments, for the CSI-RS resource with index t (For example, 1≤t≤N and t≠t_{ref}), the second amplitude coefficient and/or the phase coefficient corresponding to the second vector with index

$${n}_{3 , r}^{( f , t )}$$

(e.g. the vector not reported for the CSI-RS resource with index t) may correspond to a maximum value of amplitude coefficient for the CSI-RS resource with index t.

In some embodiments, for the reference CSI-RS resource (e.g. the CSI-RS resource with index t_{ref}), the priority calculation parameter for the second vector (FD basis vector) may be based on

$$π ( f , {t}_{ref} ) = min ( 2 \cdot {n}_{3 , r}^{( f , {t}_{ref} )} , 2 \cdot ( {N}_{3} - {n}_{3 , r}^{( f , {t}_{ref} )} ) - 1 ) .$$

For example, r=1, 2, . . . , v, and f=0, 1, . . . , Mᵥ−1. In some embodiments, for the CSI-RS resource with index t (For example, 1≤t≤N and t≠t_{ref}.), the priority calculation parameter for the second vector (FD basis vector) may be based on the second vector offset (e.g. φ_{n,t}) or based on a parameter for second vector selection for the CSI-RS resource with index t (e.g. M_{initial,t} or Mᵢₙᵢₜᵢₐₗ) or based on the index of the first one of the second vector corresponding to the CSI-RS resource with index t.

In some embodiments, for the CSI-RS resource with index t (For example, 1≤t≤N and t≠t_{ref}), the priority calculation parameter

$$π ( f , t ) = min ( ( 2 \cdot ( ( {n}_{3 , r}^{( f , t )} - {φ}_{n , t} ) mod {N}_{3} ) ) ,$$

$$( 2 \cdot ( ( {N}_{3} - {n}_{3 , r}^{( f , t )} - 1 - {φ}_{n , t} ) mod {N}_{3} ) ) ) or$$

$$π ( f , t ) = min ( ( 2 \cdot ( ( {n}_{3 , r}^{( f , t )} + {φ}_{n , t} ) mod {N}_{3} ) ) ,$$

$$( 2 \cdot ( ( {N}_{3} - {n}_{3 , r}^{( f , t )} - 1 + {φ}_{n , t} ) mod {N}_{3} ) ) )$$

In some embodiments, r=1, 2, . . . , v, and f=0, 1, . . . , Mᵥ−1. For example, in case of N₃≤19.

In some embodiments, for the CSI-RS resource with index t (For example, 1≤t≤N and t≠t_{ref}), the priority calculation parameter

$$π ( f , t ) = min ( ( 2 \cdot ( ( {n}_{3 , r}^{( f , t )} - {φ}_{n , t} - {M}_{initial} ) mod {N}_{3} ) ) ,$$

$$( 2 \cdot ( ( ( {N}_{3} - {n}_{3 , r}^{( f , t )} ) - 1 - {φ}_{n , t} - {M}_{initial} ) mod {N}_{3} ) or$$

$$π ( f , t ) = min ( ( 2 \cdot ( ( {n}_{3 , r}^{( f , t )} - {φ}_{n , t} - {M}_{initial , t} ) mod {N}_{3} ) ) ,$$

$$( 2 \cdot ( ( ( {N}_{3} - {n}_{3 , r}^{( f , t )} ) - 1 - {φ}_{n , t} - {M}_{initial , t} ) mod {N}_{3} ) or$$

$$π ( f , t ) = min ( ( 2 \cdot ( ( {n}_{3 , r}^{( f , t )} + {φ}_{n , t} + {M}_{initial} ) mod {N}_{3} ) ) ,$$

$$( 2 \cdot ( ( ( {N}_{3} - {n}_{3 , r}^{( f , t )} ) - 1 + {φ}_{n , t} + {M}_{initial} ) mod {N}_{3} ) or$$

$$π ( f , t ) = min ( ( 2 \cdot ( ( {n}_{3 , r}^{( f , t )} + {φ}_{n , t} + {M}_{initial , t} ) mod {N}_{3} ) ) ,$$

$$( 2 \cdot ( ( ( {N}_{3} - {n}_{3 , r}^{( f , t )} ) - 1 + {φ}_{n , t} + {M}_{initial , t} ) mod {N}_{3} ) .$$

For example, in case of N₃>19.

In some embodiments, for the CSI-RS resource with index t (For example, 1≤t≤N and t≠t_{ref}), the priority calculation parameter

$$π ( f , t ) = min ( ( 2 \cdot ( ( {n}_{3 , r}^{( f , t )} + {n}_{3 , r}^{( 0 , t )} ) mod {N}_{3} ) ) ,$$

$$( 2 \cdot ( ( {N}_{3} - {n}_{3 , r}^{( f , t )} - 1 + {n}_{3 , r}^{( 0 , t )} ) mod {N}_{3} ) ) ) or$$

$$π ( f , t ) = min ( ( 2 \cdot ( ( {n}_{3 , r}^{( f , t )} - {n}_{3 , r}^{( 0 , t )} ) mod {N}_{3} ) ) ,$$

$$( 2 \cdot ( ( {N}_{3} - {n}_{3 , r}^{( f , t )} - 1 - {n}_{3 , r}^{( 0 , t )} ) mod {N}_{3} ) ) ) .$$

In some embodiments, the terminal device 110 may be configured with one codebook subset restriction for the CSI report. In some embodiments, the one codebook subset restriction may forms a bit sequence B=B₁B₂, wherein bit sequences B₁, and B₂ may be concatenated to form B. In some embodiments, there may be O₁O₂ first vector groups G(r₁,r₂). And G(r₁,r₂)={v_{N}_{₁}ᵣ_{₁}₊ₓ_{₁}_{,N}_{₂}ᵣ_{₂}₊ₓ_{₂}}, and X₁=0, 1, . . . N₁−1, X₂=0, 1, . . . N₂−1, for r₁∈{0, 1, . . . O₁−1}, r₂∈{0, 1, . . . O₂−1}. For example, for the second codebook configuration and the first type of codebook.

In some embodiments, the one codebook subset restriction may indicate Gᵣ first vector groups indicated by (r₁^{(k)}, r₂^{(k)}) for k=0, 1, . . . Gᵣ−1. The group indices may be g^{(k)}=O₁r₂^{(k)}+r₁^{(k)}. In some embodiments, the group indices may be assigned such that g^{(k)} increased as k increases. In some embodiments, the remaining first vectors groups (e.g. except the Gᵣ first vector groups) may not be restricted. In some embodiments, Gᵣ may be a positive integer. In some embodiments, 1≤Gᵣ≤8 or 1≤Gᵣ≤4. In some embodiments, Gᵣ=4.

In some embodiments, the average coefficient amplitude corresponding to a first vector with index i and/or corresponding to a unit with index z₂ may be restricted based on a corresponding value calculated based on the at least one first amplitude coefficient and/or the at least one second amplitude coefficient and/or at least one bit in the first bitmap (or in the third bitmap and in the fourth bitmap) for non zero coefficients indication.

In some embodiments, the average coefficient amplitude corresponding to a first vector with index i and/or corresponding to a unit with index z₂ may be restricted as

$$\sqrt{\frac{1}{{\sum }_{f = 0}^{{M}_{v} - 1} {\sum }_{q = 1}^{Q} {k}_{r , i + sL , f , q}^{( 4 )}} {\sum }_{f = 0}^{{M}_{v} - 1} {\sum }_{q = 1}^{Q} {{k}_{r , i + sL , f , q}^{( 4 )} ( {p}_{r , s}^{( 1 )} {p}_{r , i + sL , f , q}^{( 2 )} )}^{2}} \leq {γ}_{i + sL}$$

$$or$$

$$\sqrt{\frac{1}{{\sum }_{f = 0}^{{M}_{v} - 1} {\sum }_{q = 0}^{Q - 1} {k}_{r , i + sL , f , q}^{( 4 )}} {\sum }_{f = 0}^{{M}_{v} - 1} {\sum }_{q = 0}^{Q - 1} {{k}_{r , i + sL , f , q}^{( 4 )} ( {p}_{r , s}^{( 1 )} {p}_{r , i + sL , f , q}^{( 2 )} )}^{2}} \leq {γ}_{i + sL}$$

$$or$$

$$\sqrt{\frac{1}{{\sum }_{f = 0}^{M - 1} {\sum }_{q = 1}^{Q} {k}_{r , i + sL , f , q}^{( 4 )}} {\sum }_{f = 0}^{M - 1} {\sum }_{q = 1}^{Q} {{k}_{r , i + sL , f , q}^{( 4 )} ( {p}_{r , s}^{( 1 )} {p}_{r , i + sL , f , q}^{( 2 )} )}^{2}} \leq {γ}_{i + sL}$$

$$or$$

$$\sqrt{\frac{1}{{\sum }_{f = 0}^{M - 1} {\sum }_{q = 0}^{Q - 1} {k}_{r , i + sL , f , q}^{( 4 )}} {\sum }_{f = 0}^{M - 1} {\sum }_{q = 0}^{Q - 1} {{k}_{r , i + sL , f , q}^{( 4 )} ( {p}_{r , s}^{( 1 )} {p}_{r , i + sL , f , q}^{( 2 )} )}^{2}} \leq {γ}_{i + sL} .$$

For example, for the second codebook configuration and the first type of codebook. In some embodiments,

$${k}_{r , i + sL , f , q}^{( 4 )}$$

may indicate/represent the non zero coefficient corresponding to first vector with index i, second vector with index f, third vector with index q and layer with index r. In some embodiments,

$${k}_{r , i + pL , f , q}^{( 4 )}$$

may be indicated based on one bitmap (e.g. the first bitmap) or two bitmaps (e.g. the third bitmap and the third bitmap).

In some embodiments, the third bitmap may include at least one indication of vector pairs. In some embodiments, one vector pair may include two vectors from a set of vectors that include one first vector, one second vector, and one third vector. In some embodiments, one vector pair may include a pair of one first vector and one second vector or a pair of one second vector and one third vector or a pair of one first vector and one second vector. In some embodiments, the third bitmap may include at least one indication of a pair of one first vector and one second vector or a pair of one first vector and one third vector and a pair of one second vector and one third vector. In some embodiments, the fourth bitmap may include at least one indication of non-zero coefficients corresponding to one vector left in the set and at least one selected vector pair indicated by the third bitmap. In some embodiments, the fourth bitmap may include at least one indication of non-zero coefficients corresponding to one third vector and at least one selected/indicated pair of one first vector and one second vector indicated by the third bitmap. In some embodiments, the fourth bitmap may include at least one indication of non-zero coefficients corresponding to one second vector and at least one selected/indicated pair of one first vector and one third vector indicated by the third bitmap. In some embodiments, the fourth bitmap may include at least one indication of non-zero coefficients corresponding to one first vector and at least one selected/indicated pair of one second vector and one third vector indicated by the third bitmap.

In some embodiments, the third bitmap may include at least one indication of a pair of one first vector and one second vector, and the fourth bitmap may include at least one indication of non-zero coefficients corresponding to one third vector and at least one selected/indicated pair of one first vector and one second vector indicated by the third bitmap. In some embodiments, the field size or number of bits for the third bitmap may be Mᵥ*Q (For example, corresponding to one layer with index r) or Mᵥ*Q*v (For example, corresponding to all v layers). In some embodiments, the field size or number of bits for the fourth bitmap may be 2L*S₁ (For example, corresponding to all v layers) or 2L*S_{1,r} (For example, corresponding to one layer with index r). In some embodiments, S, may correspond to all v layers. In some embodiments, S_{1,r} may correspond to one layer with index r. In some embodiments, S₁ and/or S_{1,r}, may be the maximum number of selected pairs of one first vector and one second vector based on the first bitmap. In some embodiments, S₁ and/or S_{1,r} may be a non-negative integer or a positive integer. In some embodiments, 1≤S₁≤Mᵥ*Q*v−1. In some embodiments, 1≤S_{1,r}Mᵥ*Q−1 In some embodiments, S₁ and/or S_{1,r} may be determined or configured based on the at least one configuration.

In some embodiments, the third bitmap may include at least one indication of a pair of one first vector and one third vector, and the fourth bitmap may include at least one indication of non-zero coefficients corresponding to one second vector and at least one selected/indicated pair of one first vector and one third vector indicated by the third bitmap. In some embodiments, the field size or number of bits for the third bitmap may be 2L*Q (For example, corresponding to one layer with index r) or 2L*Q*v (For example, corresponding to all v layers). In some embodiments, the field size or number of bits for the fourth bitmap may be Mᵥ*S₂ (For example, corresponding to all v layers) or Mᵥ*S_{2,r} (For example, corresponding to one layer with index r). In some embodiments, S₂ may correspond to all v layers. In some embodiments, S_{2,r} may correspond to one layer with index r. In some embodiments, S₂ and/or S_{2,r} may be the maximum number of selected pairs of one first vector and one third vector based on the first bitmap. In some embodiments, S₂ and/or S_{2,r} may be a non-negative integer or a positive integer. In some embodiments, 1≤S₂≤2L*Q*v−1. In some embodiments, 1≤S₂≤2L*Q−1 In some embodiments, S₂ and/or S_{2,r} may be determined or configured based on the at least one configuration.

In some embodiments, the third bitmap may include at least one indication of a pair of one second vector and one third vector, and the fourth bitmap may include at least one indication of non-zero coefficients corresponding to one first vector and at least one selected/indicated pair of one second vector and one third vector indicated by the third bitmap. In some embodiments, the field size or number of bits for the third bitmap may be 2L*Mᵥ (For example, corresponding to one layer with index r) or 2L*Mᵥ*v (For example, corresponding to all v layers). In some embodiments, the field size or number of bits for the fourth bitmap may be Q*S₃ (For example, corresponding to all v layers) or Q*S_{3,r} (For example, corresponding to one layer with index r). In some embodiments, S₃ may correspond to all v lavers. In some embodiments, S_{3,r} may correspond to one layer with index r. In some embodiments, S₃ and/or S_{3,r} may be the maximum number of selected pairs of one second vector and one third vector based on the first bitmap. In some embodiments, S₃ and/or S_{3,r} may be a non-negative integer or a positive integer. In some embodiments, 1≤S₃≤2L*Mᵥ*v−1. In some embodiments, 1≤S₃≤2L*Mᵥ−1 In some embodiments, S₃ and/or S_{3,r} may be determined or configured based on the at least one configuration.

In some embodiments, the terminal device may indicate or determine or report a field in the at least one codebook indicator to indicate Q third vectors for the CSI report. For example, the terminal device may be configured with the second codebook configuration.

In some embodiments, the field size for third vector reporting or for the field in the at least one codebook indicator to indicate Q third vectors may be ┌log₂ C(N₄, Q)┐ or ┌log₂ C(N₄−1, Q−1)┐ or ┌log₂ C(Q_{w}, Q)┐ or ┌log₂ C(Q_{w}−1, Q−1)┐. In some embodiments, the first one of the Q third vectors may be

$${n}_{4 , r}^{( q )} = 0$$

(For example, a length-N₄ vector with all ones). In some embodiments, Q_{w} may be configured by the network device or Q_{w} may be determined based on the value of N₄. For example,

$${Q}_{w} = max ( \frac{{N}_{4}}{2} , Q )$$

or Q_{w} may be determined based on the value of Q. For example, Q_{w}=2Q. In some embodiments, Q_{w} third vectors may be represented as

$$\{ - ⌊ \frac{{Q}_{w}}{2} ⌋ , … - 2 , - 1 , 0 , 1 , … ⌊ \frac{{Q}_{w}}{2} ⌋ - 1 \} .$$

In some embodiments, N₄=2 may be only applied when combined with Tᵤ≥2 or Tᵤ≥4. In some embodiments, the terminal device may not expect N₄=2 and Tᵤ≤2 at the same time. In some embodiments, the terminal device may not expect N₄=2 and Tᵤ≤4 at the same time. In some embodiments, the terminal device may not expect to be configured with (N₄=2 and Tᵤ=2) or (N₄=2 and Tᵤ=1) or (N₄=4 and Tᵤ=1) at the same time.

In some embodiments, the reported CSI for the second codebook configuration may be applied or correspond to channel/CSI after slot l. In this case, the location of the slot l may be configured by the network device 120. For example, the location of slot l may be slot n+δ or slot n−n_{CSI_ref}. In some embodiments, δ may be configured by the network device 120, δ may be non-negative integer, e.g., δ may be at least one of {0, 2, 1, 3, 4, 5}. In some embodiments, n_{CSI_ref} may be a positive integer. In some embodiments, n_{CSI_ref} may be at least one of 4 or 5.

In some embodiments, the slot n may be the slot for the CSI reporting or the last downlink slot (for PDSCH reception) that overlaps with (the uplink slot for) the CSI reporting or

$$n = ⌊ {n}^{′} \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋ .$$

In some embodiment, δ may be based on the subcarrier spacing corresponding to one of: the fink slot (for PDSCH reception), the CSI-RS resource for the CSI report, the uplink slot for the CSI reporting (or for PUSCH transmission), or the minimum value of SCS among or between at least two of: SCS for uplink transmission, SCS for downlink transmission, SCS for CSI-RS for the CSI report, SCS for PDSCH reception, SCS for PDCCH triggering the CSI report. For example, the slot n+δ with δ=0 may be the last slot for PDSCH reception overlapping with (the uplink slot for) the CSI reporting. In this case, μ_{DL} and μ_{UL} may be the subcarrier spacing configurations for DL and UL, respectively.

$${N}_{slot , offset}^{CA}$$

and μ_{offset} may be determined by higher-layer configured ca-SlotOffset for the cells transmitting the uplink and downlink.

In some embodiments, the value of N₄*Tᵤ may be no less than 4 or 5. In some embodiments, the terminal device may expect the value of N₄*Tᵤ no less than 4 or 5. In some embodiments, the terminal device may not be expected to be configured with N₄ and Tᵤ with value of N₄*Tᵤ no less than 4 or 5. In some embodiments, the location of slot l may be slot of max (n, n−n_{CSI_ref}+N₄*Tᵤ). In some embodiments, if the terminal device is configured with (N₄=2 and Tᵤ=2) or (N₄=2 and Tᵤ=1) or (N₄=4 and Tᵤ=1) or N₄*Tᵤ≤4 or N₄*Tᵤ≤5, then the location of slot l may be slot n or n+δ or the location of slot l may not expected to be slot n−n_{CSI_ref}.

In some embodiments, the priority calculation parameter for the third vector (e.g. DD basis vector) may be based on

$$ρ ( q ) = min ( 2 \cdot {n}_{4 , r}^{( q )} , 2 \cdot ( {N}_{4} - {n}_{4 , r}^{( q )} ) - 1 ) .$$

In some embodiments, the priority for the at least one codebook indictor for the second codebook configuration may be Pri(r,i,f,q)=2·L·v·π(f)·(N₄+1)+2·L·v·ρ(q)+v·i+r or Pri(r,i,f,q)=2·L·v·π(f)·N₄+2·L·v·ρ(q)+v·i+r, wherein

$$π ( f ) = min ( 2 \cdot {n}_{3 , r}^{( f )} , 2 \cdot ( {N}_{3} - {n}_{3 , r}^{( f )} ) - 1 ) .$$

In some embodiments, the element or the coefficient (e.g. first amplitude coefficient, second amplitude coefficient, phase coefficient) corresponding to a first vector with index i and/or a second vector with index f and/or a layer with index r and/or a third vector with index q with the highest priority may have the lowest associated value Pri(r,i,f,q) or Pri(r,i,f).

In some embodiments, CSI group 1 may comprise at least one of: indication for Mᵥ second vectors, and v2LMᵥ−└K^{NZ}/2┘ highest priority elements/bits of the first bitmap for non zero coefficients indication, the

$$max ( 0 , ⌈ \frac{{K}^{N Z}}{2} ⌉ - v )$$

highest priority second amplitude coefficients, and the

$$max ( 0 , ⌈ \frac{{K}^{N Z}}{2} ⌉ - v )$$

highest priority phase coefficients. In some embodiments, CSI group 2 may comprise at least one of: └K^{NZ}/2┘ lowest priority elements/bits of the first bitmap for non zero coefficients indication, the

$$min ( {K}^{NZ} - v , ⌊ \frac{{K}^{NZ}}{2} ⌋ )$$

lowest priority second amplitude coefficients, and the min

$$min ( {K}^{NZ} - v , ⌊ \frac{{K}^{NZ}}{2} ⌋ )$$

lowest priority phase coefficients. For example, for the first type of codebook.

In some embodiments, CSI group 1 may comprise at least one of: vK₁M−└K^{NZ}/2┘ highest priority elements/bits of the first bitmap for non zero coefficients indication, the

$$max ( 0 , ⌈ \frac{{K}^{N Z}}{2} ⌉ - v )$$

highest priority second amplitude coefficients, and the

$$max ( 0 , ⌈ \frac{{K}^{N Z}}{2} ⌉ - v )$$

highest priority phase coefficients. In some embodiments, CSI group 2 may comprise at least one of: └K^{NZ}/2┘ lowest priority elements/bits of the first bitmap for non zero coefficients indication, the

$$min ( {K}^{NZ} - v , ⌊ \frac{{K}^{NZ}}{2} ⌋ )$$

lowest priority second amplitude coefficients, and the

$$min ( {K}^{NZ} - v , ⌊ \frac{{K}^{NZ}}{2} ⌋ )$$

lowest priority phase coefficients. For example, for second first type of codebook.

In some embodiments, the third bitmap for non zero coefficients indication and/or the fourth bitmap for non zero coefficients indication may be comprised in CSI group 1. In some embodiments, CSI group 1 may comprise at least one of: the third bitmap for non zero coefficients indication, the fourth bitmap for non zero coefficients indication, the

$$max ( 0 , ⌈ \frac{{K}^{N Z}}{2} ⌉ - v )$$

highest priority second amplitude coefficients, and the

$$max ( 0 , ⌈ \frac{{K}^{N Z}}{2} ⌉ - v )$$

highest priority phase coefficients. In some embodiments, CSI group 2 may comprise at least one of: the

$$min ( {K}^{NZ} - v , ⌊ \frac{{K}^{NZ}}{2} ⌋ )$$

lowest priority second amplitude coefficients, and the

$$min ( {K}^{NZ} - v , ⌊ \frac{{K}^{NZ}}{2} ⌋ )$$

lowest priority phase coefficients.

In some embodiments, the third bitmap for non zero coefficients indication may be comprised in CSI group 1, and a set of highest priority elements/bits in the fourth bitmap for non zero coefficients indication may be comprised in CSI group 1 and a set of lowest priority elements/bits in the fourth bitmap for non zero coefficients indication may be comprised in CSI group 2. In some embodiments, CSI group 1 may comprise at least one of: the third bitmap for non zero coefficients indication, X_{sec}−└K^{NZ}/2┘ highest priority elements/bits of the fourth bitmap for non zero coefficients indication, the

$$max ( 0 , ⌈ \frac{{K}^{NZ}}{2} ⌉ - υ )$$

highest priority second amplitude coefficients, and the

$$max ( 0 , ⌈ \frac{{K}^{N Z}}{2} ⌉ - υ )$$

highest priority phase coefficients. In some embodiments, CSI group 2 may comprise at least one of: └K^{NZ}/2┘ lowest priority elements/bits in the fourth bitmap for non zero coefficients indication, the

$$min ( {K}^{NZ} - v , ⌊ \frac{{K}^{NZ}}{2} ⌋ )$$

lowest priority second amplitude coefficients, and the

$$min ( {K}^{NZ} - v , ⌊ \frac{{K}^{NZ}}{2} ⌋ )$$

lowest priority phase coefficients. In some embodiments, X_{sec} may be

$${\sum }_{r = 1}^{ν} 2 L \cdot {S}_{1 , r} or 2 L \cdot {S}_{1} {\sum }_{r = 1}^{v} {M}_{v} \cdot {S}_{2 , r} or$$

$${M}_{v} \cdot {S}_{2} or {\sum }_{r = 1}^{v} Q \cdot {S}_{3 , r} or Q \cdot {S}_{3} .$$

In some embodiments, a set of highest priority elements/bits in the third bitmap for non zero coefficients indication may be comprised in CSI group 1 and a set of lowest priority elements/bits in the third bitmap for non zero coefficients indication may be comprised in CSI group 2. In some embodiments, a set of highest priority elements/bits in the fourth bitmap for non zero coefficients indication may be comprised in CSI group 1 and a set of lowest priority elements/bits in the fourth bitmap for non zero coefficients indication may be comprised in CSI group 2. In some embodiments, CSI group 1 may comprise at least one of: ┌X_{sec}/2┐ or └X_{sec}/2┘ highest priority elements/bits in the third bitmap for non zero coefficients indication, X_{sec}−└K^{NZ}/2┘ highest priority elements/bits of the fourth bitmap for non zero coefficients indication, the

$$max ( 0 , ⌈ \frac{{K}^{N Z}}{2} ⌉ - υ )$$

highest priority second amplitude coefficients, and the

$$max ( 0 , [ \frac{{F}^{N Z}}{2} ⌉ - υ )$$

highest priority phase coefficients. In some embodiments, CSI group 2 may comprise at least one of └X_{sec}/2┘ or ┌X_{sec}/2┐ lowest priority elements/bits in the third bitmap for non zero coefficients indication, └K^{NZ}/2┘ lowest priority elements/bits in the fourth bitmap for non zero coefficients indication, the

$$min ( {K}^{NZ} - v , ⌊ \frac{{K}^{NZ}}{2} ⌋ )$$

lowest priority second amplitude coefficients, and the

$$min ( {K}^{N Z} - v , ⌊ \frac{{K}^{NZ}}{2} ⌋ )$$

lowest priority phase coefficients.

For example, r=1, 2, . . . , v, and f=0, 1, . . . , Mᵥ−1. In some embodiments, for the CSI-RS resource with index t (For example, 1≤t≤N and t≠t_{ref}.), the priority calculation parameter for the second vector (FD basis vector) may be based on the second vector offset (e.g. φ_{n,t}) or based on a parameter for second vector selection for the CSI-RS resource with index t (e.g. M_{initial,t} or Mᵢₙᵢₜᵢₐₗ) or based on the index of the first one of the second vector corresponding to the CSI-RS resource with index t.

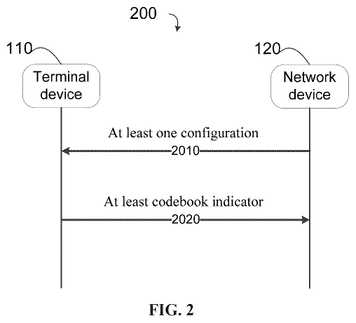

Reference is made to FIG. 2, which illustrates a signaling flow 200 of reporting at least one codebook indicator in accordance with some embodiments of the present disclosure. For the purposes of discussion, the signaling flow 200 will be discussed with reference to FIG. 1, for example, by using the terminal device 110 and the network device 120. It is noted that FIG. 2 is only an example embodiment.

The network device 120 transmits (2010) at least one configuration to the terminal device 110. The terminal device 110 determines and transmits (2020) at least one codebook configuration based on the at least one configuration to the network device 120.

The network device 120 may transmit at least one CSI-RS in the plurality of CSI-RS resources to the terminal device 110. The terminal device 110 may measure the received at least one CSI-RS. It is noted that the terminal device 110 may perform any proper measurements on the received reference signals.

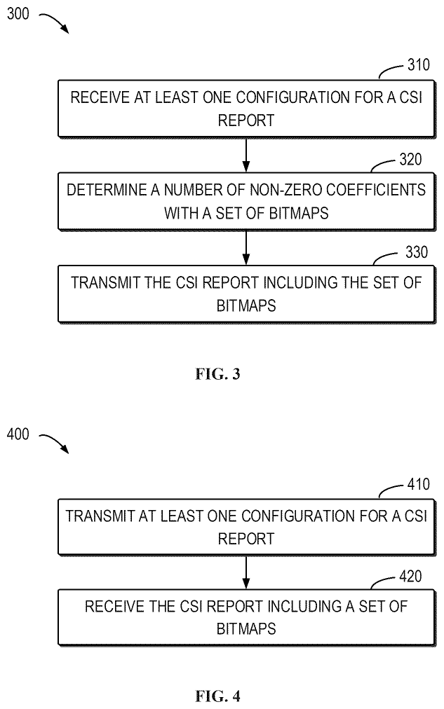

FIG. 3 illustrates a flowchart of a communication method 300 implemented at a terminal device in accordance with some embodiments of the present disclosure. For example, the method 300 may be implemented by the terminal device 110 in FIG. 1.

At block 310, the terminal device 110 receives, from the network device 120, at least one configuration for a channel state information (CSI) report. In some embodiments, the at least one configuration comprises at least one of: a first codebook parameter, a second codebook parameter, a plurality of channel state information reference signal (CSI-RS) resources for the CSI report, at least one parameter for antenna port configuration, a configuration for the type of codebook, or a configuration for the mode of codebook structure.

At block 320, the terminal device 110 determines a number of non-zero coefficients with a set of bitmaps based on the at least one configuration for the CSI report. The set of bitmaps comprises one bitmap or a plurality of bitmaps. Further, a pattern of the set of bitmaps is based on at least one of: whether a type of codebook is a first type of codebook or a second ty pe of codebook, whether a mode of codebook structure is a first mode of codebook structure or a second mode of codebook structure, a number of first vectors, a number of second vectors, a number of third vectors, a value of a first codebook parameter, a number of layers, a number of non-zero coefficients, a threshold, or a number of subbands. In some embodiments, a maximum value of the number of non-zero coefficients is per third vector.

At block 330, the terminal device 110 transmits, to the network device 120, the CSI report that comprises the set of bitmaps. In some embodiments, the plurality of bitmaps may include a third bitmap and a fourth bitmap. In some embodiments, the third and fourth bitmaps may be in the second part of the CSI report.

In some embodiments, the terminal device 110 determines, based on a first set of configurations or a first condition, that the set of bitmaps comprises the plurality of bitmaps. The terminal device 110 may also determine, based on a second set of configurations or a second condition, that the set of bitmaps comprises the one bitmap.

In some embodiments, for the reference CSI-RS resource (e.g. CSI-RS resource with index t_{ref}) in the second plurality of CSI-RS resources or in the plurality of CSI-RS resources, the terminal device 110 may determine and/or report a first offset for the second vectors (For example, represented as Mᵢₙᵢₜᵢₐₗ). In some embodiments, Mᵢₙᵢₜᵢₐₗ may be an integer. For example, Mᵢₙᵢₜᵢₐₗ∈{−2Mᵥ+1, −2Mᵥ+2, . . . ,0}. In some embodiments, for one CSI-RS resource with index t (e.g. t≠t_{ref}), the terminal device 110 may determine and/or report a second offset for second vectors (For example, represented as M_{initial,t}). In some embodiments, M_{initial,t} may be an integer. In some embodiments, the number of candidate values for M_{initial,t} may be N₃. In some embodiments, 0≤M_{initial,t}≤N₃−1.

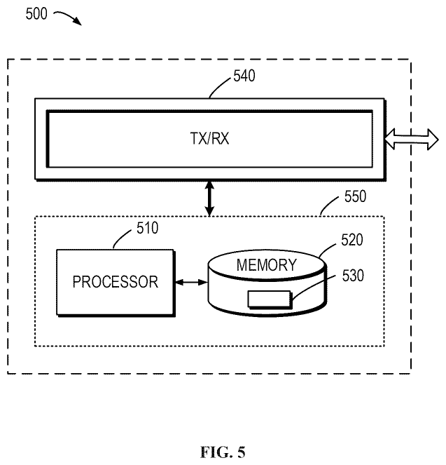

FIG. 4 illustrates a flowchart of a communication method 400 implemented at a terminal device in accordance with some embodiments of the present disclosure. For example, the method 400 may be implemented by the network device 120 in FIG. 1.

At block 410, the network device 120 transmits, to the terminal device 110, at least one configuration for a channel state information (CSI) report. A number of non-zero coefficients with a set of bitmaps is determined based on the at least one configuration for the CSI report.

At block 420, the network device 120 receives, from the terminal device 110, the CSI report that comprises the set of bitmaps. The set of bitmaps comprises one bitmap or a plurality of bitmaps.

FIG. 5 is a simplified block diagram of a device 500 that is suitable for implementing embodiments of the present disclosure. The device 500 can be considered as a further example implementation of any of the devices as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX)/receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

According to embodiments of the present disclosure, the circuitry may be configured to perform any of the method implemented by the device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a computer readable medium having instructions stored thereon, the instructions, when executed on at least one processor, causing the at least one processor to perform the method implemented by the device discussed above.

In an aspect, a computer program comprising instructions, the instructions, when executed on at least one processor, causing the at least one processor to perform the method implemented by the device discussed above.

In some embodiments, a terminal device comprises a circuitry configured to perform: the above methods.

In some embodiments, a network device comprises a circuitry configured to perform the above methods.

In summary, embodiments of the present disclosure provide the following aspects.

In another solution, a computer readable medium having instructions stored thereon, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-18. (canceled)

19. A method, performed by a terminal device, the method comprising:
receiving, from a network device, a configuration comprising a plurality of channel state information reference signal (CSI-RS) resources; and
transmitting, to the network device, a channel state information (CSI) report comprising an amplitude coefficient indicator, a phase coefficient indicator and a first indicator of a bitmap for indicating non-zero coefficient in the amplitude coefficient indicator and the phase coefficient indicator, wherein:
each of the amplitude coefficient indicator, the phase coefficient indicator and the first indicator is associated with a first priority, the first priority is based on an index of a first CSI-RS resource in a subset of the plurality of CSI-RS resources.

20. The method of claim 19, wherein
the index of the first CSI-RS resource corresponds to a strongest coefficient.

21. The method of claim 19, wherein
the first priority is based on an index of a second vector.

22. The method of claim 19, wherein
each of the amplitude coefficient indicator, the phase coefficient indicator and the first indicator is associated with a second priority, the second priority is based on an index of a second CSI-RS resource in the subset of the plurality of CSI-RS resources, the index of the first CSI-RS resource is different from the index of the second CSI-RS resource.

23. The method of claim 19, wherein
the first priority is based on
$$π ( f ) = min ( 2 \cdot {n}_{3 , r}^{( f )} , 2 \cdot ( {N}_{3} - {n}_{3 , r}^{( f )} ) - 1 ) ,$$
wherein
$${n}_{3 , r}^{( f )}$$
is an index associated with a second vector, f∈{0, 1, . . . N₃−1}, N₃ is an integer.

24. A method, performed by a network device, the method comprising:
transmitting, to a terminal device, a configuration comprising a plurality of channel state information reference signal (CSI-RS) resources; and
receiving, from the terminal device, a channel state information (CSI) report comprising an amplitude coefficient indicator, a phase coefficient indicator and a first indicator of a bitmap for indicating non-zero coefficient in the amplitude coefficient indicator and the phase coefficient indicator, wherein:
each of the amplitude coefficient indicator, the phase coefficient indicator and the first indicator is associated with a first priority, the first priority is based on an index of a first CSI-RS resource in a subset of the plurality of CSI-RS resources.

25. The method of claim 24, wherein
the index of the first CSI-RS resource corresponds to a strongest coefficient.

26. The method of claim 24, wherein
the first priority is based on an index of a second vector.

27. The method of claim 24, wherein
each of the amplitude coefficient indicator, the phase coefficient indicator and the first indicator is associated with a second priority, the second priority is based on an index of a second CSI-RS resource in the subset of the plurality of CSI-RS resources, the index of the first CSI-RS resource is different from the index of the second CSI-RS resource.

28. The method of claim 24, wherein
the first priority is based on
$$π ( f ) = min ( 2 \cdot {n}_{3 , r}^{( f )} , 2 \cdot ( {N}_{3} - {n}_{3 , r}^{( f )} ) - 1 ) ,$$
wherein
$${n}_{3 , r}^{( f )}$$
is an index associated with a second vector, f∈{0, 1, . . . N₃−1}, N₃ is an integer.

29. A terminal device, comprising a processor configured to cause the terminal device to:
receive, from a network device, a configuration comprising a plurality of channel state information reference signal (CSI-RS) resources; and
transmit, to the network device, a channel state information (CSI) report comprising an amplitude coefficient indicator, a phase coefficient indicator and a first indicator of a bitmap for indicating non-zero coefficient in the amplitude coefficient indicator and the phase coefficient indicator, wherein:
each of the amplitude coefficient indicator, the phase coefficient indicator and the first indicator is associated with a first priority, the first priority is based on an index of a first CSI-RS resource in a subset of the plurality of CSI-RS resources.

30. The terminal device of claim 29, wherein
the index of the first CSI-RS resource corresponds to a strongest coefficient.

31. The terminal device of claim 29, wherein
the first priority is based on an index of a second vector.

32. The terminal device of claim 29, wherein
each of the amplitude coefficient indicator, the phase coefficient indicator and the first indicator is associated with a second priority, the second priority is based on an index of a second CSI-RS resource in the subset of the plurality of CSI-RS resources, the index of the first CSI-RS resource is different from the index of the second CSI-RS resource.

33. The terminal device of claim 29, wherein
the first priority is based on
$$π ( f ) = min ( 2 \cdot {n}_{3 , r}^{( f )} , 2 \cdot ( {N}_{3} - {n}_{3 , r}^{( f )} ) - 1 ) ,$$
wherein
$${n}_{3 , r}^{( f )}$$
is an index associated with a second vector, f∈{0, 1, . . . N₃−1}, N₃ is an integer.
